(19) United States
(12) Patent Application Publication
(10) Pub. No.: US 2023/0086629 A1
(43) Pub. Date: Mar. 23, 2023

(54) Building Set and Method for Teaching Numeracy and Spelling

(71) Applicant: Kontu, Inc., Wilmington, DE (US)

(72) Inventor: Patrick Greenwood, Boulder, CO (US)

(21) Appl. No.: 18/054,049

(22) Filed: Nov. 9, 2022

Related U.S. Application Data
(63) Continuation-in-part of application No. 16/119,997, filed on Aug. 31, 2018, now Pat. No. 11,501,659.
(60) Provisional application No. 62/554,289, filed on Sep. 5, 2017.

(51) Int. Cl. G09B 19/02; A63H 33/04; G09B 1/08

(52) U.S. Cl. CPC G09B 19/02; A63H 33/046; A63H 33/048; G09B 1/08

(57) ABSTRACT

A building set includes a tray having a first row and a second row, each having a plurality of marker positions. The example building set also includes a plurality of markers configured for interchangeably fitting with the marker positions on the tray. A connection mechanism has a first connection on a first side of the markers, a second connection on a second side of the markers, and a third connection at each of the marker positions. The third connection interchangeably mates with the first connection and the second connection of the plurality of markers. The connection mechanism is at least one of hook-and-loop and magnetic, and may be biased toward one side of the markers to aid in subtraction. The tray and markers are configurable in various exercises and games to teach at least one of numeracy, arithmetic, and spelling.

### CROSS REFERENCE TO RELATED APPLICATIONS

This application is a continuation-in-part of U.S. patent application Ser. No. 16/119,997 filed Aug. 31, 2018 for “Magnetic Building Set And Method For Teaching Numeracy And Spelling,” which claims the priority benefit of U.S. Provisional Patent Application No. 62/554,289 filed Sep. 5, 2017 for “Magnetic Building Set and Method for Teaching Numeracy,” each hereby incorporated by reference in its entirety as though fully set forth herein.

### BACKGROUND

The informal understanding children gain through experimentation, observation, and comparison in play lays the foundation for higher-order thinking and later learning of formal STEM concepts

### BRIEF DESCRIPTION OF THE DRAWINGS

FIGS. 1-164 show example magnetic building sets and illustrate example methods for teaching numeracy, geometric shapes, arithmetic, spelling, and basic structural design and assembly techniques.

FIG. 1 shows trays and 10-frame of an example magnetic building set.

FIG. 2 shows trays and 10-frame of an example magnetic building set.

FIG. 3 shows a tray of an example magnetic building set.

FIG. 4 shows a tray of an example magnetic building set.

FIGS. 5-8 show a tray and unit markers of an example magnetic building set.

FIG. 9 shows a unit marker of an example magnetic building set.

FIG. 10 shows a cutaway view of a unit marker of an example magnetic building set.

FIG. 11 shows a unit marker of an example magnetic building set.

FIG. 12 shows a cutaway view of a unit marker of an example magnetic building set.

FIG. 13 shows a tray and unit markers of an example magnetic building set.

FIG. 14 shows a tray and unit markers of an example magnetic building set.

FIG. 15 shows trays and unit markers of an example magnetic building set.

FIG. 16 shows a cutaway view of a tray and unit markers of an example magnetic building set.

FIG. 17 shows a cutaway view of a tray and unit markers of an example magnetic building set.

FIG. 18 shows a cutaway view of trays and unit markers of an example magnetic building set.

FIG. 19 shows a cutaway view of trays and unit markers of an example magnetic building set.

FIGS. 20-23 show quantity cards of an example magnetic building set.

FIG. 24 shows operator cards of an example magnetic building set.

FIG. 25 shows trays and unit markers of an example magnetic building set.

FIG. 26 shows cards of an example magnetic building set.

FIG. 27 shows cards of an example magnetic building set.

FIG. 28 shows trays and unit markers of an example magnetic building set.

FIG. 29 shows trays and unit markers of an example magnetic building set.

FIG. 30 shows trays and unit markers of an example magnetic building set.

FIG. 31 shows cards of an example magnetic building set.

FIG. 32 shows cards of an example magnetic building set.

FIG. 33 shows trays and unit markers of an example magnetic building set.

FIG. 34 shows trays and unit markers of an example magnetic building set.

FIG. 35 shows cards of an example magnetic building set.

FIG. 36 shows cards of an example magnetic building set.

FIG. 37 shows trays and unit markers of an example magnetic building set.

FIG. 38 shows cards of an example magnetic building set.

FIG. 39 shows cards of an example magnetic building set.

FIG. 40 shows a unit marker of an example magnetic building set.

FIG. 41 shows a cutaway view of a unit marker of an example magnetic building set.

FIG. 42 shows a unit marker of an example magnetic building set.

FIG. 43 shows a cutaway view of a unit marker of an example magnetic building set.

FIG. 44 shows a tray and unit markers of an example magnetic building set.

FIG. 45 shows a tray and unit markers of an example magnetic building set.

FIG. 46 shows trays and unit markers of an example magnetic building set.

FIG. 47 shows a cutaway view of a tray and unit markers of an example magnetic building set.

FIG. 48 shows a cutaway view of a tray and unit markers of an example magnetic building set.

FIG. 49 shows a cutaway view of trays and unit markers of an example magnetic building set.

FIG. 50 shows a cutaway view of a tray and unit markers of an example magnetic building set.

FIG. 51 shows a unit marker of an example magnetic building set.

FIG. 52 shows a cutaway view of a unit marker of an example magnetic building set.

FIG. 53 shows a unit marker of an example magnetic building set.

FIG. 54 shows a cutaway view of a unit marker of an example magnetic building set.

FIG. 55 shows a tray and unit markers of an example magnetic building set.

FIG. 56 shows a tray and unit markers of an example magnetic building set.

FIG. 57 shows trays and unit markers of an example magnetic building set.

FIG. 58 shows a cutaway view of a tray and unit markers of an example magnetic building set.

FIG. 59 shows a cutaway view of a tray and unit markers of an example magnetic building set.

FIG. 60 shows a cutaway view of trays and unit markers of an example magnetic building set.

FIG. 61 shows a cutaway view of trays and unit markers of an example magnetic building set.

FIG. 62 shows a tray and unit markers of an example magnetic building set.

FIG. 63 shows trays and unit markers of an example magnetic building set.

FIG. 64 shows trays and unit markers of an example magnetic building set.

FIG. 65 shows a tray and unit marker of an example magnetic building set.

FIG. 66 shows cards of an example magnetic building set.

FIG. 67 shows cards of an example magnetic building set.

FIG. 68 shows a ten-frame of an example magnetic building set.

FIGS. 69-71 show a ten-frame and unit markers of an example magnetic building set.

FIGS. 72-75 show trays and unit markers of an example magnetic building set.

FIG. 76 shows ten-frames and unit markers of an example magnetic building set.

FIG. 77 shows a ten frame and unit markers of an example magnetic building set.

FIG. 78 shows a ten-frame, tray, and unit markers of an example magnetic building set.

FIG. 79 shows a ten-frame, trays, and unit markers of an example magnetic building set.

FIG. 80 shows place value trays of an example magnetic building set.

FIG. 81 shows place value trays and unit markers of an example magnetic building set.

FIG. 82 shows trays, place value trays, and unit markers of an example magnetic building set.

FIGS. 83-87 show place value trays and unit markers of an example magnetic building set.

FIGS. 88-89 show trays and unit markers of an example magnetic building set.

FIGS. 90-95 show cards of an example magnetic building set.

FIG. 96 shows trays and unit markers of an example magnetic building set.

FIG. 97 shows trays and unit markers of an example magnetic building set.

FIG. 98 shows cards of an example magnetic building set.

FIG. 99 shows cards of an example magnetic building set.

FIG. 100 shows trays and unit markers of an example magnetic building set.

FIGS. 101-104 show cards of an example magnetic building set.

FIG. 105 shows trays, fractions, and unit markers of an example magnetic building set.

FIG. 106 shows trays and unit markers of an example magnetic building set.

FIG. 107 shows trays and unit markers of an example magnetic building set.

FIG. 108 shows trays, fractions, and unit markers of an example magnetic building set.

FIG. 109 shows trays, fractions, and unit markers of an example magnetic building set.

FIGS. 110-114 show trays and unit markers of an example magnetic building set.

FIG. 115 shows the stacking of trays and unit markers of an example magnetic building set.

FIG. 116 shows the stacking of trays and unit markers of an example magnetic building set.

FIGS. 117-119 show lateral interlocking profiles of trays and unit markers of an example magnetic building set.

FIG. 120 shows the stacking of lateral interlocking profiles of trays and unit markers of an example magnetic building set.

FIG. 121 shows trays and unit markers of an example magnetic building set.

FIG. 122 shows a game board of an example magnetic building set.

FIGS. 123-135 show a game board, trays, unit markers, and pictures of an example magnetic building set.

FIG. 136 shows a plurality of game boards of an example magnetic building set.

FIGS. 137-149 show shapes or structures made from trays and unit markers of an example magnetic building set.

FIG. 150 shows a tray and letter markers of an example magnetic building set.

FIG. 151 shows a tray and letter markers of an example magnetic building set.

FIG. 152 shows trays and letter markers of an example magnetic building set.

FIG. 153 shows trays and letter markers of an example magnetic building set.

FIG. 154 shows a tray and letter markers of an example magnetic building set.

FIG. 155 shows trays and letter markers of an example magnetic building set.

FIG. 156 shows trays and letter markers of an example magnetic building set.

FIG. 157 shows a tray of an example magnetic building set.

FIG. 158 shows a tray and unit markers of an example magnetic building set.

FIG. 159 shows a tray of an example magnetic building set.

FIG. 160 shows a tray and unit markers of an example magnetic building set.

FIG. 161 shows a tray of an example magnetic building set.

FIG. 162 shows a tray and unit markers of an example magnetic building set.

FIG. 163 shows a tray of an example magnetic building set.

FIG. 164 shows a tray and unit markers of an example magnetic building set.

FIG. 165 shows another example tray and unit markers of an example building set having a hook-and-loop connection mechanism.

FIG. 166 shows another example tray and unit markers of an example building set having a magnetic connection mechanism.

FIG. 167 is a cross sectional view of the example tray and unit markers having a magnetic connection mechanism of FIG. 166.

### DETAILED DESCRIPTION

A magnetic building set and method for teaching numeracy is disclosed. An example magnetic building set 1 includes a plurality of trays 2 with indents 3 that receive a plurality of unit markers 4 which can be implemented in various manipulative exercises and games that teach numeracy, elementary arithmetic, geometric shapes, and spelling. The magnetic building set 1 enables the user (e.g., teachers and/or students) to build a plurality of geometric shapes, structures and other constructions. Trays 2 can be provided to represent a plurality of numeric quantities whereby a single tray provides, on one side, a corresponding quantity of indents 3 that are capable of receiving an equal quantity of unit markers 4. Trays 2 can be provided with an equal number of indents 3 on a second side as are present on the first side, allowing them to be reversible, such that unit markers can be inserted in either side, therefore allowing tray and marker assemblies to be stacked one on top of the other. When resting on a work surface such as a table, the quantity of indents 3 within a single tray 2 that face upward, and therefore the quantity of unit markers 4 that can be inserted into the upward facing indents, represents the unit quantity for that particular tray 2. When resting on a work surface such as a table, the indents 3 on the underside of the tray 2 are present to provide the stacking and reversibility properties and are not considered when calculating the total unit quantity for the tray 2. For example, when resting on a work surface, a tray 2 that is considered to have a unit quantity of two, may have two indents 3 on a first upward facing side and a corresponding two indents 3 on the second side which rests upon the work surface. For the purposes of the numeracy exercises and games described herein, this tray 2 with a unit quantity of two can be considered a two-unit tray. The markers 4 within a tray 2 may be collectively referred to as a marker assembly 5.

A tray 2 and marker assembly 5 representing a specific numeric quantity can be manipulated as a whole, while the unit markers contained therein are visible to the student and can be viewed, manipulated, arranged and counted individually. Students are instructed to manipulate the trays and markers in various exercises in order to learn counting, number composition and decomposition, subitizing of quantities, arithmetic operations, place value, arithmetic story problems, geometric shapes, and spelling.

Before continuing, it is noted that as used herein, the terms “includes” and “including” mean, but is not limited to, “includes” or “including” and “includes at least” or “including at least.” The term “based on” means “based on” and “based at least in part on.”

The examples described herein are provided for purposes of illustration, and are not intended to be limiting. Other devices and/or device configurations may be utilized to carry out the operations described herein. The operations shown and described herein are provided to illustrate example implementations. It is noted that the operations are not limited to the ordering shown. Still other operations may also be implemented.

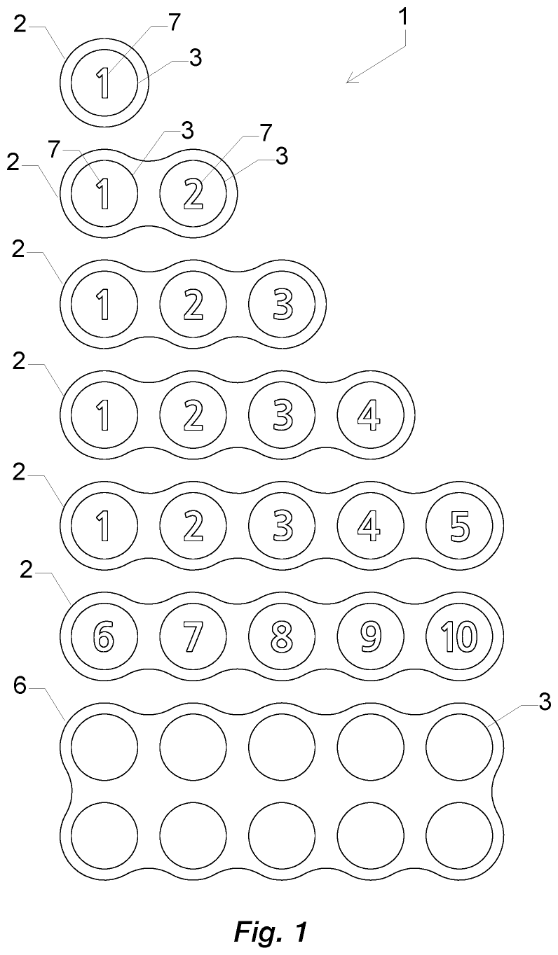

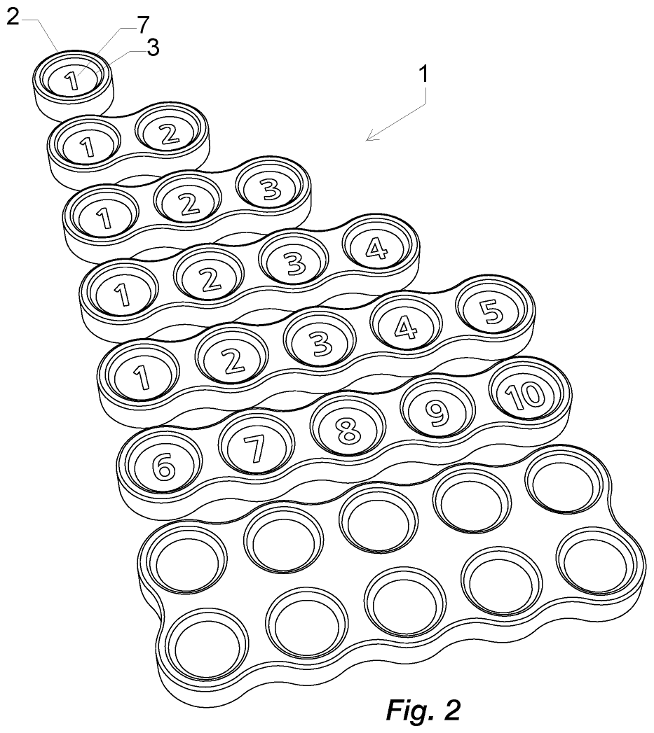

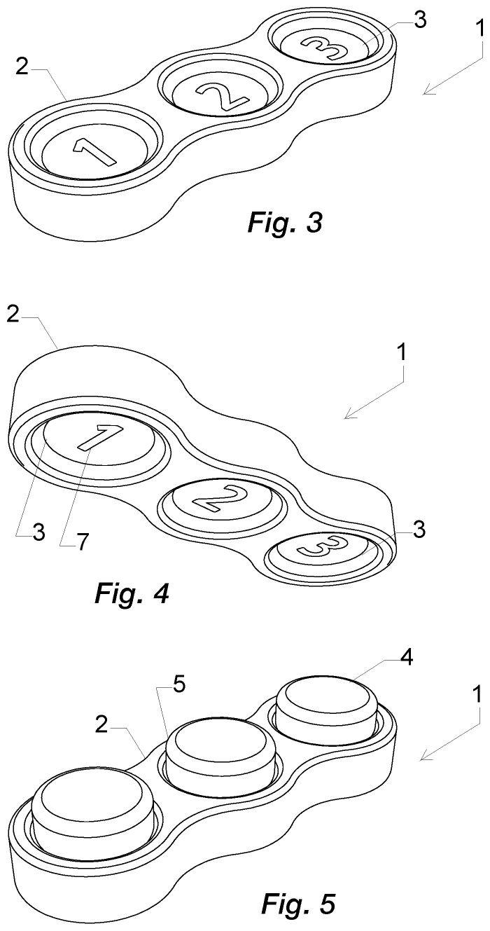

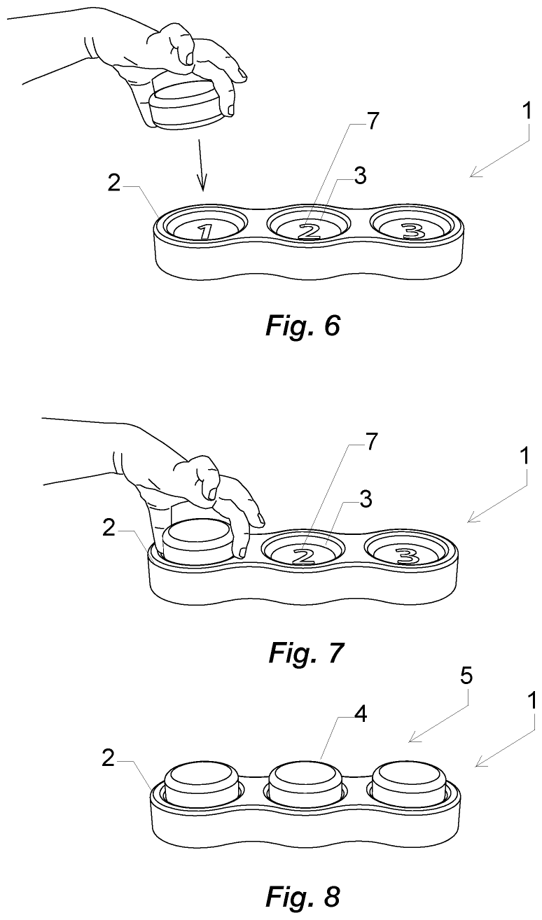

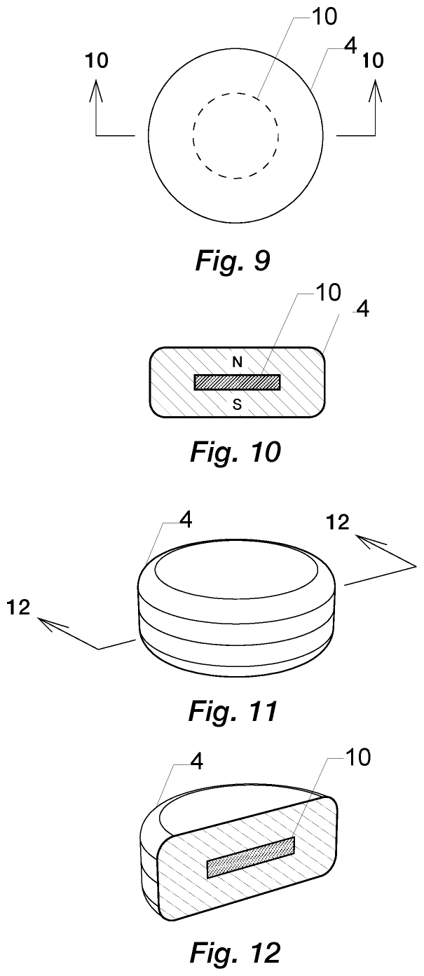

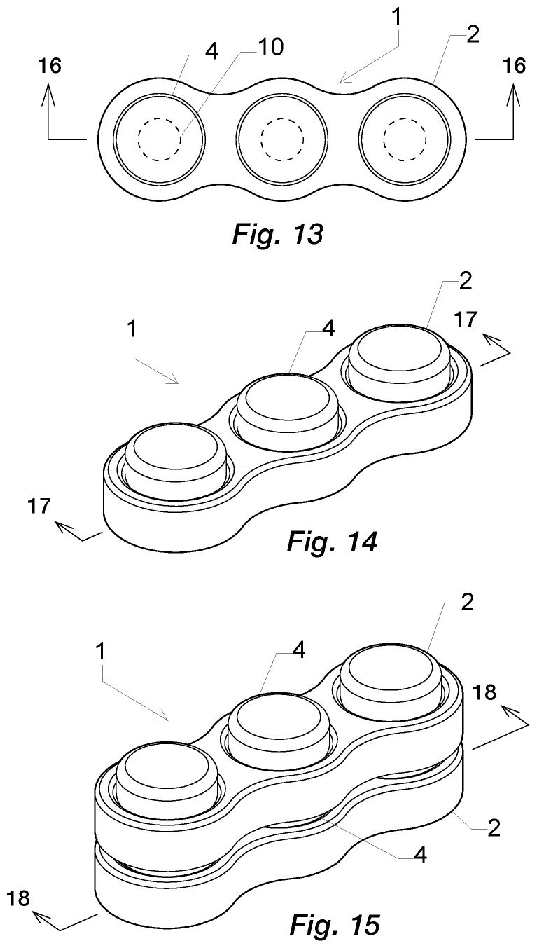

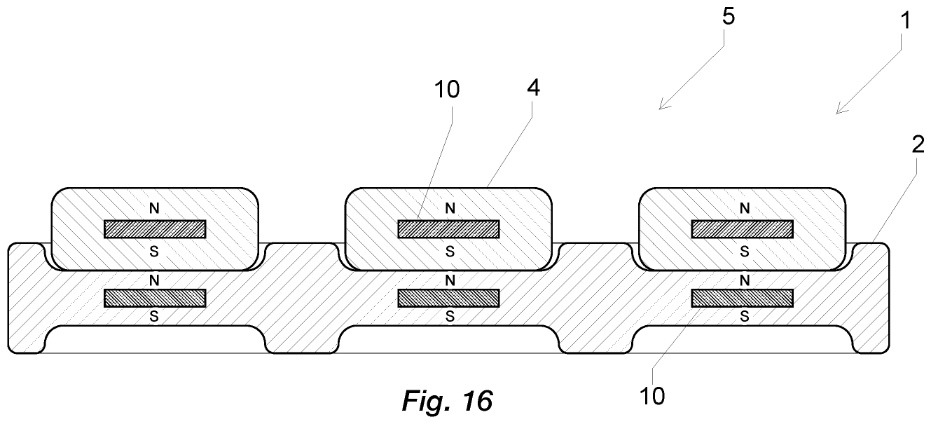

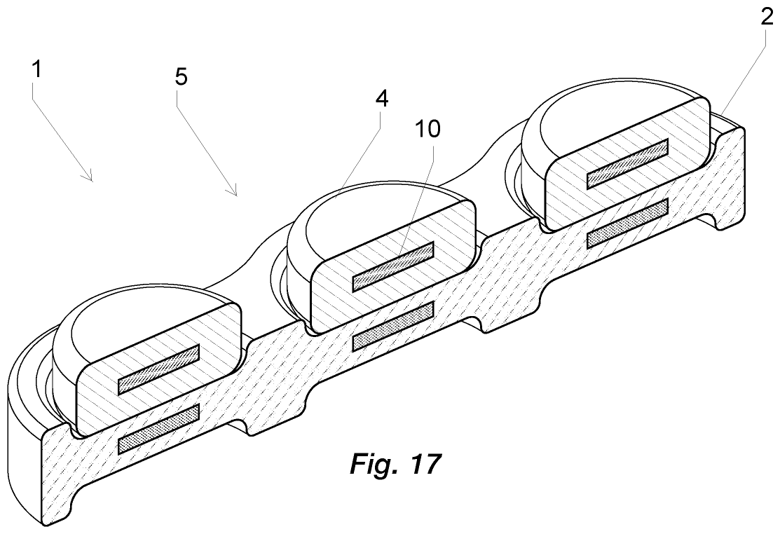

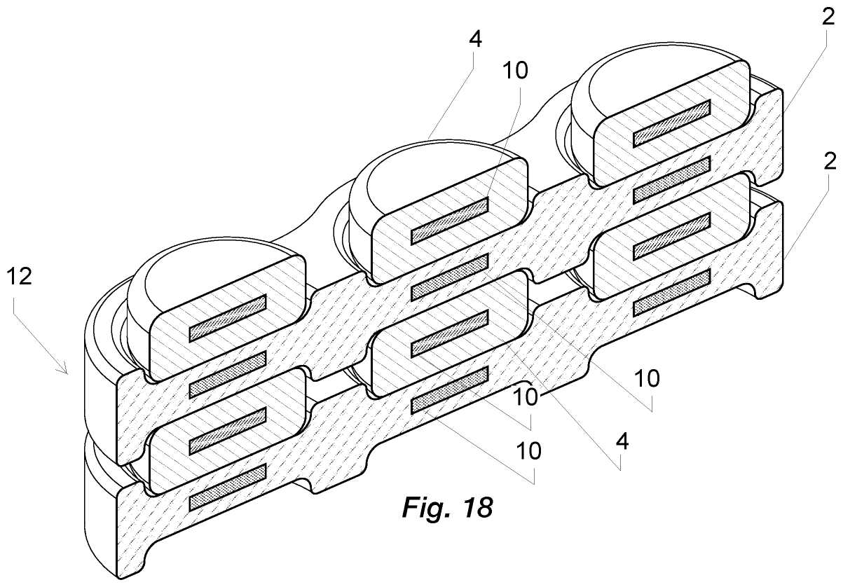

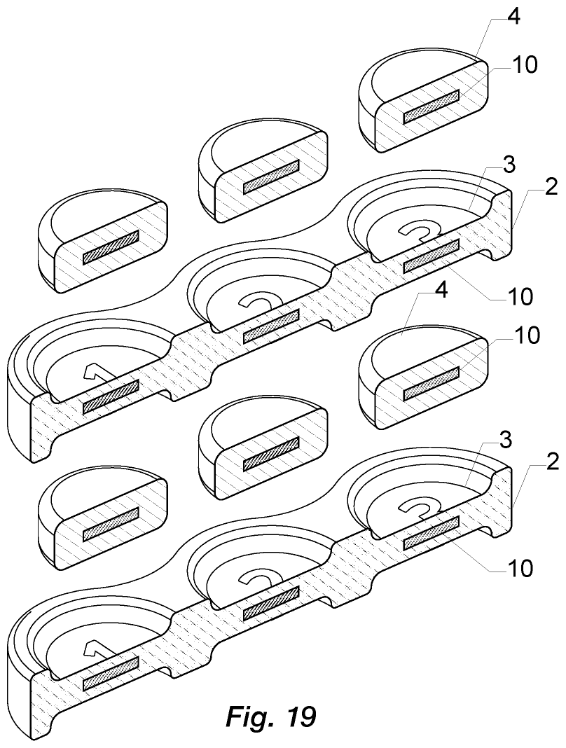

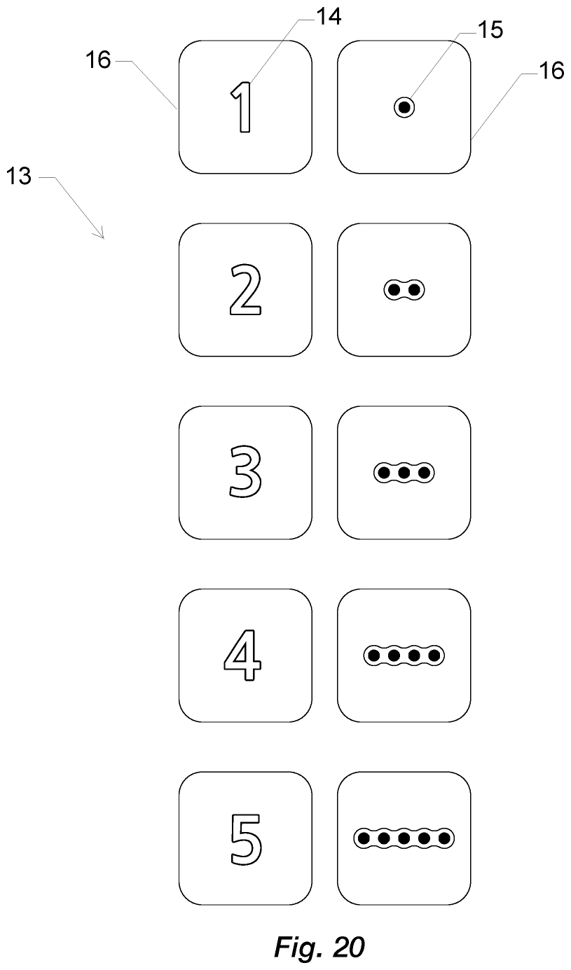

FIGS. 1-164 show example magnetic building sets 1 and illustrate example methods for teaching numeracy, shapes, and spelling. Trays 2 can be provided that represent any known quantity and may be provided with as many indents 3 as desired. In an example, trays 2 can be provided that represent the following quantities: a tray 2 representing the quantity of one and having one indent 3 on a first side and one indent 3 on a second side, a tray 2 representing the quantity of two and having two indents 3 on a first side and two indents 3 on a second side, a tray 2 representing the quantity of three and having three indents 3 on a first side and three indents 3 on a second side, a tray 2 representing the quantity of four and having four indents 3 on a first side and four indents 3 on a second side, a tray 2 representing the quantity of five and having five indents 3 on a first side and five indents 3 on a second side, a special tray 2 in the form of a ten-frame 6 representing the quantity of ten and having ten indents 3 arranged in two rows of five on a first side and ten indents arranged in two rows of five on a second side.

The surface of the indents 3 within a tray 2 may be printed, painted, debossed, etched or otherwise inscribed or denoted with numerical indicia 7 beginning with the numeral “1” and increasing sequentially by one in each subsequent indent such that the last indent can be printed, painted, debossed, etched or otherwise inscribed or denoted with the numeral corresponding to the numeric quantity represented by the tray 2. When resting on a work surface such as a table, a tray 2 without markers inserted into the indents 3 and with numeric indicia 7 visible can represent a number line. Indents 3 within the trays 2 can also be marked with indicia 7 beginning with a numeral other than “1” and can represent a quantity transposed along a number line. For example, a tray 2 with five indents can be provided that is marked with the numerals “6”, “7”, “8”, “9” and “10.” When placed in a linear relationship and adjacent to a preceding tray 2 with five indents that has been provided with the numerals “1”, “2”, “3”, “4” and “5,” a modular number line can be represented. Additional trays 2 with five indents and sequences of numerals of an order greater than ten can be provided to further extend the number line represented.

It is noted that the references are not shown for each instance in the figures where the element referred to by the reference is shown multiple times in the same drawings (e.g., one of the trays 2 or one of the markers 4 may only be labeled once even if multiple trays or markers are shown), in order to simplify the drawings. Multiple instances of the same element are clearly understood from the drawing to be multiple instances, and therefore each instance does not need to be separately labeled as such.

A student may practice counting by inserting markers 4 into the indents 3 provided within a tray. The student can be instructed to begin by inserting a marker into the indent that contains the indicium 7 for the numeral “1” while speaking aloud the word for the numeral “1.” The student can then be instructed to proceed to the next adjacent indent 3 that contains an indicium 7 for the numeral “2,” and insert a new marker 4, speaking aloud the word for the numeral “2.” The student can repeat this process until all indents within the tray have been filled with markers 4 and the student has completed the counting exercise for a given tray and quantity represented. When all markers 4 have been inserted into the indents in a tray, the student can further practice numeracy skills by memorizing the quantity represented while looking at the markers 4, by quickly counting them again without speaking aloud or by subitizing the quantity represented by the tray 2 and markers 4.

As shown for example in FIG. 77, a unit marker 4 can be printed, painted, debossed or otherwise inscribed on a first side, a second side or both sides with numerical indicia 8. When a student is practicing the counting exercise disclosed hereinabove, the student places the marker 4 with numerical indicia 8 into the tray indent that possesses a matching numerical indicium 7 thereby enhancing their recognition and memorization of the numerals and reinforcing the counting exercise.

A unit marker 4 can be printed, painted, debossed, etched or otherwise inscribed on a first side, a second side or on both a first and second side with a picture 9 of a face, animal, insect, plant, fruit, flower, food item, astral body, popular character or other object recognizable and known to a student. When performing the counting exercise disclosed hereinabove using unit markers printed with pictures thereon, a student may count a quantity of known and relatable objects, as pictured on the markers, further enhancing their cognition of and engagement with the numeracy exercises.

Magnets Enclosed within Trays and Markers. In an example, magnets 10 can be enclosed within the tray indents 3 and unit markers 4 such that the markers 4 remain secured within the indents 3 during casual manipulation but are easily removed when desired. When the markers 4 are inserted into the indents 3, the attractive force of the magnets 10 within the markers 4 to the magnets 10 within the indents 3 also provides auditory and kinesthetic feedback which may further enhance both the learning experience and enjoyment during play. Using their imagination, a student may build a plurality of geometric shapes, constructions or other structures 11 by stacking tray assemblies 12 and marker assemblies 5. The magnets 10 within the tray indents and the magnets 10 within the markers 4 can have dipole axes where a first side of a marker 4 may be attracted to an indent 3 within a first side of a tray 2, the second side of the same marker 4 may be repelled from an indent in the first side of the same tray 2. Additionally, the second side of a marker 4 may be attracted to an indent 3 within the second side of the same tray 2 and the second side of a marker 4 may be repelled from an indent in the first side of the same tray 2. A student may, through experimentation and exploration, determine the side and orientation of a magnetic marker 4 that may fit into a corresponding magnetic indent 3 within a tray.

It is noted that the magnet configuration disclosed herein is an example configuration. In another example, steel slugs or other magnetic material may be provided in the discs and only magnets provided in the trays, or vice versa. In addition, the device is not limited to implementation with magnets. Other mechanisms for removably attaching trays and markers may be implemented. The specific materials may be altered based on design considerations as will be readily appreciated by those having ordinary skill in the art after becoming familiar with the teachings herein.

Number composition describes the property of mathematics whereby a set of two or more numbers can be composed into a greater number. Number decomposition describes the property of mathematics whereby a number can be decomposed into two or more smaller numbers. A student may, with the assistance of a teacher, implement the tray and marker assemblies to illustrate number composition and decomposition by placing two or more trays 2 adjacent to each other on a work surface and inserting unit markers 4 into each of the indents 3 in all of the trays 2. The student and teacher may then count the unit markers 4 in each individual tray 2, noting the quantity represented by each tray 2, and then counting the total number of unit markers 4 present in all trays 2.

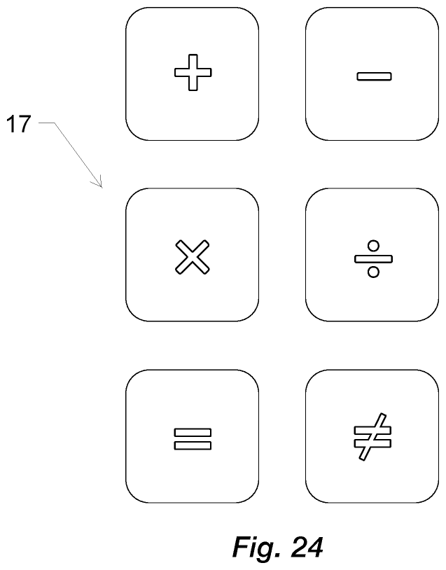

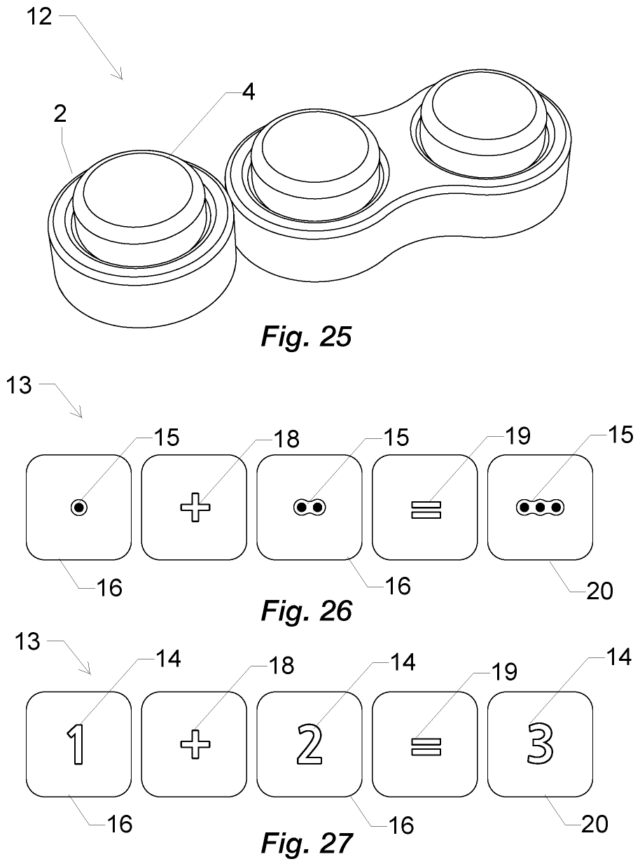

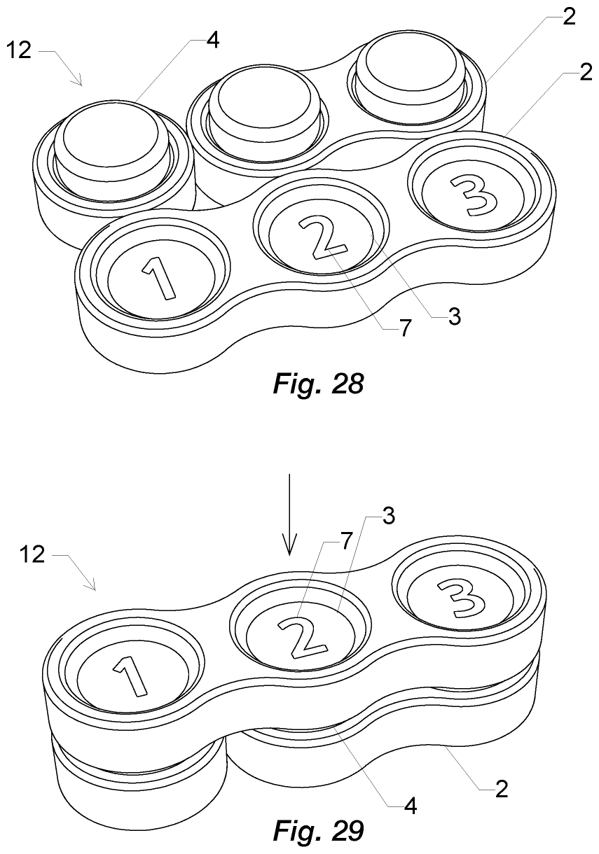

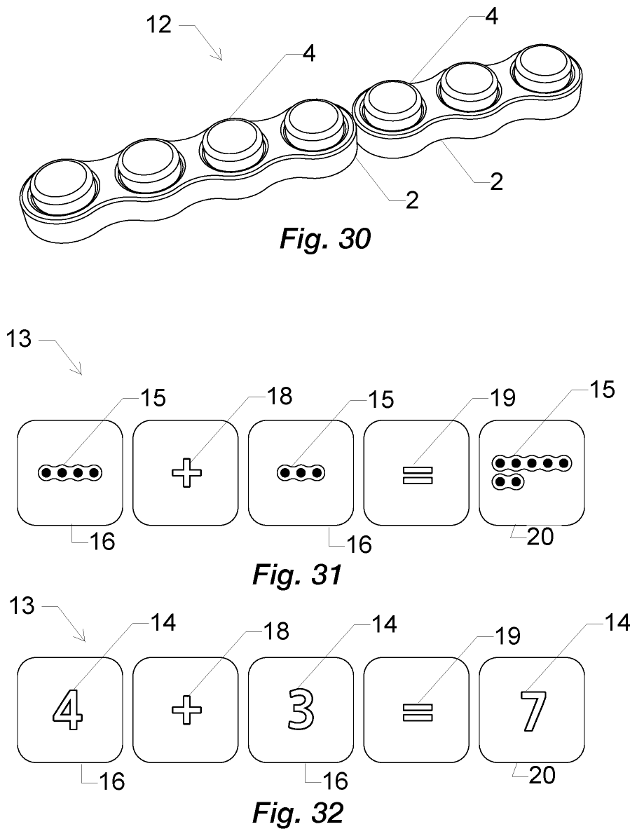

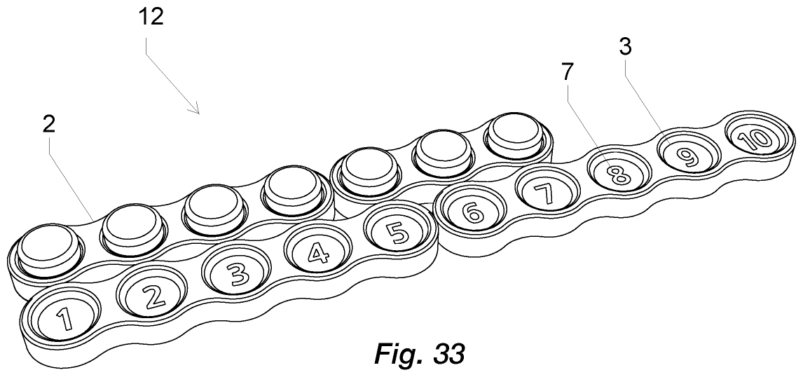

For example, the teacher may place a one-unit tray 2 upon the work surface. With instruction from the teacher, the student may insert a single unit marker 4 into the indent 3 within the one-unit tray 2 and count the unit marker, speaking the name of the number aloud. The teacher may then place a two-unit tray 2 upon the work surface and instruct the student to place unit markers 4 within the indents 3 of the two-unit tray 2 using the exercise described hereinabove. At this stage in the exercise, the student may have placed on the work surface a single one-unit tray 2 with a marker 4 inserted and a single two-unit tray 2 with two markers 4 inserted, as shown in FIG. 25. The teacher can now instruct the student to count aloud the total number of markers 4 present on the work surface. With assistance from the teacher, the student may count a total of three unit markers 4 present on the work surface. Three is the correct answer for the exercise described. The teacher and student may further discuss the phenomenon demonstrated by the trays 12 and markers 4 whereby the quantity of three markers 4 that are present on the work surface is composed of a one-unit tray 2 and marker assembly 5 and a two-unit tray 2 and marker assembly 5. As shown in FIG. 28, the student may place a three-unit tray 2 on the work surface and aligned with the one-unit and two-unit trays 2 and notice the length of the three-unit tray 2 is equal to the length of the one-unit and two-unit trays 2 when added together. Finally, the student may further emphasize the equality by stacking the three-unit tray 2 on top of the one-unit and two-unit trays 2 and their markers 4 as illustrated in FIG. 29.

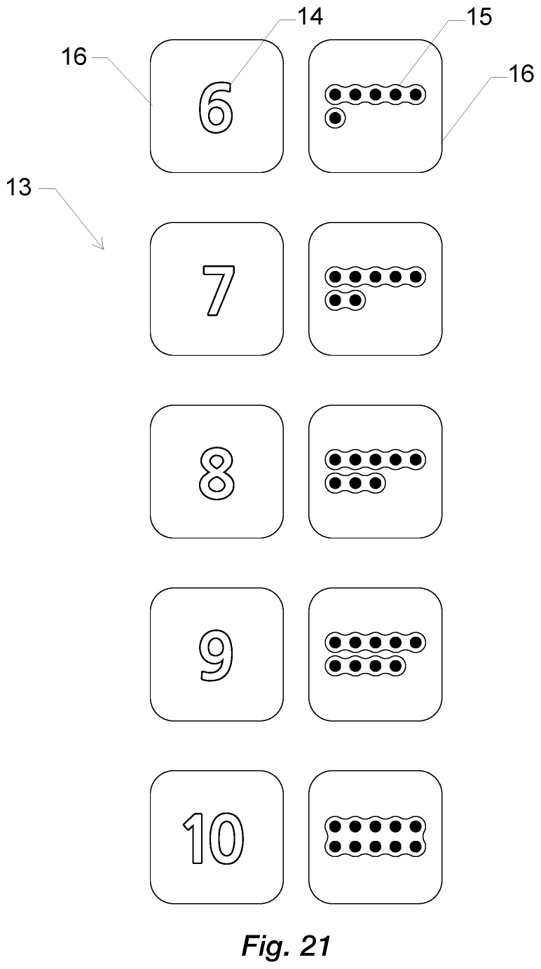

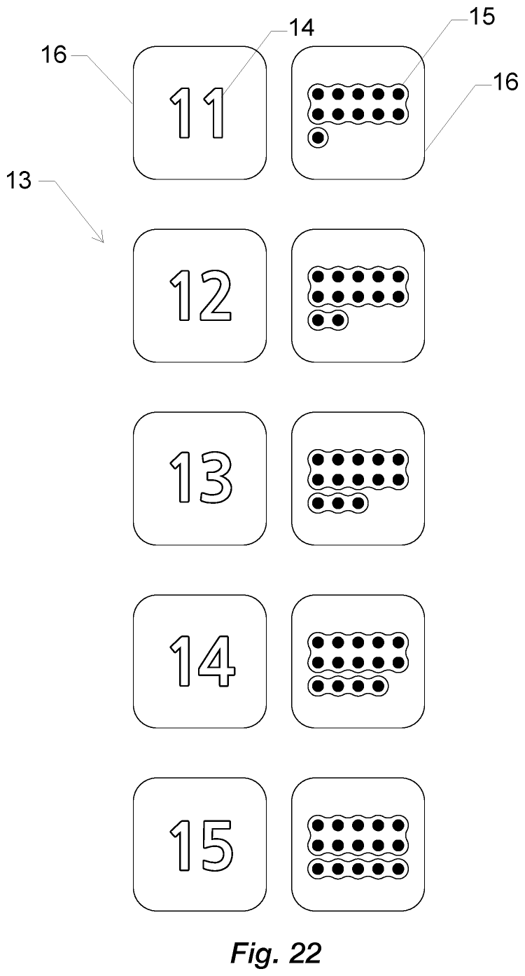

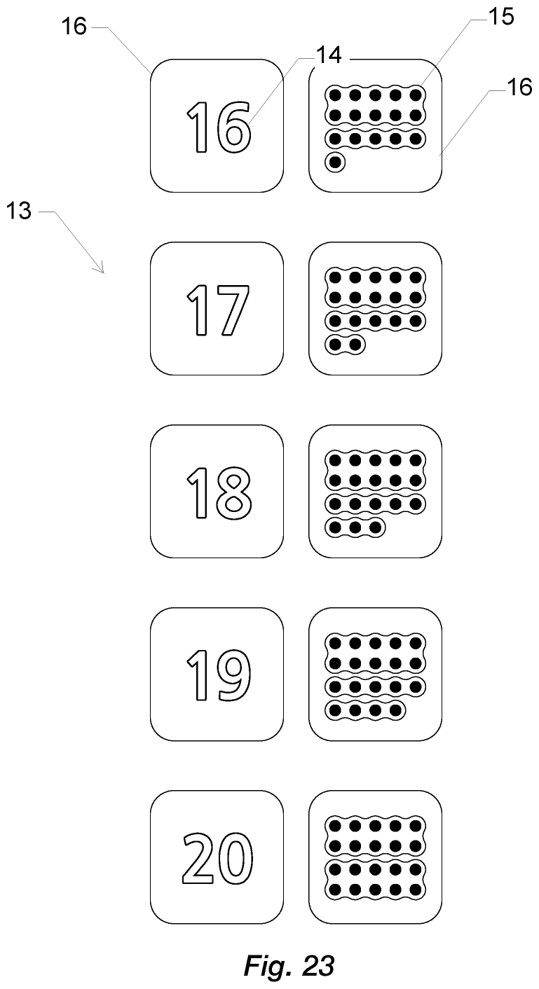

Quantity and Operator Cards. In an example shown in FIGS. 21-23, a set of cards 13 may be provided with the building set 1 that can demonstrate to the student the relationship between the concrete representation of a given quantity in the form of a tray 2 filled with unit markers 4 or a tray assembly 12 filled with unit markers 4 and the corresponding symbolic numeral representation of an equal quantity. In an example, the set of cards 13 provided each have printed on a first side a numeral indicia 14 in a sequence beginning with the numeral “1” and increasing by one consecutively up to and including, but not limited to the numeral “20.” The set of cards can each have printed on a second side a pictorial representation 15 of a tray or an assembly of trays filled with unit markers representing a quantity equal to the quantity represented by the numeral on the first side of each respective card. These cards 13 with pictorial and numeral representations of quantity 15 and 14 can hereafter be referred to as quantity cards 16. The drawings for the cards 13 show an optimized set of pictorial representations 15 whereby the least number of trays 2 that can be implemented to represent the quantity is displayed in the picture 15 and where possible, the quantity is grouped into five-unit trays 2 and ten-unit trays 2. For example, the card 13 for the quantity “4” shows a single four-unit tray 2 and the card for the quantity “6” shows a five-unit tray 2 and a one-unit tray 2. In some of the mathematical exercises and for some levels of learners, it might be advantageous to provide permutations of the quantity cards 13 that show groupings of trays 2 other than the optimized set. For example, the quantity card “4” may show two two-unit trays 2 in its pictorial representation 15 rather than a single four-unit tray 2. The advantage of this pictorial representation 15 is apparent when examining the addition operation exercise. When using two two-unit trays 2 in the exercise, the resulting solution may have on the work surface two two-unit trays 2 instead of a single four-unit tray 2.

As shown in FIG. 24, A set of cards 13 is also provided with the building set that can have printed on each side one of the arithmetic signs which are the plus sign, the minus sign, the multiplication sign and the division sign also known as an obelus, an equal sign and a slashed equal sign to represent inequality. In an example, a card may have printed on a first side one of the arithmetic signs and may have printed on a second side the sign that is inverse to the sign printed on the first side. Generally, these may be referred to as sign cards 17. The sign cards may be arranged on a work surface in conjunction with tray 2 and unit marker assemblies 5 in order to illustrate basic arithmetic equations. When a sign card 17 bearing one of the arithmetic operation signs is used in an equation, such as that shown in FIG. 26, this sign card may also be referred to hereinafter as an operator card 18. When a sign card 17 bearing one of the arithmetic equality signs is used in an equation, such as that shown in FIG. 26, this sign card may also be referred to hereinafter as an equality card 19.

When employing a quantity card 16 in an arithmetic equation, a student may implement a first side of the card that has been printed with the pictorial representation 15 of a tray 2 and unit marker assembly 5 to denote the quantity represented. When further employing a quantity card 16 in an arithmetic equation, a student may also implement a second side of the card 14 that has been printed with a numeral to denote the quantity represented. A student may also implement a combination of pictorial and numeral cards 13, depending on the student's achievement level, learning style, the exercise being taught or the teacher's discretion. As part of a teaching exercise, a student can arrange the cards 13 into an arithmetic equation by placing the cards 13 on a work surface in a sequence where a plurality of quantity cards 16 is combined with one or more arithmetic operator cards 18 followed by an equality card 19 and ending with a quantity card 16 that represents the solution to the equation.

Addition Operation Exercise. With instruction from a teacher, a student may learn to perform the addition operation of arithmetic by placing two or more trays 2 filled with unit markers 4 upon a work surface and counting the total quantity of unit markers 4. In an example, the student can begin by placing a first tray 2 on the work surface. The student may then proceed to insert unit markers 4 into the indents 3 of the first tray, counting aloud in sequence beginning with one and proceeding until they have filled all indents 3 within the first tray 2. The teacher may assist the student at this point, noting the total quantity of unit markers 4 which have been counted in the first tray 2. The teacher may then present to the student a selection of the quantity cards 16 described hereinabove by placing them on the work surface. The presented cards can have the side facing upwards which has been printed with the pictorial representation 15 of a tray and unit marker assembly or plurality of assemblies. The student can be asked to select the quantity card 16 that matches the representation 15 and quantity of the first tray 2 which they have just counted and the teacher can remove the cards 16 that do not match the quantity of the first tray.

In another example, the teacher may simply place the matching quantity card 16 on the work surface without the student having to select a matching quantity card 16. In either case, the matching quantity card 16 now rests on the work surface.

The teacher next places an operator card 18 which has been printed with the plus sign onto the work surface and adjacent to the first card. With or without the teacher's assistance, the student may select a second tray 2 and place it on the work surface adjacent to the first tray 2. The teacher may instruct the student to align the trays 2 along their longest axes to form a line. The student next inserts unit markers 4 into the indents 2 within the second tray 2, again counting aloud in sequence beginning with one and proceeding until they have filled all indents within the second tray 2. The teacher and student next repeat the process for selecting a quantity card 16 that matches the quantity of the most recently counted tray and marker assembly and placing the quantity card 16 upon the work surface and adjacent to the operator card 18 having the plus sign printed thereon. The student may repeat the described process of placing trays, inserting markers, selecting and placing the matching quantity card and placing the plus sign operator card 18 on the work surface until the desired quantity of trays 2 to be added together has been reached.

In an example, when the desired quantities of tray 2 and unit marker assemblies 5 and corresponding cards 13 has been placed on the work surface, the teacher may next place the equals sign card 19 adjacent to the previously placed assembly composed of quantity cards 16 and plus sign operator card 17 or plurality of plus sign operator cards 17. The teacher may then disclose to the student the significance of the plus sign operator card 18 and the significance of the equals sign card 19. The teacher may next instruct the student to count the total quantity of unit markers 4 present on the work surface. When the student has counted the total quantity of unit markers 4 correctly, the teacher may present to the student a plurality of quantity cards 16 wherein one card has printed on it the quantity representation of the quantity that equals the total quantity of unit markers 4 present on the work surface.

In another example, the teacher may simply present the quantity card 16 to the student which equals the total quantity of unit markers 4 present on the work surface. In either case, the card 16, which equals the total quantity of unit markers 4 present on the work surface, can be considered the solution to the arithmetic addition problem represented by the tray 2 and unit marker assemblies 5 and the previously placed assembly of cards 13. This quantity card 16 may hereafter be referred to as the solution card 20. The teacher or student may then place the solution card on the work surface with the side having printed the pictorial representation of the quantity facing upward and adjacent to the equals sign card. FIGS. 25-27 illustrate an example addition exercise using tray 2 and marker assemblies 5 and cards 13.

At this stage of the exercise, the addition operation is complete. The teacher may now instruct the student to flip the quantity cards 16 over such that the sides which have been printed with the numeral representation 14 of the quantities are facing upwards. The teacher may discuss with the student the significance of the numeral quantity cards 16 and their relationship to the quantities represented by the tray 2 and unit marker assemblies 5.

In another example of the addition operation teaching exercise, the teacher may find it advantageous to substitute the quantity cards 16 with the tray and marker assemblies themselves, therefore placing the plus sign card 17 or plurality of plus sign cards 17 and the equals sign card 19 adjacent to and between the tray 2 and marker assemblies 5.

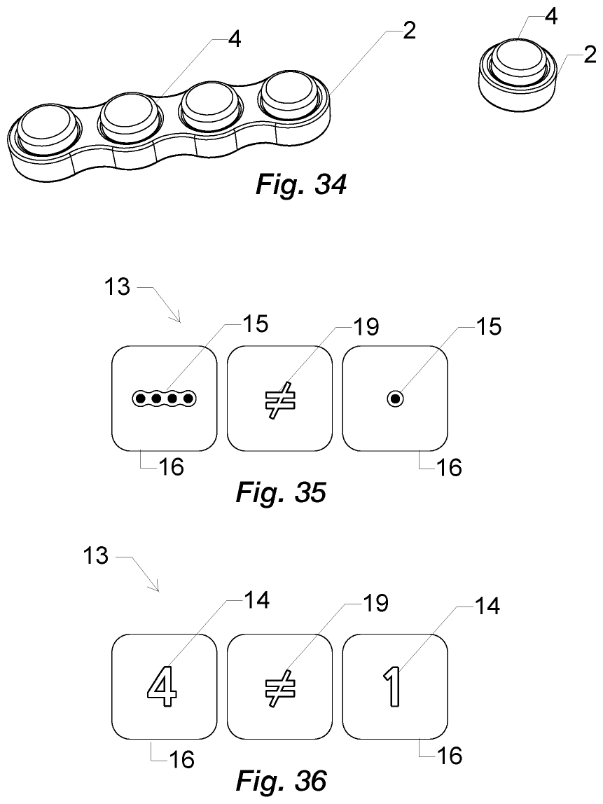

Equality and Inequality Exercises. With instruction from a teacher, a student may explore the concepts of equality and inequality in mathematics using the building set 1 and cards 13 disclosed hereinabove. For example, the student may place a four-unit tray 2 and marker assembly 5 on the work surface. The student may then place a one-unit tray 2 and marker assembly 5 on the work surface near to but not touching the four-unit tray 2 such that they can be examined separately as two distinct representations of quantity, “4” and “1” respectively as shown in FIG. 34. Next, the teacher may ask the student to examine the four-unit and one-unit trays 2 on the work surface and to determine if they are the same or not the same. Naturally, they are not the same as “4” is not equal to “1”. The teacher may ask the student to select a quantity card 16 for each of the two quantities present on the work surface, “4” and “1”, and place them onto the work surface, each quantity card 16 being adjacent to its respective tray 2. At the discretion of the teacher or student, they may place the cards 13 on the work surface with the pictorial representation 15 of the tray 2 and marker assemblies 5 facing up (FIG. 35) or the quantity numerals 14 facing up (FIG. 26). The teacher may next offer the student the equality card 19 that has printed on a first side the equals sign and on a second side the slashed equal sign and explain that the equals sign means “the same” and that the slashed equals sign means “not the same.” The teacher may then ask the student to place the equality card 19 onto the work surface between the two quantities cards 16 and with the side facing up that has printed thereon the slashed equals sign.

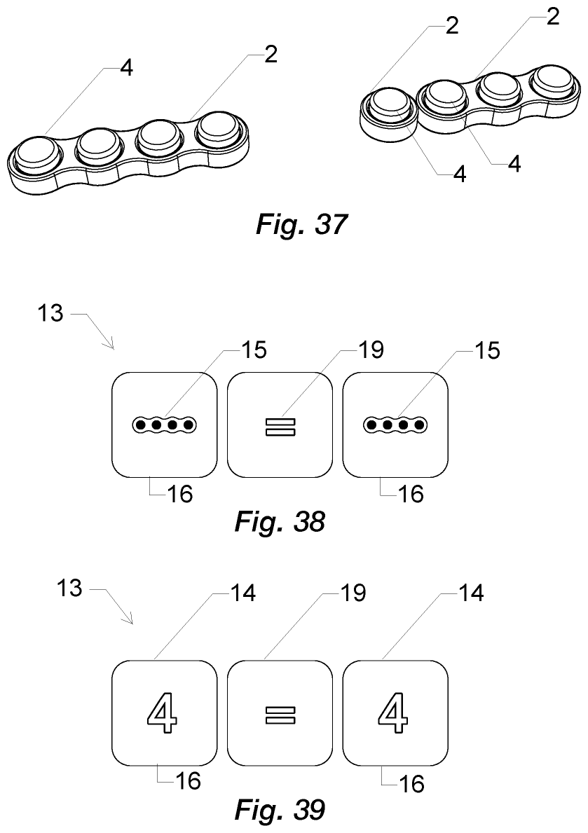

In the next phase of the exercise, the teacher may ask the student to examine the tray 2 and marker assemblies 5 on the work surface and try to determine what tray 2 or combination of trays 2 may be added to the one-unit tray 2 in order to arrive at the same quantity represented by the four-unit tray 2. There are multiple correct solutions to this challenge which invites the student to engage in divergent problem-solving. In the solution presented in FIG. 37, the student has selected a three-unit tray 2 and placed it adjacent to the one-unit tray 2 therefore equaling “4”. When the two arrangements of tray and marker assemblies are equal, the teacher may instruct the student to flip the operator card 19 over, as shown in FIGS. 38 & 39 such that the equals sign is facing upward thus completing the exercise.

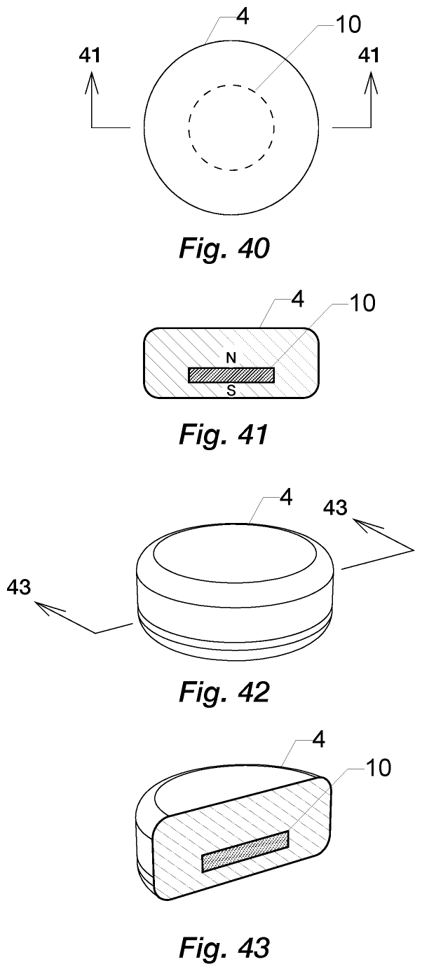

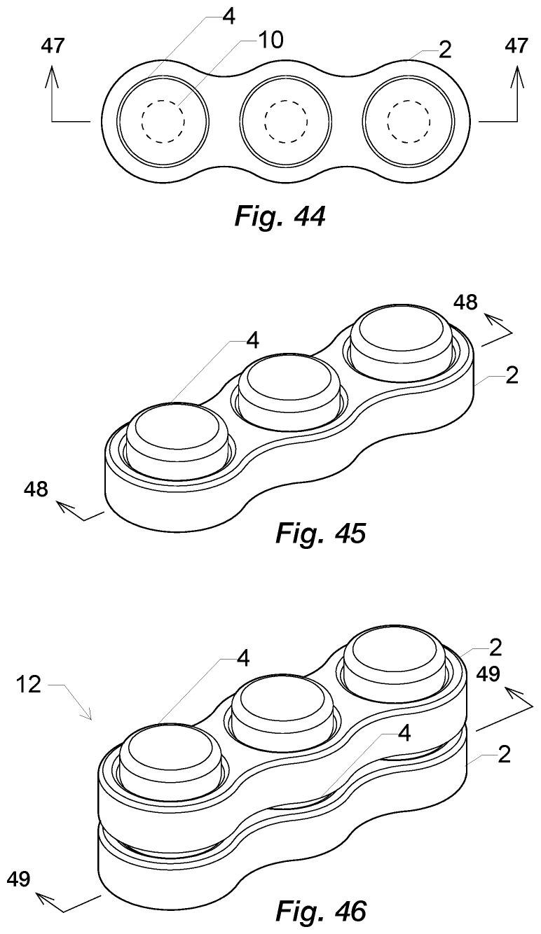

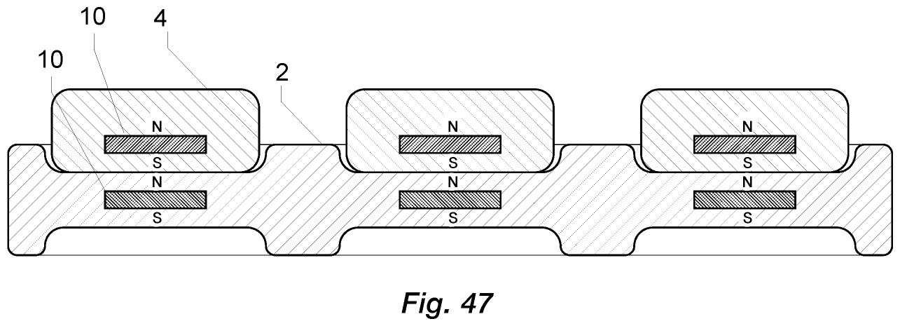

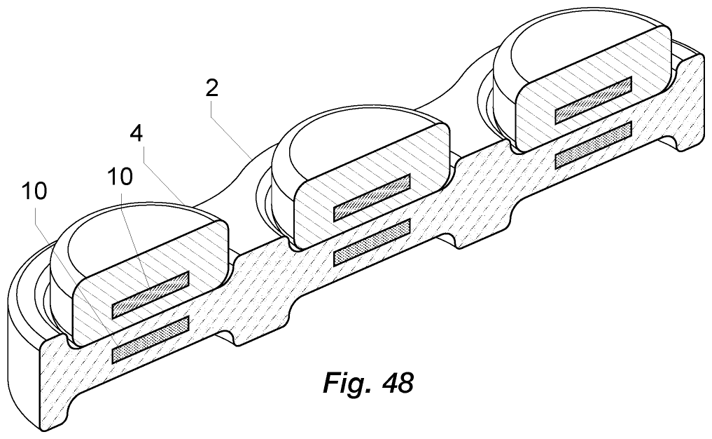

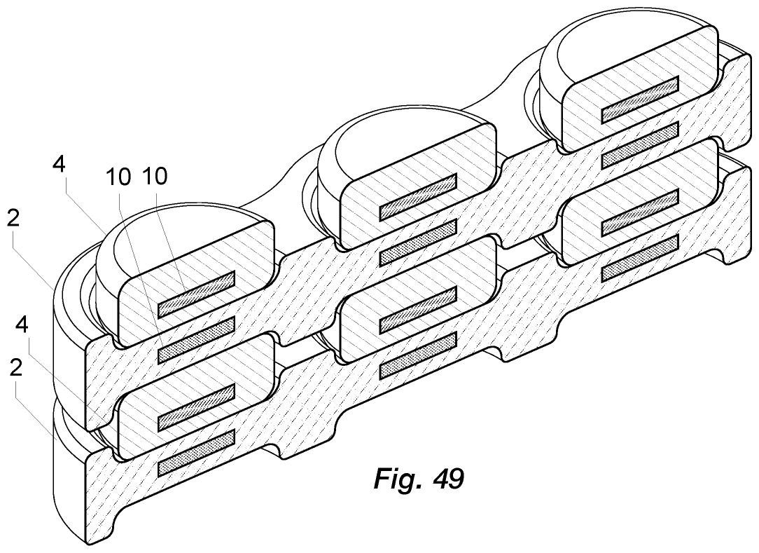

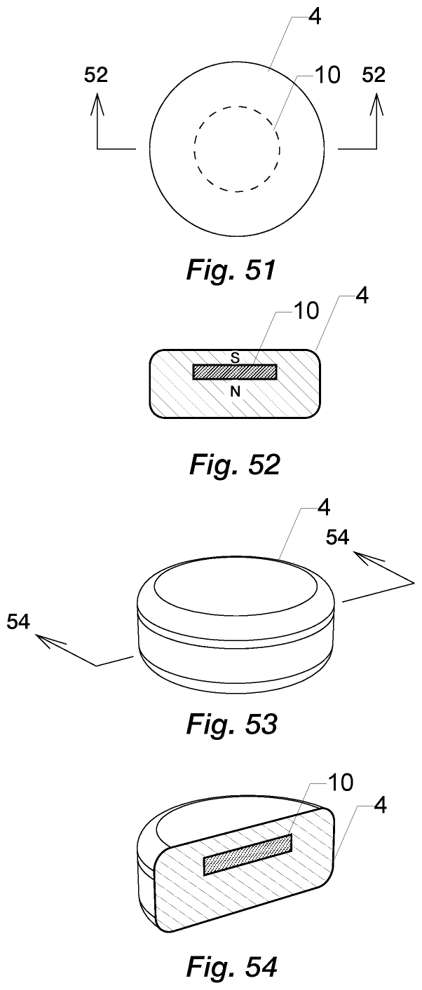

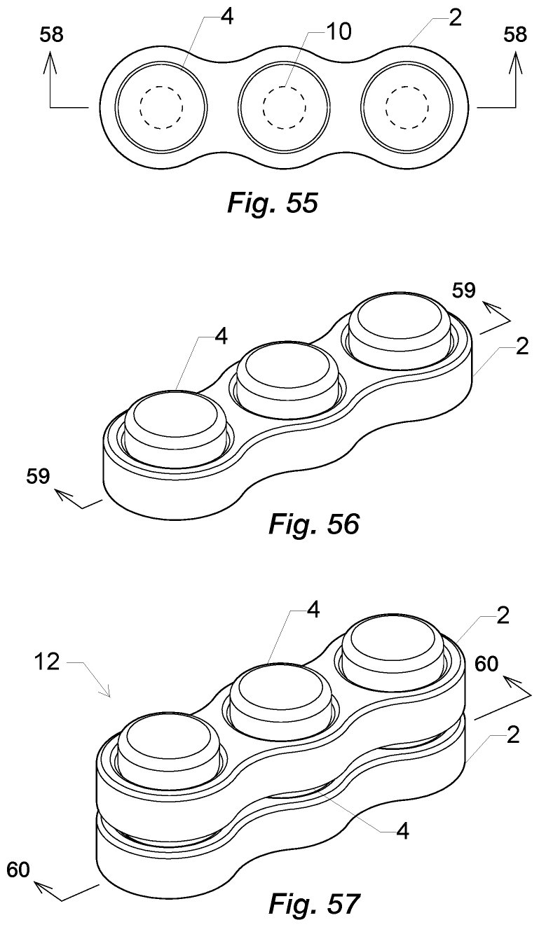

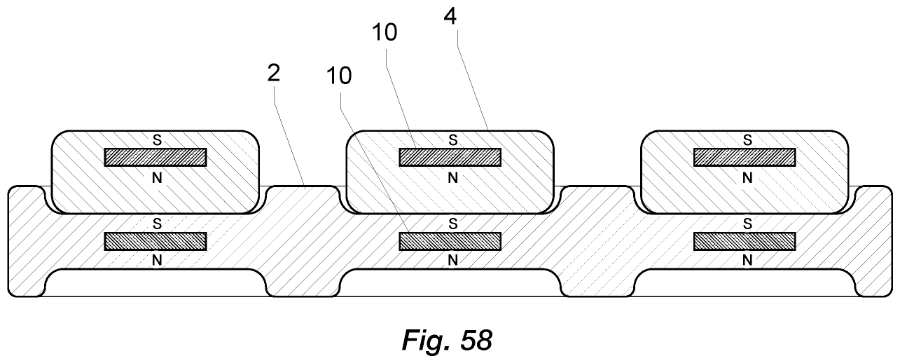

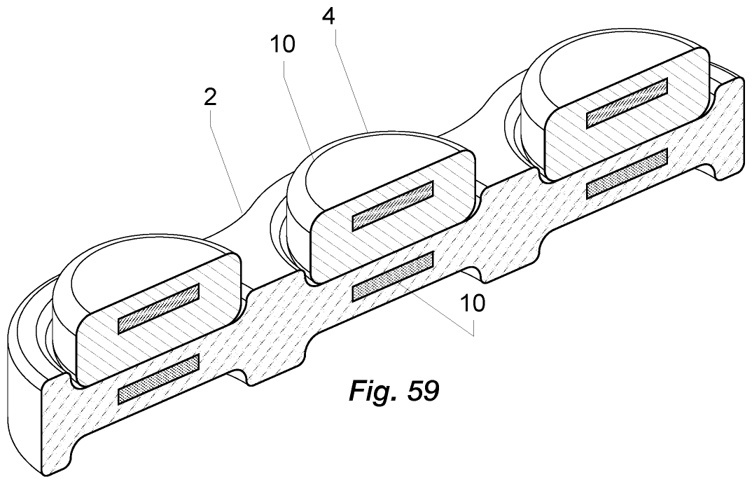

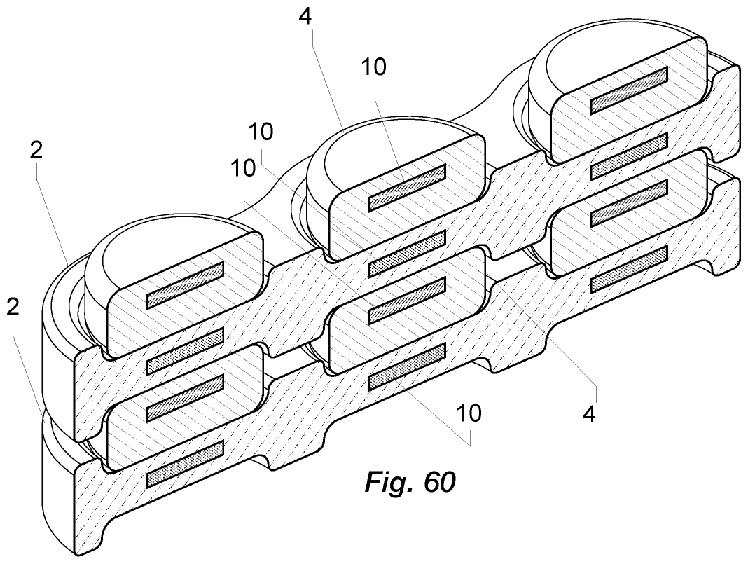

Offset Magnets within Markers. As shown in FIGS. 40-61, in an example, some or all of the magnetic unit markers 4 provided in the building set can have the magnets 10 provided therein offset within the unit marker 4 body and biased towards one face of the marker 4 FIGS. 41, 43, 52 & 54. The offset magnet 10 in a unit marker 4 of this design can be positioned such that a first face of the magnet 10 lies closer to a first face on the exterior of the unit marker 4 than the second face of the magnet 10, which lies further from the second face on the exterior of the unit marker 4. The distance between the first exterior face of the unit marker 4 and the first face of the magnet 10 therein may be less than the distance between the second exterior face of the unit marker 4 and the second face of the magnet 10 therein. Therefore, the strength of the magnetic force measured at the first exterior face of the unit marker 4 may be stronger than the magnetic force measured at the second exterior face of the unit marker 4. When the first face of the unit marker 4, having a magnetic polarity of South is inserted into a corresponding indent 3 within a tray 2 having a magnetic polarity of North, the attractive force present between the first face of the unit marker 4 and the face of the indent 3 may be of a magnitude which we can call magnitude A. Conversely, when the second face of the unit marker 4, having a magnetic polarity of North is inserted into a corresponding indent 3 within a tray 2 having a magnetic polarity of South, the attractive force present between the second face of the unit marker 4 and the face of the indent 3 may be of a magnitude which we can call magnitude B. Magnitude A may be greater than magnitude B.

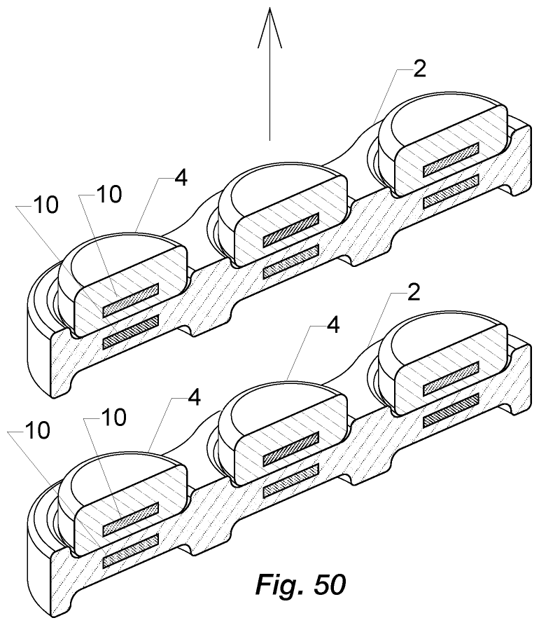

Two trays 2 can be stacked together with an intervening set of unit markers 4 with offset magnets 10 resting within the upward facing indents 3 of the first tray 2, which rests on a work surface, and accordingly resting in the downward facing indents 3 of the second tray 2 which have been stacked atop the unit markers 4. In this arrangement, the magnets 10 in both the trays 2 and the unit markers 4 may have their North poles facing upward and their South poles facing downward. The downward faces of the unit markers 4 and the faces of the indents 3 within the first tray 2 may have an attractive force of magnitude A. The upward faces of the unit markers 4 and the faces of the indents 3 within the second tray 2 may have an attractive force of magnitude B. When a student holds the first tray 2 secure to the work surface, grasps the second tray 2 and removes it from the tray assembly 12, the unit markers 4 are more likely to remain within the indents 3 of the first tray by nature of the relationship where magnitude A is greater than magnitude B as shown in FIG. 50.

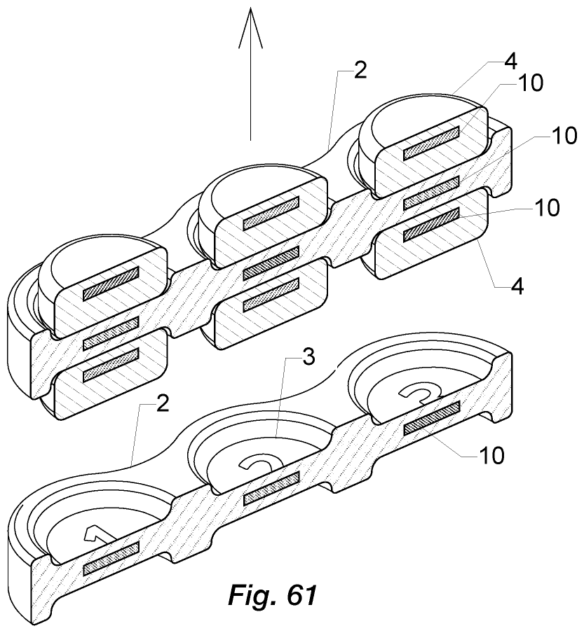

Conversely, the entire two tray assembly 12 and unit marker assembly 5 just described can be reoriented such that the second tray 2 rests on the work surface and the first tray 2 is stacked atop the unit markers 5 resting within the upward facing indents 3 on the second tray 2. In this second arrangement, the magnets 10 in both the trays 2 and the unit markers 4 may have their South poles facing upward and their North poles facing downward. The downward faces of the unit markers 4 and the faces of the indents 3 within the second tray 2 may continue to have an attractive force of magnitude B. The upward faces of the unit markers 4 and the faces of the indents 3 within the first tray 2 may continue to have an attractive force of magnitude A. When a student holds the second tray 2 secure to the work surface, grasps the first tray 2 and removes it from the assembly 12, the unit markers 4 are more likely to remain within the downward facing indents 3 of the first tray 2 and be removed from the upward facing indents 3 of the second tray 2, again by nature of the relationship where magnitude A is greater than magnitude B, as shown in FIG. 61. The magnets 10 within the markers 4 and the magnets 10 within the trays 2 can be embedded such that their polarities are reversed, counter to those polarities disclosed above, and all functionality disclosed herein can be maintained.

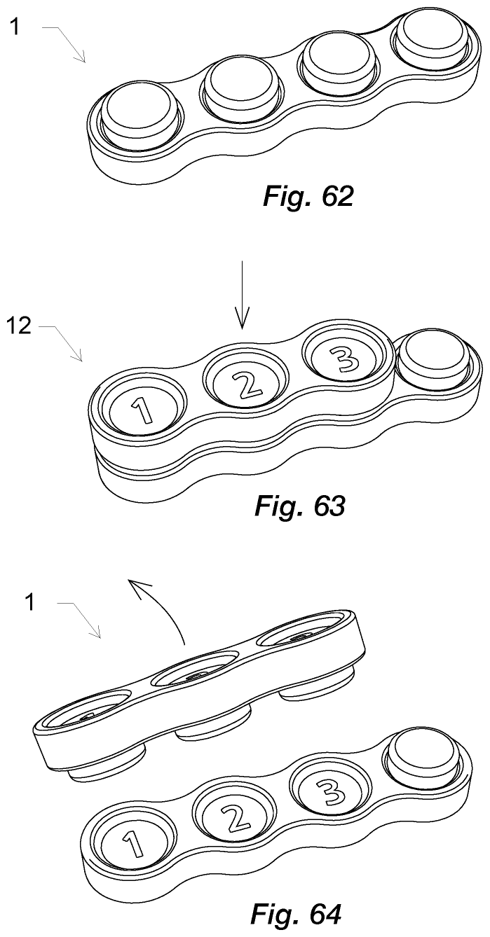

Subtraction Operation Exercise. As shown in FIGS. 61-67, with instruction from a teacher, a student may learn to perform the subtraction operation of arithmetic using tray and unit marker assemblies 12. If desired, the teacher and student may augment the subtraction operation exercise using the quantity cards 16, operator cards 18, and equality cards 19 disclosed hereinabove. To begin the subtraction operation exercise, the student places on the work surface a first tray 2 that represents the quantity from which another quantity may be subtracted. The student places the tray 2 on the work surface such that magnets 10 therein have the South poles facing upward and the North poles facing downward. The student can then perform the counting exercise disclosed hereinabove whereby the student inserts unit markers 4 into the upward facing indents 3 of the first tray 2 while counting aloud for each unit marker 4 that has been inserted FIG. 62. The student may implement unit markers 4 whereby the magnets 10 are centered within the marker body or the student may implement unit markers 4 whereby the magnets 10 are offset within the marker body as previously disclosed. In an example of the subtraction exercise, the student implements the unit markers 4 which have their magnets offset within their bodies.

The student inserts the unit markers 4 into the indents 3 in the first tray 2 such that the faces of the markers 4 with the greater distance between exterior marker face and interior magnet 10 are resting within the indents 3. The North poles of the magnets 10 within the unit markers 4 inserted may be facing downward and attracted to the upward facing South poles of the magnets 10 within the indents 3 within the first tray 2. The attractive force between the faces of the markers 4 and the faces of the indents 3 in which they are resting provides an attractive force which we have called magnitude B hereinabove. The South poles of the magnets 10 within the unit markers 4 may be facing upward.

Next, the student may select the quantity card 16 that equals the quantity of unit markers 4 within the indents 3 of the first tray 2 and place it onto the work surface with the side which has been printed with a pictorial representation 15 of the first tray facing upwards. The teacher may then present to the student the sign operator card 17 that has the minus sign printed thereon. The student can then place the minus operator card 17 adjacent to the first quantity card 16.

Continuing with the subtraction exercise, the student next chooses a second tray 2 that represents the quantity that may be subtracted from the first tray 2 and of a lesser quantity than is represented by the first tray 2. The student can then stack the second tray 2 atop the assembly 12 of unit markers and first tray such that the unit markers 4 within the first tray 2 are inserted into the indents 3 in the underside of the second tray 2. The magnets 10 within the indents 3 in the second tray 2 may have their North poles facing downward and may be attracted to the upward-facing South poles of the magnets within the unit markers 4 by a force we have called magnitude A hereinabove. Because the distance between the upward facing exterior faces of the unit markers 4 and the interior magnets 10 within the bodies of the markers 4 is the lesser distance, the magnets 10 within the unit markers 4 and the magnets 10 within the indents 3 of the second tray 2 are in closer proximity to each other than are the magnets 10 within the unit markers 4 and the magnets 10 within the indents 3 of the first tray 2. Magnitude A may be greater than magnitude B.

Next the student may select a second quantity card 16 that equals the quantity of indents 3 within the second tray 2 and place it onto the work surface such that the side which has been printed with a pictorial representation 15 of the second tray 2 is facing upwards and the quantity card 16 is adjacent to the minus operator card 17. The teacher can next present to the student the equals sign card 19 and instruct them to place the card 19 on the work surface adjacent to the second quantity card 16. Looking at the present arrangement of cards 13 on the work surface, the student may have placed a first quantity card 16 followed by a minus sign operator card 17 followed by a second quantity card 16 and followed finally by an equals sign card 19 as illustrated in FIG. 66.

At this stage in the subtraction exercise, the student may have created on the work surface an assembly 12 including a first tray 2, unit markers 4 inserted therein and a second tray 2 of a lesser represented quantity than the first tray 2 which has been stacked atop the unit markers 4 within the first tray 2. Referring at the arrangement of trays 2 and unit markers 4, the teacher may point out to the student that a certain quantity of unit markers 4 has been covered by the second tray 2 and a certain quantity of unit markers 4 have not been covered by the second tray 2 and are still clearly visible FIG. 63. The teacher may then instruct the student to count the quantity of unit markers 4 that are clearly visible and not covered by the second tray 2. The quantity of unit markers 4 clearly visible and not covered by the second tray 2 represents the solution to the subtraction operation exercise. This stage of the exercise can also be illustrated with standard positions for the magnets 10, meaning those positions not offset within the bodies of the markers 4.

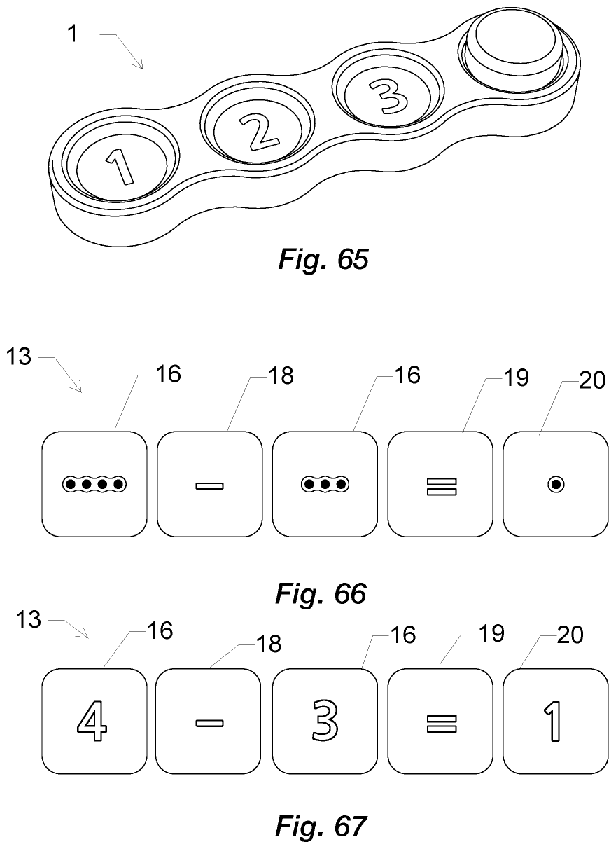

To further illustrate the subtraction operation, the student may hold the first tray 2 securely to the work surface with a first hand and then grasp the second tray 2 and remove it from the assembly 12 with a second hand. By nature of the relationship between the offset magnets 10 within the markers 4 to the magnets 10 within the indents 3 within the trays 2, and whereby magnitude A is greater than magnitude B, the unit markers 4 are more likely to remain within the downward facing indents 3 of the second tray 2 and to be removed from the upward facing indents 3 within the first tray 2 as shown in FIG. 64. The quantity of unit markers 4 represented by the second tray 2 and within the indents 3 of the second tray 2 has been taken away from the quantity of unit markers 4 represented by the first tray 2 and within the indents 3 of the first tray 2. The second tray 2 can be set aside on the work surface. The teacher now instructs the student to count the unit markers 4 that remain within the indents 3 within the first tray 2. As shown in FIG. 65, the quantity of unit markers 4 that remain in the first tray 2 represents the solution to the subtraction operation exercise.

The teacher next instructs the student to select a quantity card 16 which equals the quantity of markers 4 remaining in the first tray 2, and thus becomes the solution card 20. The student can place the solution quantity card 20 adjacent to the equals sign card 19 FIG. 66. The teacher may now instruct the student to flip the quantity cards 16 over such that the sides which have been printed with the numeral representation 14 of the quantities are facing upwards FIG. 67. The teacher and student may discuss the significance of the numeral quantity cards 16 and their relationship to the quantity represented by the first tray 2, the quantity represented by the second tray 2, the quantity of unit markers 4 removed from the first tray 2 and resting within the second tray 2, and finally the quantity of unit markers 4 remaining in the first tray 2 after the completion of the subtraction operation.

In other examples, exercises may implement more than one tray 2 for the quantities in the operation. For example, 7 minus 6 implements a 5 tray and a 2 tray on the bottom, and a 5 tray and a 1 tray on the top to be implemented for the subtraction. Still other examples are also contemplated which will be readily understood by those having ordinary skill in the art after becoming familiar with the teachings herein.

Ten-Frame Tray and Exercises. Ten-frames are common educational devices implemented to illustrate quantities up to and including ten. Ten-frames are provided in a variety of forms and materials such as paper, cardboard, plastic, wood or other suitable material. The common feature of all ten-frames is a frame, grid or other configuration having ten holes, slots, grid cells, or other form of divisions, typically arranged in two rows of five. A ten-frame has two rows of five, totally ten cells. Five-frames have one row of five such divisions. In the example of a ten-frame, a student may draw dots in the grid cells if the ten-frame is printed on paper. In other forms, a student may manipulate counters by placing them within the divisions on a ten-frame.

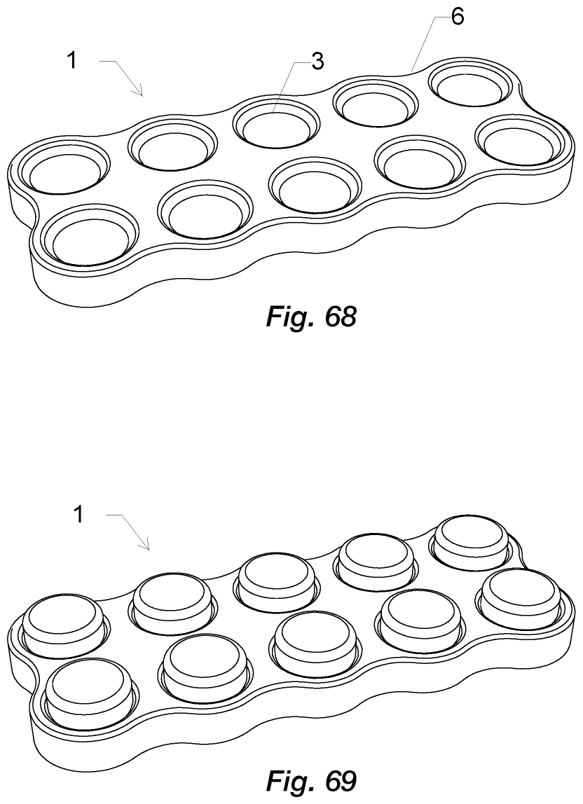

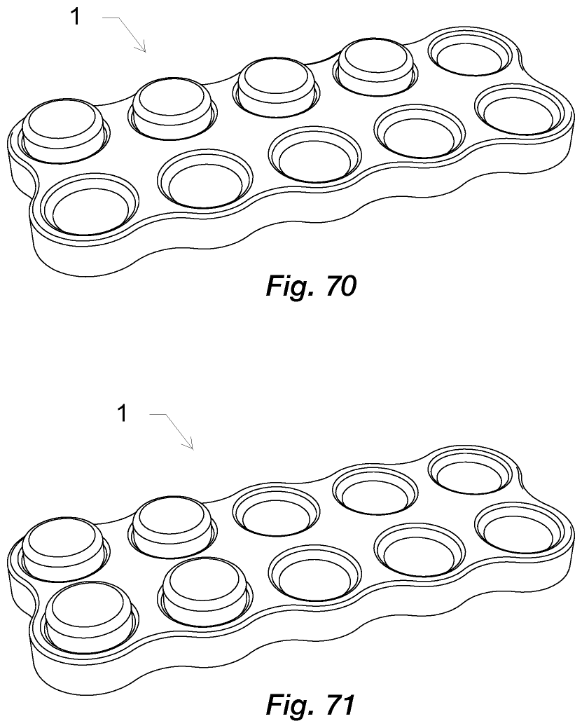

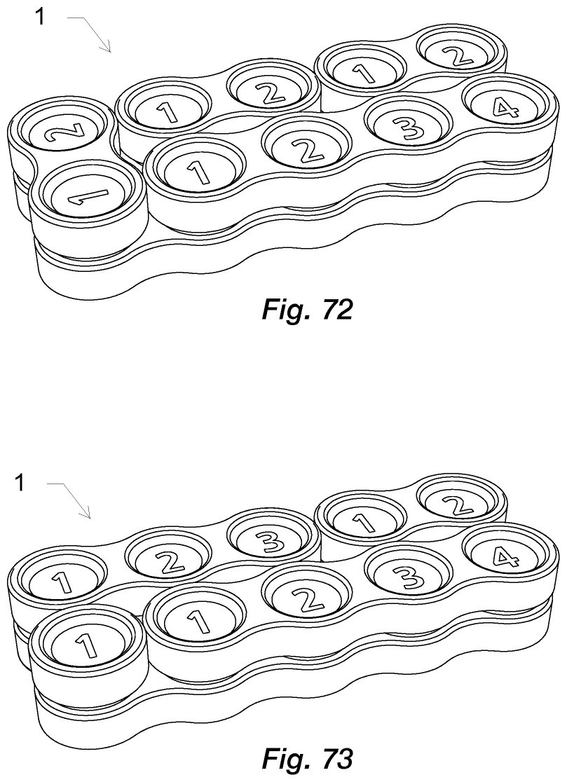

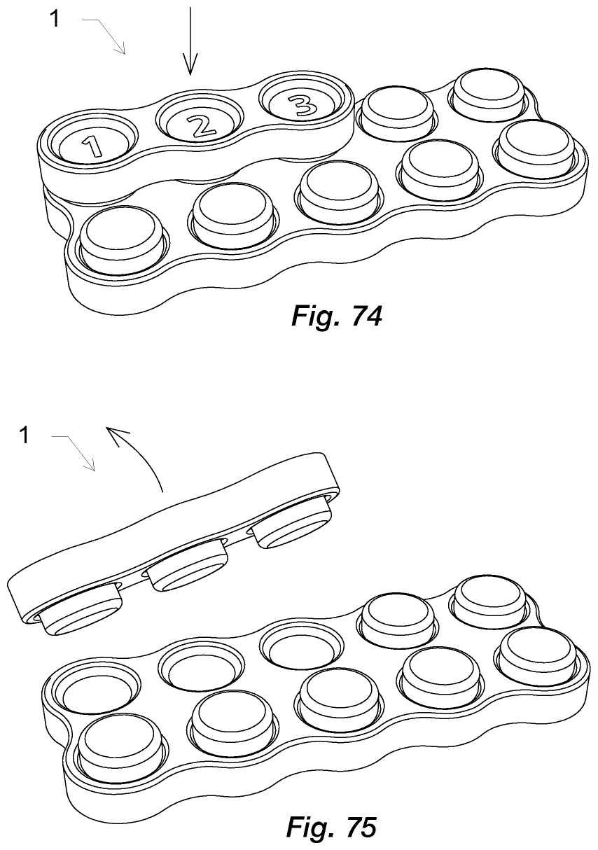

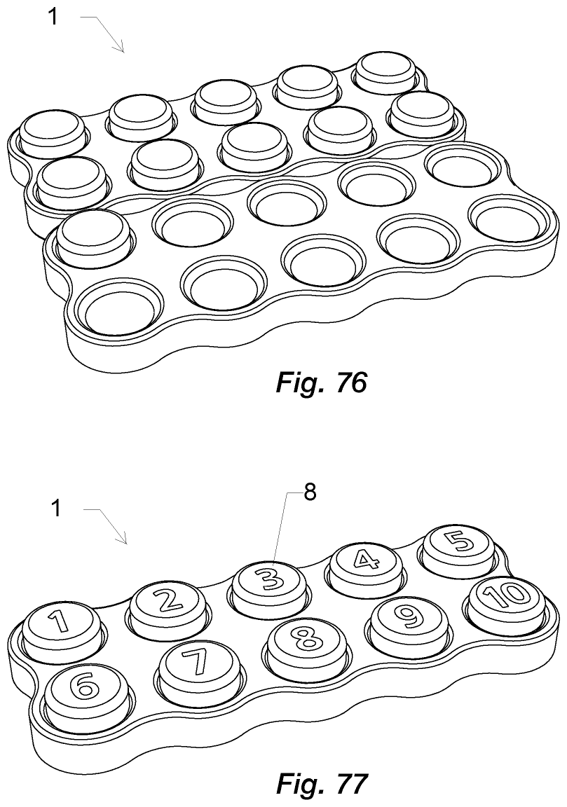

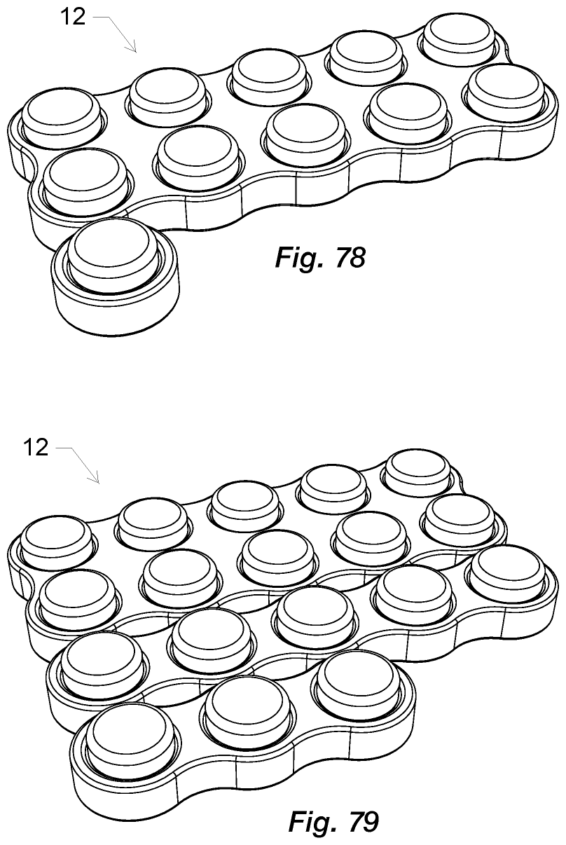

As shown in FIGS. 68-79, A ten-frame tray 6 can be provided with the building set 1. This tray 6 may be configured to have a total of ten indents 3 arranged in two rows of five on a first side, and a total of ten indents 3 arranged in two rows of five on a second side. In accordance with the design of the trays 2 previously disclosed, the ten-frame tray 6 may have magnets 10 embedded within the indents 3 in the tray 6. A student may place unit markers 4 within the indents 3 of the ten-frame tray 6 in a variety of arrangements that prompt further understanding of representations of quantity within the ten-frame tray 6. A student may place unit markers 4 in a first column to represent a quantity up to and including five. A student may place unit markers 4 in rows of two to represent even quantities up to and including ten. A teacher may illustrate to the student how when an odd number greater than one is represented by a quantity of unit markers within the indents 3 in the ten-frame tray 6, there can be a row of two unit markers 4 or a plurality of rows of two unit markers 4, followed by a row that contains a single unit marker 4. The building set 1 disclosed provides a benefit whereby trays 2 can be stacked atop the unit markers 4 within the indents 3 of the ten-frame tray 6 to further illustrate to a student the concepts of number composition and number decomposition within the context of the quantity ten represented by the ten-frame tray 6. The building set 1 disclosed also provides a further benefit whereby unit markers 4 with offset magnets 10 can be inserted into the indents 3 within the ten-frame tray 6 and in concert with a tray 2 stacked atop the unit markers 4 and as disclosed hereinabove in the subtraction operation exercise, be implemented to subtract or take away a quantity of unit markers 4 from the ten-frame tray 6.

Quantities greater than ten can be represented by placing a first ten-frame tray 6 on a work surface, placing a second ten-frame tray 6 adjacent to the first ten-frame tray 6, and inserting unit markers 4 into both ten-frame trays 6. Quantities greater than ten can also be represented by placing a ten-frame tray 6 on a work surface and then placing one or more unit-trays 2 adjacent to the ten-frame tray 6 and inserting unit markers 4 into the indents 3 within all the trays 2 and 6.

A pictorial representation of the ten-frame tray 6 can be included in the pictures 15 printed on the quantity cards 16 disclosed hereinabove, to represent the quantity ten, either by itself or as a component of a larger quantity, for example whereby a pictorial representation 15 of a ten-frame tray 6 is printed on a quantity card 16 adjacent to a pictorial representation 15 of a one-unit tray printed on the quantity card 16 which counted together represent the quantity “11”.

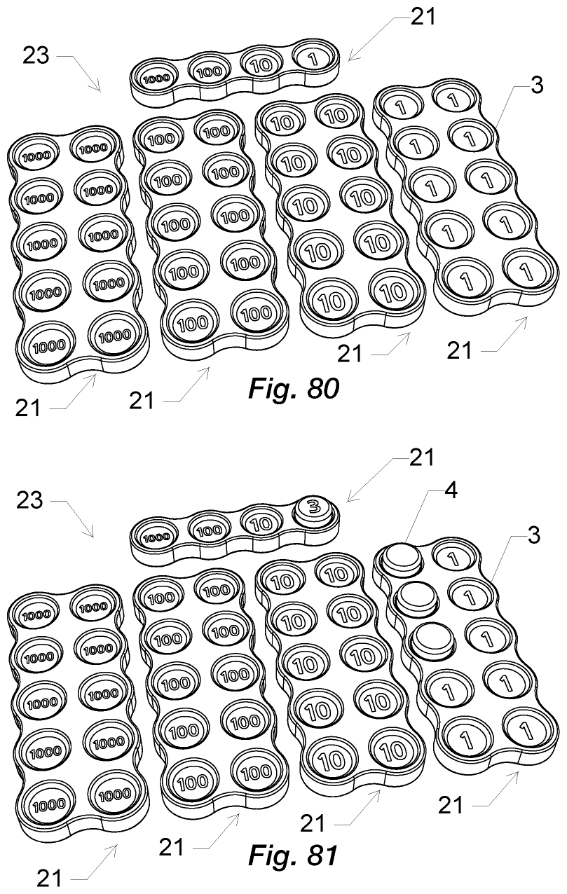

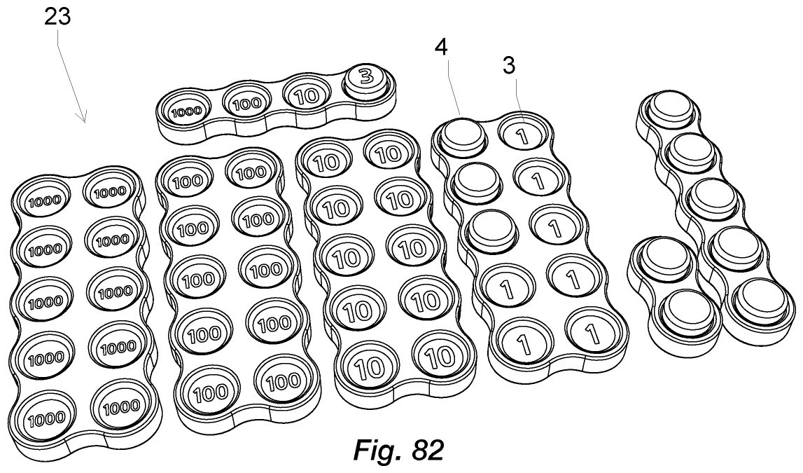

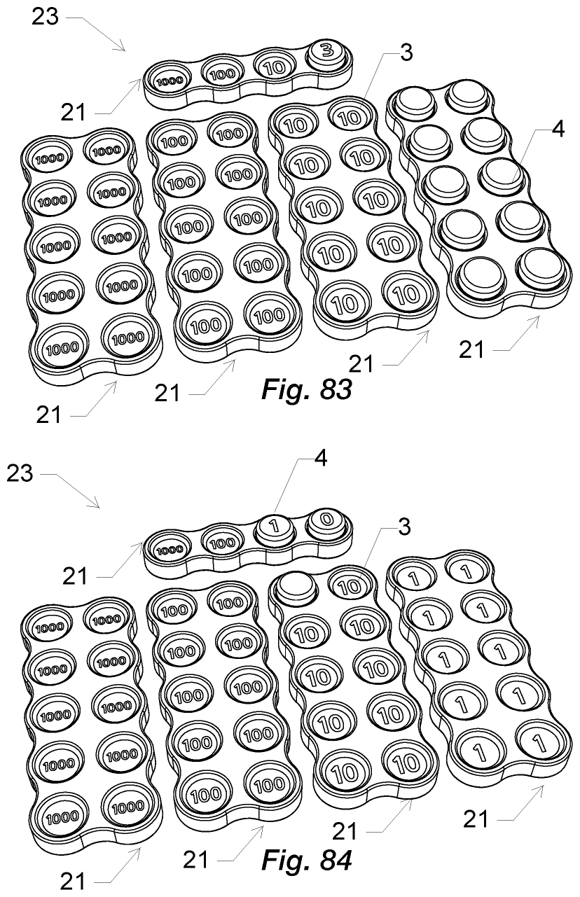

Place Value Trays and Large Numbers. As shown in the examples in FIGS. 80-87, the building set 1 can be provided with specialized trays 2 for teaching the mathematical concept of place value, large number modeling and the operations of addition and subtraction with large numbers. In an example, a ten-frame tray 6 can be provided that has printed, painted, debossed, etched or otherwise inscribed in every indent 3 the numeral “1” and may represent the ones place value. Another ten-frame tray 6 can be provided that has printed, painted, debossed, etched or otherwise inscribed in every indent 3 the numeral “10” and may represent the tens place value. Yet another ten-frame tray 6 can be provided that has printed, painted, debossed, etched or otherwise inscribed in every indent 3 the numeral “100” and may represent the hundreds place value. Still another ten-frame tray 6 can be provided that has printed, painted, debossed, etched or otherwise inscribed in every indent 3 the numeral “1000” and may represent the thousands place value. These special ten-frame trays 6 may be referred hereafter to as place value trays 21.

In another example, to represent place value numbers “1000” and higher, the abbreviation for kilo using the letter “k” may be implemented in the markers and/or indents 3. For example, the indicia 7 within the indents 3 in the thousands place value tray 21 may be written as “1 k.” Proceeding logically, place value trays 21 may be provided for 10 k and 100 k. To model numbers in the millions, the abbreviation for million using the letter “m” may be implemented in the tray indents 3. In an example, the place value trays 21 can be oriented vertically whereby the indents 3 form two vertical rows of five and indicia 7 in the indents are inscribed such that they can be read when the place value tray 21 is positioned in the preferred orientation.

A specialized tray 2 can be provided that has inscribed within the indents 3 a sequence of place value numerals starting with the numeral “1” in the right-most indent and increasing by a factor of 10 in each successive indent in a right-to-left direction. This tray can be hereafter referred to as the solution tray 22. For example, a solution tray 22 may be provided with an indicium 7 of the number “1” in a first indent 3 that sits at the right-most indent position, an indicium 7 of the number “10” in a second indent 3 that sits to the left of the first indent 3, an indicium 7 for the number “100” in a third indent 3 that sits to the left of the second indent 3 and an indicium for the number “1000” in a fourth indent 3 that sits to the left of the third indent 3. In an example, the solution tray 22 may be oriented horizontally on a work surface so that the indicia 7 may be read from left to right or from right to left depending on the exercise being undertaken by the student.

The solution tray 22 may be positioned on a work surface at the top of the arrangement of solution trays 22 and place value trays 21. The place value trays 21 may be positioned in a vertical orientation and below the solution tray 22 on the work surface. The place value trays 21 may be positioned such that their place value representations proceed sequentially in the same manner as do the place value indicia 7 in the solution tray 22 and in a right-to-left direction whereby the ones place value tray 21 sits in the right-most position, the tens place value tray 21 sits to the left of the ones place value tray and continuing until all place value trays 21 have been positioned on the work surface. An arrangement of a solution tray 22 and corresponding place value trays 21 may be referred to herein as a place value tray arrangement 23.

Place Value and Large Number Exercises. With instruction from a teacher, a student may implement the place value tray arrangement 23 in combination with markers 4 to model large numbers, learn the mathematical concept of place value and perform the operations of addition and subtraction on large numbers. In order to model numbers using the place value tray arrangement 23, a student may place markers 4 into the indents 3 starting with the ones place value tray 21 and proceeding to place markers 4 in the successive place value trays 21 until the large number has been modeled. During this process, the student may be instructed to count the markers 4 in each place value tray 21. Next the student selects a marker 4 that has been inscribed with the numeral representing the counted quantity and inserts the selected marker 4 into the indent 3 in the solution tray 22 that corresponds to the place value tray 21 that has been counted. For example, a student may model the number “3” by first inserting three markers 3 into the ones place value tray and then by selecting a marker 4 that has been inscribed with the numeral “3” and finally inserting the marker 4 inscribed with the numeral “3” into the ones place value indent 3 in the solution tray 22 as shown in FIG. 81.

Continuing, a student may perform addition using the place value tray arrangement 23 and markers 4. For example, using FIG. 81 as a starting point, a student may select a five-unit tray 2 and a two-unit tray 2 which together represent the quantity “7”. The student begins by removing individual markers 4 from the five-unit and two-unit trays 2 and inserting them into the ones place value tray 21. As may be easily ascertained, the resulting number of adding “7” to “3” is “10”. The student may see that the ones place value ten-frame tray 21 is completely filled with markers 4 and the markers 4 in the tray number 10. At this stage in the exercise, the teacher may illustrate to the student the concept of place value and the process of regrouping, also known as “carrying over” numbers from a lower place value into the next higher place value. To make this point, the teacher may describe to the student how a completely filled place value ten-frame tray 21 in a first place value can be converted to a single marker 4 in the next higher place value. For example, the teacher may instruct the student to remove all 10 markers 4 from the ones place value tray 21 and then insert a single marker into the tens place value tray 21. At this stage in the exercise, the solution tray 22 may contain a single marker 4 inscribed with the numeral “3” resting in the ones place value indent 3. The teacher may then instruct the student to resolve the solution tray 22 by first counting the quantity of markers 4 in the ones place value tray 21. As the student has removed all markers 4 from the ones tray, the quantity is zero. The teacher instructs the student to select the marker 4 that has inscribed thereon the numeral “0” and insert the marker 4 into the ones place value indent 3 in the solution tray 22. Continuing for the tens place value, the student may count the quantity of markers 4 resting in the indents 3 in the tens place value ten-frame tray 21 which in this exercise may be a single marker 4 representing the quantity 10. Finally, the student may select a marker 4 that has been inscribed with the numeral “1” and place it into the tens place value indent 3 in the solution tray 22 as shown in FIG. 84.

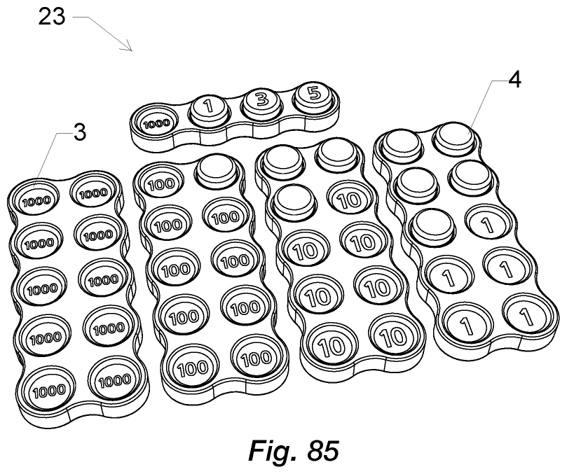

Modeling Large Numbers. In an example, the place value tray arrangement 23 and markers 4 may be implemented to model large numbers, as shown in FIG. 85. Three markers 4 with numerals inscribed thereon rest in the indents 3 in the solution tray 22. In the hundreds place value indent 3, there rests a marker 4 with the numeral “1” inscribed thereon. In the tens place value indent 3, there rests a marker 4 with the numeral “3” inscribed thereon. And finally, in the ones place value indent 3, there rests a marker 4 with the numeral “5” inscribed thereon. Reading the solution tray 22 from left to right illustrates the large number “135”. The markers 4 in the place value trays 21 correspond to the quantity represented in the solution tray 22. In the hundreds place value ten-frame tray 21 rests a single marker 4 corresponding to the numeral “1” inscribed on the marker 4 resting in the hundreds place value indent 3 in the solution tray 22. In the tens place value ten-frame tray 21 rests three markers 4 that correspond to the numeral “3” inscribed on the marker resting in the tens place value indent 3 in the solution tray 22. Finally, in the ones place value ten-frame tray 21 rests 5 markers that correspond to the numeral “5” inscribed on the marker resting in the ones place value indent 3 in the solution tray 22.

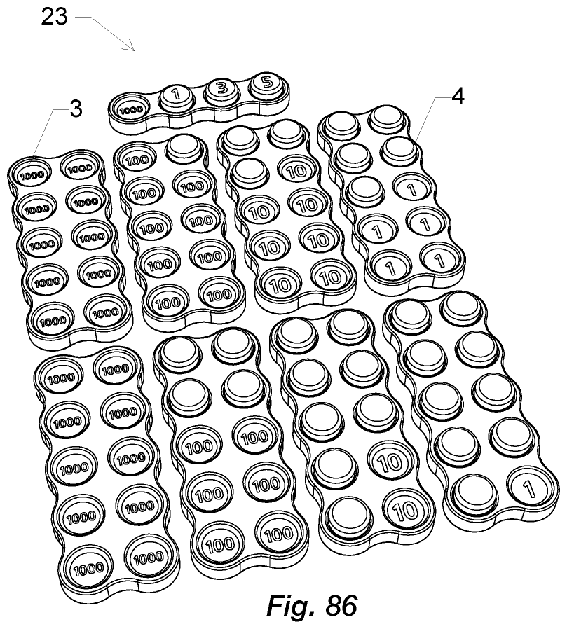

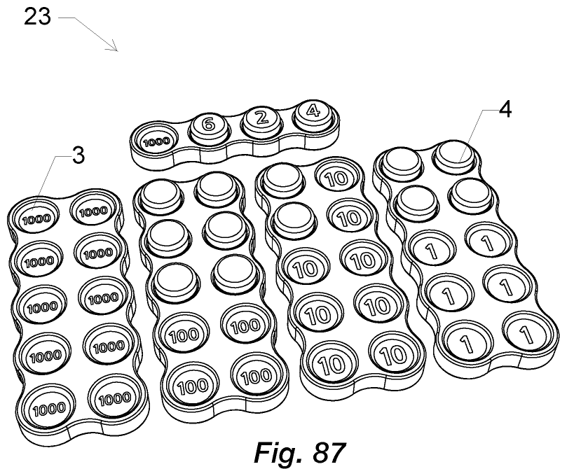

Addition of Large Numbers. In an example, adding at least one additional set of place value trays 21 to the place value tray arrangement 23 enables a student to perform the addition operation on large multi-digit numbers. In an example, additional sets of place value trays 21 are positioned on a work surface below a first set of place value trays 21 with all place value trays 21 of a particular order being aligned vertically. Each additional secondary set of place value trays 21 may be implemented to model the additional numbers in the addition operation. For example, an arrangement for the operation where “489” is added to “135” is shown in FIG. 86. The solution tray 22 shows the number “135”, as modeled by the markers 4 in the first set of place value trays 21. The first set of place value trays 21 represents the first number in the addition operation. The second set of place value trays 21 contains markers 4 that model the number “489” and represents the second number in the addition operation. By using the method disclosed hereinabove, whereby markers 4 are regrouped and “carried over” into the next higher place value and whereby the number of markers 4 in a single place value tray 21 may be counted and represented in the solution tray 22 using markers 4 that have numerals inscribed thereon, a student may add the two large numbers. The resulting solution to the problem of “135+489” is “624” as represented by the place value tray arrangement and markers shown in FIG. 87.

Subtraction of Large Numbers. In an example, a student may perform subtraction of large numbers using the place value tray arrangement 23 in a similar fashion as in the addition exercise disclosed above. Instead of adding markers 4 to the place value trays 21, the student can remove markers 4 and resolve the final number in the solution tray 22. When necessary, the student may regroup from a higher place value tray 21 to a lower place value tray, also known as “borrowing.” For example, a student may need to remove a single marker 4 from the tens place value ten-frame tray 21 and regroup it into ten markers 4 in the ones place value ten-frame tray 21.

Multiplication Operation Exercise. With instruction from a teacher, a student may learn to perform the multiplication operation of arithmetic using tray and unit marker assemblies. If desired, the teacher and student may augment the multiplication operation exercise using the quantity cards 16, operator cards 18, and equals sign cards 19 disclosed hereinabove. To begin the exercise, the student selects a first tray 2 that represents the quantity as the factor in the multiplication exercise. The student may then proceed to insert unit markers 4 into the indents 3 of the first tray 2, counting aloud in sequence beginning with one and proceeding until they have filled all indents 3 within the first tray 2. The teacher may assist the student at this point, noting the total quantity of unit markers 4 which have been counted in the first tray 2.

Next the student may select the quantity card 16 that equals the quantity of unit markers 4 within the indents 3 of the first tray 2 and place it onto the work surface with the side which has been printed with a pictorial representation 15 of the first tray facing upwards. The teacher may then present to the student the operator card 18 that has the multiplication sign printed thereon. The student can then place the multiplication operator card 18 adjacent to the first quantity card 16. The teacher may next present to the student a second quantity card 16 that represents the quantity by which the factor is multiplied. In this exercise, the second quantity card 16 may be referred to as the multiplier card 24. The student can then place the multiplier card 24 adjacent to the multiplication operator card 18 and with the side facing upward which has been printed with the numeral representation 14 of the multiplier quantity.

At this stage in the multiplication operation exercise, the teacher may discuss with the student the nature of the multiplication operation whereby the placing of the first tray 2 and the counting of the unit markers 4 therein may be repeated a number of times that equals the quantity represented by the multiplier card 24. Each new tray 2 may be of the same unit quantity as the first tray 2. The teacher may also point out that the student has already performed the tray placing and unit marker counting exercise a first time. With assistance from the teacher, the student may next repeat the tray placing and unit marker counting exercise an additional number of times until the number of trays 2 placed and filled with unit markers 4 equals the quantity represented by the multiplier card 24. To complete the multiplication operation exercise, the student and teacher examine the tray and marker assemblies 12 placed on the work surface and count the number of trays 2. The quantity of trays 2 on the work surface equals the quantity represented by the multiplier card 24. To complete the multiplication operation exercise, the student may count the total quantity of unit markers 4 within the trays 2 on the work surface and then select a quantity card 16 that represents a quantity that is equal to the total quantity of unit markers 4 counted and which represents the solution to the multiplication operation exercise.

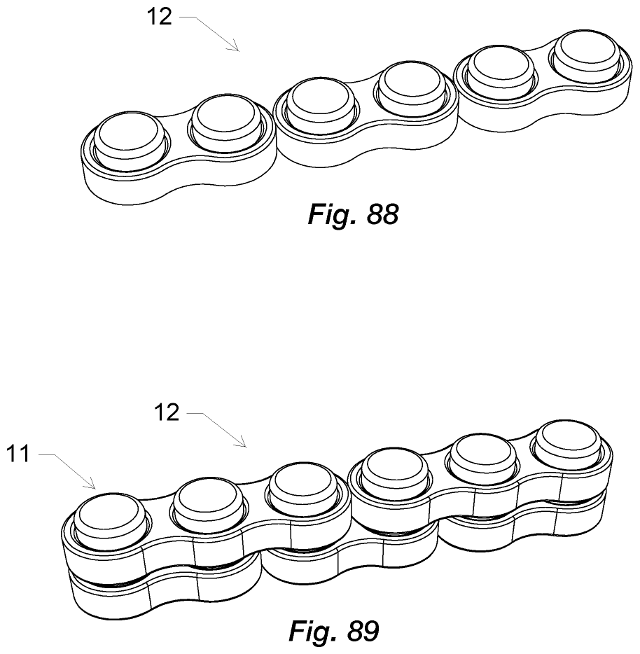

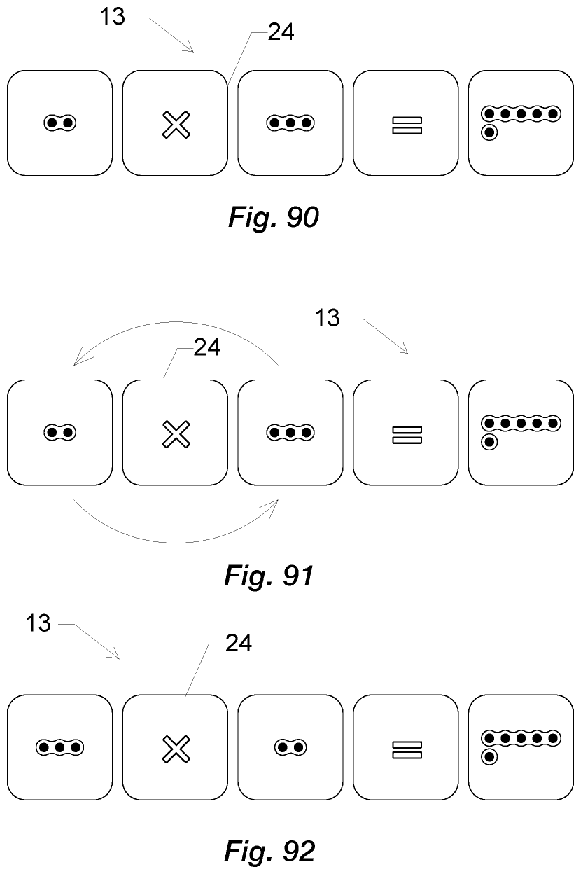

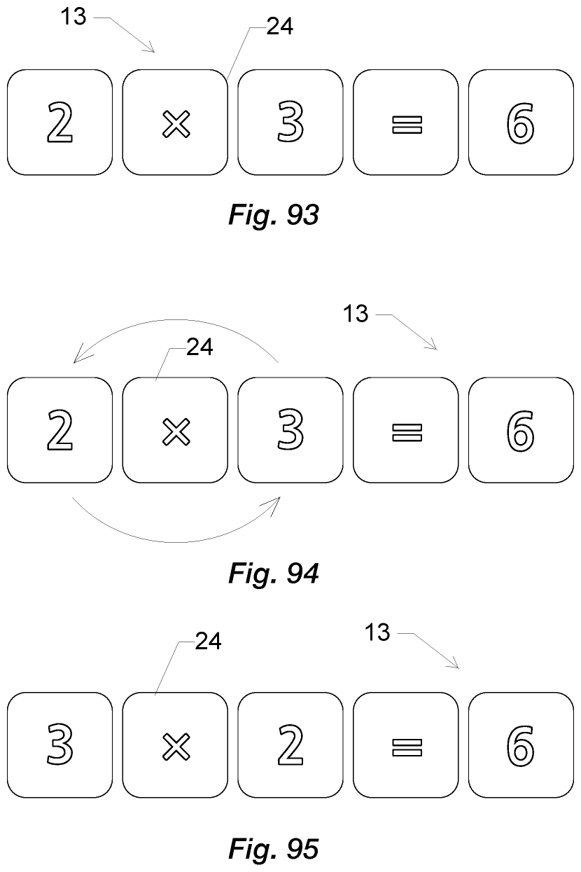

For example, a teacher may assist the student in modeling the multiplication operation “2×3=6” whereby three sets of two-unit trays 2 and marker assemblies 5 may be placed upon the work surface as shown in FIG. 88. The teacher and student may also illustrate the operation with the quantity cards 16, operator cards 18, and equals sign cards 19 utilizing either the pictorial representation 15 or numeral representation 14 of quantity shown in FIG. 90 and FIG. 93 respectively.

Commutative Property of Multiplication Exercise. In an example, upon completing the multiplication exercise disclosed herein, the teacher may illustrate to the student the commutative property of multiplication whereby the factor and multiplier in the operation can have their positions swapped yet the resulting solution of the multiplication problem remains the same. Using the example hereinabove of “2×3=6” as a starting point, the teacher may instruct the student to swap the positions of the quantity card 16 representing the factor, in this case “2”, and the quantity card 16 representing the multiplier, in this case “3”. FIG. 91 and FIG. 94 illustrate swapping the factor and multiplier cards 16 using the pictorial representation 15 or numeral representation 14 of quantity. Upon swapping the factor and multiplier cards 16, the new equation may be written as “3×2=6”.

Next, the teacher may instruct the student to model the new equation using tray and marker assemblies 12. In keeping with the method described hereinabove, the student can select a first three-unit tray 2 and insert markers 4 into each indent. The student may then stack the three-unit tray 2 and marker assembly 5 on top of the two-unit tray 2 and marker assembly 5 that presently rests on the work surface as shown in FIG. 88, aligning one end of the first three-unit tray 2 with the end of the two-unit tray assembly 12. The student may next select a second three-unit tray 2 and insert markers 4 into the indents 3 of the second three-unit tray 2 and again stack the second three-unit tray 2 and marker assembly 5 on top of the two-unit tray assembly 12. The student has modeled “3×2=6” using 2 three-unit trays with markers 4 inserted and has created a new assembly 12 combining the first assembly 12 of 3 two-unit trays and markers with the second assembly 12 of 2 three-unit trays 2 and markers 4 as shown in FIG. 89.

The teacher may instruct the student to count the markers 4 that are visible on the three-unit tray assembly 12. The student may confirm that there are six markers 4 in the three-unit tray and marker assembly 12 as there are six markers 4 in the two-unit tray and marker assembly 12 resting below the three-unit trays 2. The teacher and student may also observe how the assembly 12 of 2 three-unit trays 2 are of the same length as the assembly 12 of 3 two-unit trays 2. By using the tray and marker assemblies 12 and optionally the quantity cards 16, operator cards 18, and equals sign cards 19, the teacher and student have successfully modeled the commutative property of multiplication.

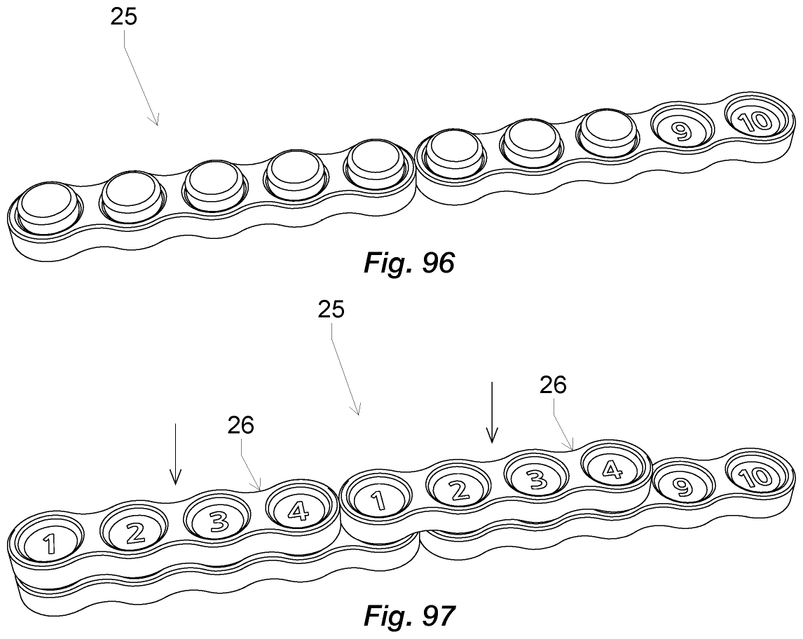

Division Operation Exercise. With instruction from the teacher, a student may learn to perform the division operation of arithmetic using tray and unit marker assemblies 12 as shown in FIGS. 96 and 97. If desired, the teacher and student may augment the division operation exercise using the quantity cards 16, division operator cards 18, and equals sign cards 19 disclosed hereinabove. The student may begin the exercise by selecting a tray 2 or plurality of trays 2 that may be implemented to model the dividend component of the division operation. The student may then place the tray 2 or plurality of trays 2 onto a work surface. If more than one tray 2 is to be implemented to represent the dividend component, the student may place the trays 2 abutted to each other on the work surface and aligned along their longitudinal axes respective to each other. Next the student may insert unit markers 4 into the indents 3 within the tray 2 or plurality of trays 2 until the quantity of unit markers 4 in the trays 2 equals the quantity to be implemented as the dividend component in the exercise. For the purposes of this exercise, the tray 2 or plurality of trays 2 on the work surface and the unit markers 4 contained therein which can be implemented to represent the dividend quantity may be referred to as the dividend tray assembly 25. The student may select the quantity card 16 that equals the dividend quantity and place it onto the work surface. The teacher can then present to the student the operator card 18 which has been printed on one side with the division operator sign, also known as an obelus. The student may place the division operator card 18 onto the work surface and adjacent to the dividend quantity card 16.

In an example, the teacher may now present to the student a quantity card 16 and a corresponding tray 2 that may be implemented as the divisor. In another example, the teacher may instruct the student to select a quantity card 16 and tray 2 to be implemented as the divisor. For the purposes of the division operation exercise, the tray 2 may be referred to as the divisor tray 26. The student may first place the divisor quantity card 16 on the work surface and adjacent to the division operator card 18. The teacher may then discuss with the student the object of the division operation whereby the dividend quantity represented by the first tray 2 or plurality of trays 2 and the unit markers 4 therein may be organized into groups of a quantity defined by the divisor tray 26. The teacher may instruct the student to stack the divisor tray 26 onto the unit markers 4 resting within the indents 3 within the dividend tray assembly 25 such that the unit markers 4 also rest in the indents 3 on the underside of the divisor tray. In keeping with the left-to-right reading of number lines, the student may stack the divisor tray 26 onto the unit markers 4 of the dividend tray assembly 25 starting at the left most unit marker 4 and continuing to the right and along the linear alignment of the unit markers 4. The teacher next instructs the student to count the quantity of unit markers 4 within the dividend tray assembly 25 that is fully visible and not covered by the divisor tray 26. If the quantity of unit markers 4 counted is greater than or equal to the quantity represented by the divisor tray 26, the teacher instructs the student to select another tray 2 of a unit quantity that is equal to the divisor tray 26. This newly selected tray 2 may also be called a divisor tray 26. The student may now stack the second divisor tray 26 onto the unit markers 4 within the dividend tray assembly 25, abutting to and immediately to the right of the first divisor tray 26.

The student may repeat the process of counting the visible and uncovered unit markers 4 within the dividend tray assembly 25 and stacking a newly selected divisor tray 26 onto the unit markers 4 if the quantity counted is greater than or equal to the unit quantity of the divisor tray 26. When no more divisor trays 26 can be stacked on the unit markers 4 within the dividend tray assembly 25 such that all of the indents 3 on the underside of each divisor tray 26 are filled with unit markers 4 of the dividend tray assembly 25, the student may count the total quantity of divisor trays 26 stacked atop the dividend tray assembly 25. The quantity of divisor trays 26 counted is the quotient, thereby the solution to the division operation exercise. If any unit markers 4 remain uncovered by divisor trays 26, the unit markers 4 represent the remainder of the division operation exercise. Division with a remainder is discussed hereinafter in the disclosure of the division operation with fractional remainder exercise.

In an example, with instruction from a teacher, a student may learn division by modeling the equation “8÷4=2” using tray and marker assemblies 12 and optionally, quantity cards 16, operator cards 18, and equals sign cards 19. The student begins by building the dividend tray assembly 25 on the work surface. The student may place a first five-unit tray 2 on the work surface and a second five-unit tray 2 that has inscribed within the indents 3 the numerals 6 thru 10 as shown in FIG. 96.

In another example, the student may place a five-unit tray 2 and a three-unit tray 2 on the work surface. In either case, the student places the trays 2 abutted to each other on the work surface and aligned along their longitudinal axes respective to each other. The student next inserts a total of eight markers 4 into the indents 3 of the trays 2 resting on the work surface, starting with the left-most indent 3 and proceeding in a left-to-right direction. The student has now completed the dividend tray assembly 25.

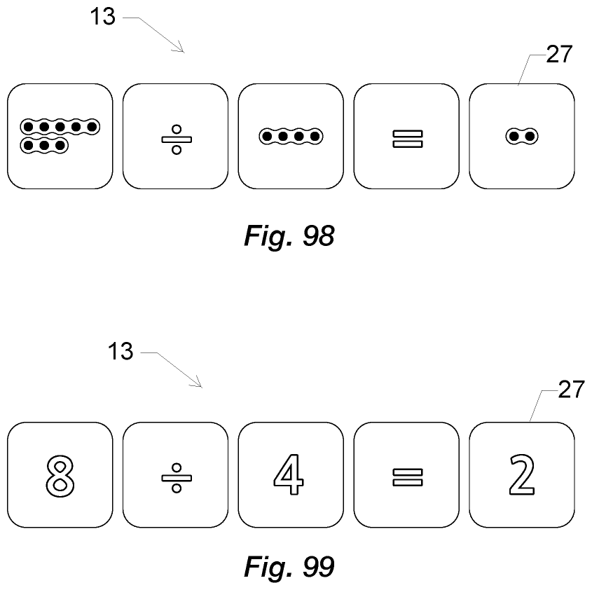

FIG. 98 and FIG. 99 illustrate the implementation of the cards 13 in the division exercise and show, respectively, the pictorial side 15 and numeral side 14 of the quantity card 16. If the cards 13 are to be implemented, the student selects a first quantity card 16 which represents the dividend in the equation, in this case the number “8”, and places it onto the work surface. At the discretion of the student and teacher, the student may place the quantity card 16 onto the work surface with the side facing upward that has printed thereon the pictorial representation 15 of the number “8” or in another example, the numeral representation 14 of the number “8”. The teacher next directs the student to place the division operator card 18 adjacent to and to the right of the dividend card 16. Continuing, the teacher directs the student to select the quantity card 16 for the number “4”, which may be implemented as the divisor, and place the quantity card 16 adjacent to and to the right of the division operator card 18. Finally, the student may place the equals sign card 19 onto the work surface, adjacent to and to the right of the divisor card 16. With direction from the teacher, the student has modeled the equation “8 4=2” using the cards 13, yet leaving the solution space empty.

At this stage in the exercise, the teacher may explain in more detail the purpose of the division exercise by posing the question, “How many fours go into eight? Put another way, how many four trays 2 can we stack in a line on top of the eight markers 4?” The student may begin stacking four-unit trays 2 on top of the eight markers 4 in the dividend tray assembly 25 until all markers 4 have been covered by four-unit trays 2 and no markers 4 remain visible. The teacher may next instruct the student to count the total number of four-unit trays 2 that have been stacked on top of the dividend tray assembly 25, explaining that the solution to the equation in the exercise is “2”. As can be seen in FIG. 97, a total of two four-unit trays 2 stack on top of the dividend tray assembly 25. If the cards 13 are being employed in the exercise, the teacher may direct the student to select the quantity card 16 that represents the number “2” and place it on the work surface adjacent to and to the right of the equals sign card 19. This card for the number represents the quotient in the division equation and can be referred to as the quotient card 27.

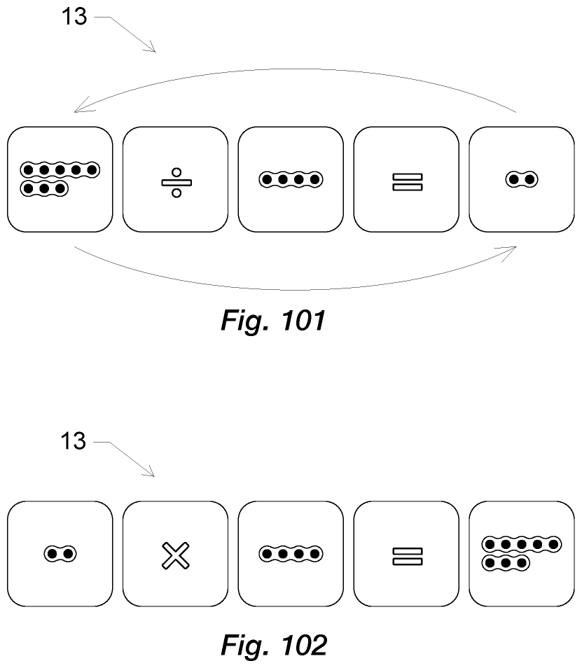

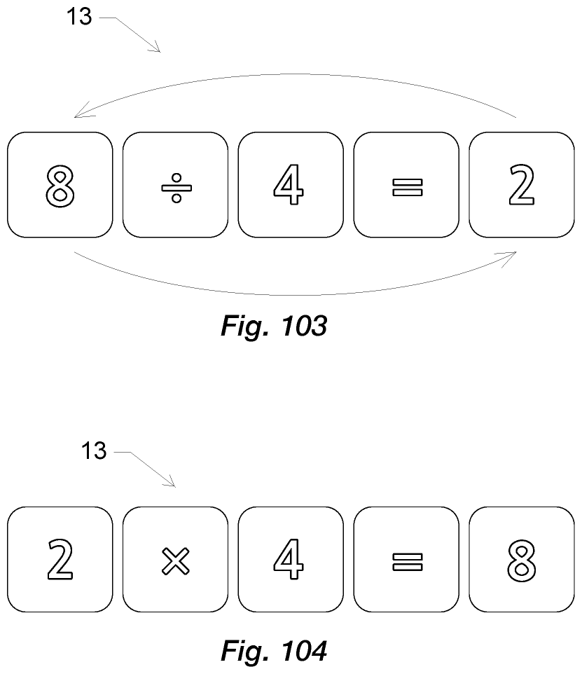

Inverse Relationship of Division to Multiplication Exercise. The teacher may illustrate to the student the inverse relationship of division to multiplication. Upon completing the division exercise disclosed hereinabove, the cards 13 on the work surface model the equation “8÷4=2”. The teacher may explain to the student that the opposite or inverse operation to division is multiplication. If “8÷4=2” is true, then “2×4=8” is also true. To illustrate this fact, the teacher may direct the student to swap the dividend card 16 which represents the number “8” with the quotient card 27 which represents the number “2”. FIG. 101 illustrates the swapping process for the pictorial quantity cards 15 while FIG. 103 illustrates the swapping process for the numeral quantity cards 14. Next, the student may flip over the division operator card 18 which has printed on the reverse side the multiplication operator card 18. FIG. 102 illustrates the inverted equation using the pictorial cards 15 while FIG. 104 illustrates the inverted equation using the numeral cards 14.

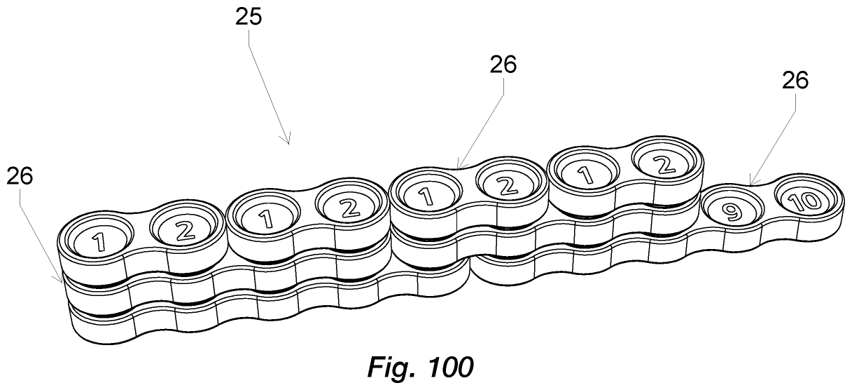

Continuing with the exercise, the teacher may assist the student in modeling the inverse relationship described hereinabove using tray and marker assemblies 12. With the teacher and student having modeled the equation “8÷4=2” as described hereinabove, there rests on the work surface the tray and marker assembly 12 as shown in FIG. 97. The teacher may direct the student to place markers 4 into the upward-facing indents 3 in the two four-unit trays 2 that are positioned at the top of the assembly 12. The student may then model the inverse equation “2×4=8” as represented by the arrangement of cards 13 that also rests on the work surface as shown in either FIG. 102 or FIG. 104. The student may stack four two-unit trays 2 onto the markers resting in the two four-unit trays 2 in the assembly 12 as illustrated in FIG. 100. The teacher and student may observe that the assembly 12 of two four-unit trays 2 and respective markers 4 and the assembly of four two-unit trays 2 and respective markers 4 are equal in length and thereby demonstrates the inverse relationship of the two equations.

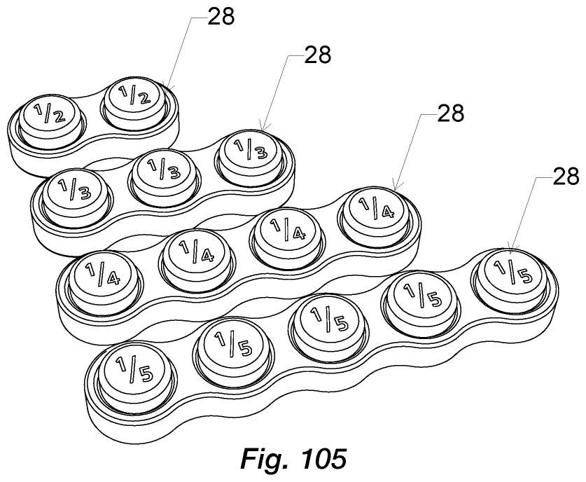

Markers with Numerical Fractions. In an example, some or all of the unit markers 4 in the building set 1 can be printed, painted, debossed or otherwise inscribed on a first side, a second side or on both sides with a numerical fraction 28, comprising a first numerical indicium set above a solidus, also known as a fraction slash, followed by a second numerical indicium set below the solidus, and thereby can be implemented to represent numerical fractions 28. Unit markers 4 with fractions 28 printed thereon can be provided for each unit-tray 2 quantity included in the building set 1. The fractions 28 on the unit markers 4 that correspond to a particular tray 2 can have as the numerator the numeral 1 and as the denominator the numeral that represents the quantity that is equal to the quantity represented by the tray 2. For example, the indents 3 on the upward facing side of a two-unit tray 2 can be filled with unit markers 4 that each have printed thereon the fraction ½. A single such unit marker 4 in the context of the two-unit tray 2 can be considered one half of the total quantity represented by the three-unit tray 2. Continuing, the indents 3 on the upward facing side of a three-unit tray 2 can be filled with unit markers that each have printed thereon the fraction %. A single such unit marker 4 in the context of the three-unit tray 2 can be considered one third of the total quantity represented by the three-unit tray 2. Two such unit markers 4 in the context of the three-unit tray 2 can be considered two thirds of the total quantity represented by the three-unit tray 2. The process and technique of representing fractions 28 using markers 4 and trays 2 can be applied to any whole number whereby the numeral represented by the quantity of indents 3 on the first side of a tray 2 is implemented as the denominator in the numeric fraction 28 that can be printed on an equal quantity of markers 4. For example, FIG. 105 illustrates unit trays and markers with numerical fractions 28 thereon for the whole numbers “2”, “3”, “4” and “5”.

Division with Fractional Remainder Exercise. Consider how the equation “9÷4=2.25” can be written as “9÷4=2¼” when written using fractional notation. In elementary curriculum, this might be expressed in a word problem as “9 divided by 4 is 2 with a remainder of 1.” Using markers with numerical fractions described hereinabove, the building set 1 may be implemented to model the division of whole numbers whereby the quotient produced contains a fractional remainder. Other math manipulatives either do not demonstrate the connection of elementary remainders to fractions and by extension decimal remainder, or ignore remainders in division entirely.

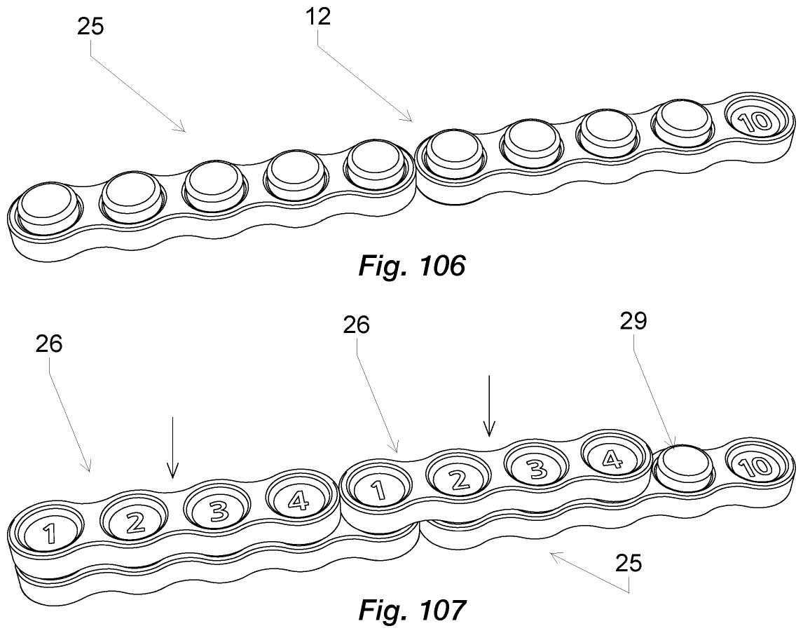

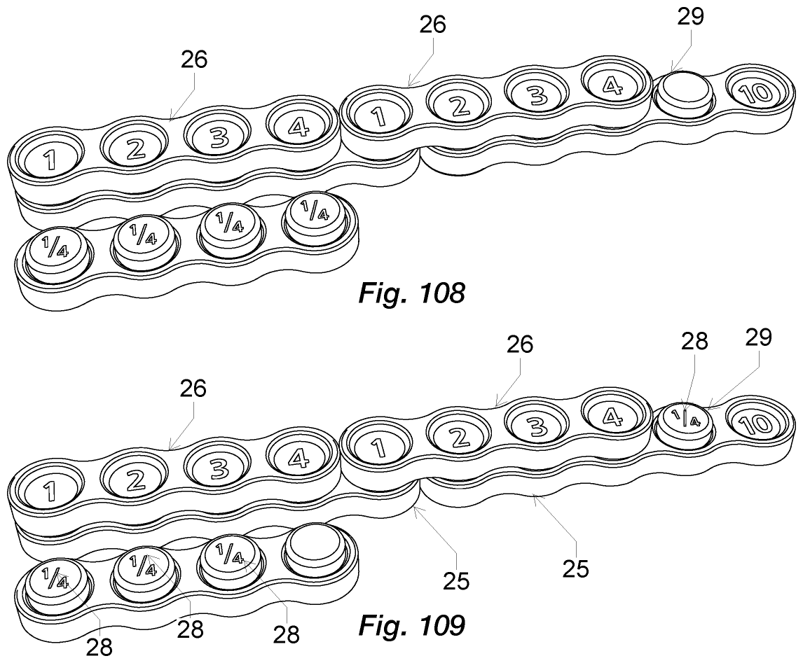

With instruction from a teacher, a student may model the division operation “9÷4” using tray and marker assemblies 12 as shown in FIGS. 106 and 107 and by employing the division operation exercise described hereinabove. As evident from FIG. 107, two four-unit trays 2 can be stacked on top of the dividend tray assembly 25 with one marker 4 remaining uncovered. This single marker 4 represents the remainder of 1 in the word problem “9 divided by 4 is 2 with a remainder of 1.” The teacher may explain to the student that the remaining marker is a partial component of an incomplete four-unit tray 2 since “4” is the divisor in the operation. This remaining marker 4 can be referred to hereafter in the exercise as the remainder marker 29. The teacher may next instruct the student to select a third four-unit tray 2 and place it on the work surface adjacent to the tray and marker assembly 12 already present on the work surface. Continuing, the teacher may instruct the student to insert markers 4 having printed thereon the fraction ¼ into every indent in the third four-unit tray 2 as shown in FIG. 108. This tray assembly 12 can be called the “fourths tray assembly.” At this stage in the exercise, the teacher may further explain the relationship of each the four markers 4 within the four-unit tray 2 to the total quantity represented by the four-unit tray 2; each marker is one of four that is present in the four-unit tray 2 and can be expressed as ¼th of the total number of markers 4 that can be inserted.

Going further, the teacher may explain to the student that the single marker 4 that remains uncovered in the division tray assembly 25 can also be considered ¼th of a four-unit tray 2 and may instruct the student to swap the remainder marker 29 in the division tray assembly with one of the ¼th markers 4 in the fourths tray assembly 12 as shown in FIG. 109. The teacher may instruct the student to remove the third four-unit tray 2 from the work surface or optionally leave it in place. Finally, the teacher may explain to the student how they have modeled “9 divided by 4” and how the resulting solution can be read in the division tray assembly as “9÷4=2¼”, as evident in FIG. 109. Optionally, the teacher may direct the student to convert the fraction ¼ into decimal notation using a calculator and therefore expressing the solution as “9÷4=2.25”.

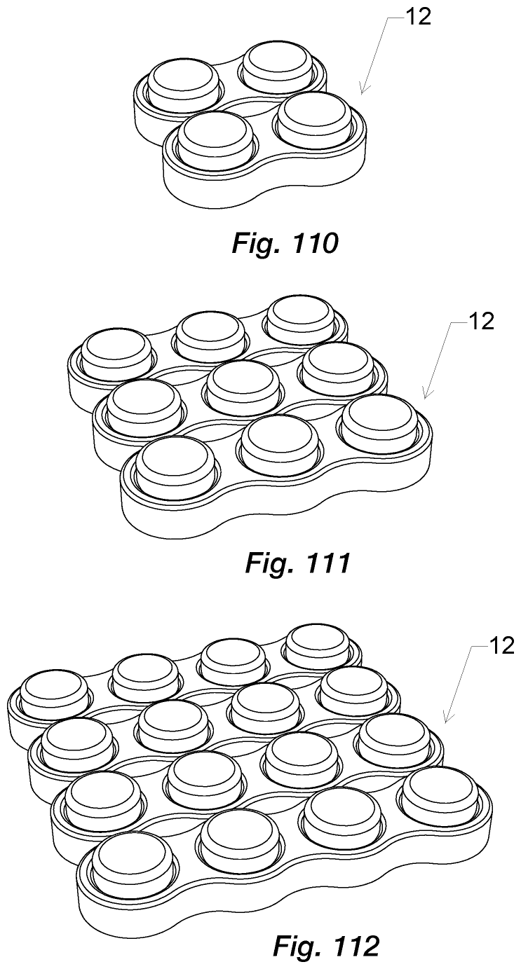

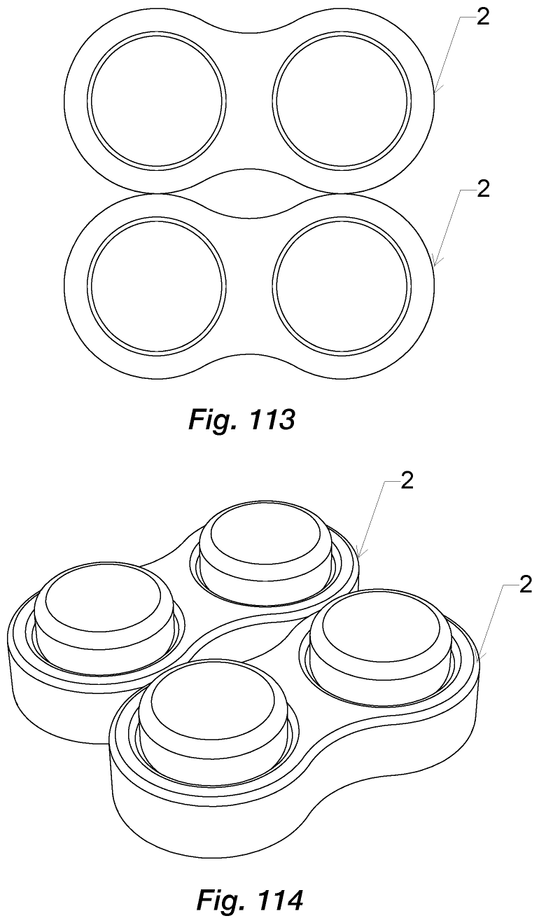

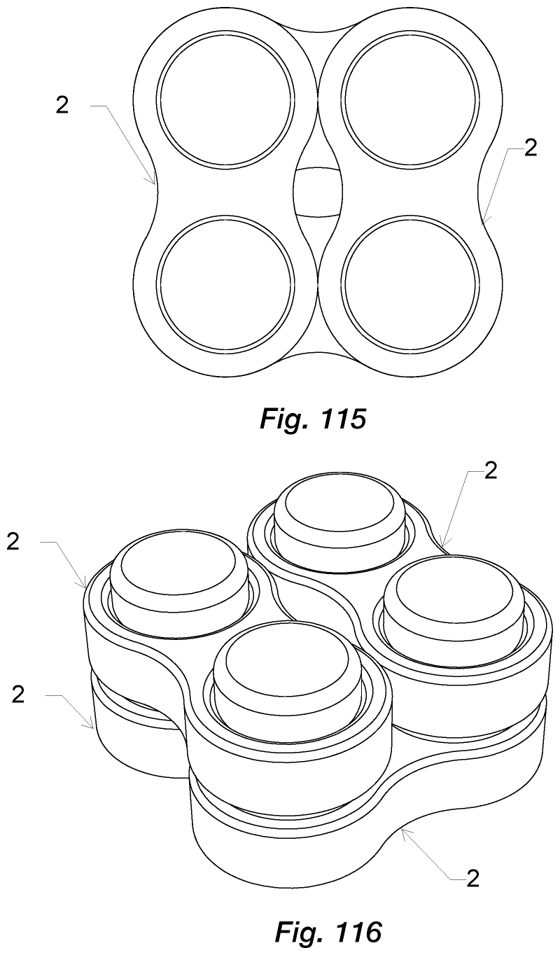

Squared Number Arrangements. With instruction from a teacher, a student may model squared numbers using tray and marker assemblies 12, as shown in FIGS. 110-112. For example, a student may first choose a number to square. The student may then select a tray 2 that represents that number and place it on a work surface. The student may continue placing trays 2 of the previously selected unit quantity onto the work surface until the quantity of trays 2 also equals the chosen number. The student may then arrange the trays 2 in rows in order to form a square arrangement 11. Next, the student may count the markers along each side of the square arrangement 11 and find all quantities are equal. The teacher may then introduce the geometric quality of a square whereby all sides are equal. The quantity cards 16 and operator cards 18 may be implemented to show the student how squaring a number might be written in mathematical notation. For advanced students, the teacher may next introduce the mathematical notation for squared numbers such as 3². Arrangements for 2², 3², and 4² are shown in the drawings.

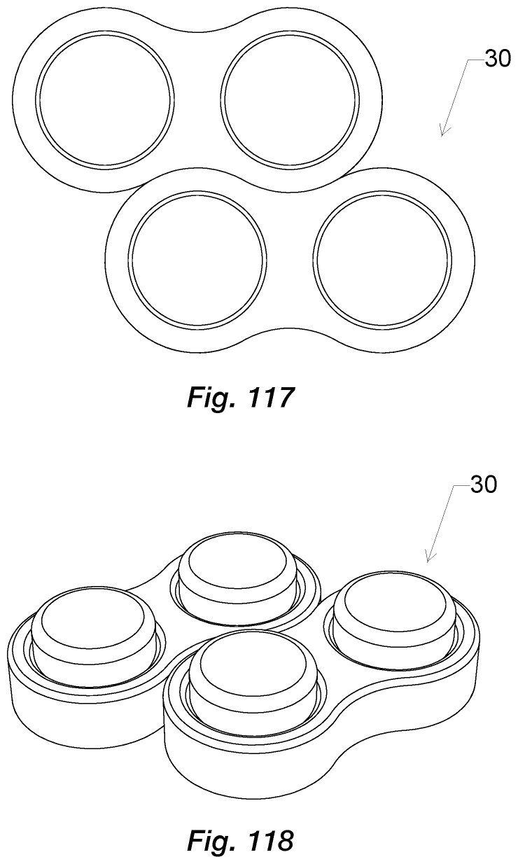

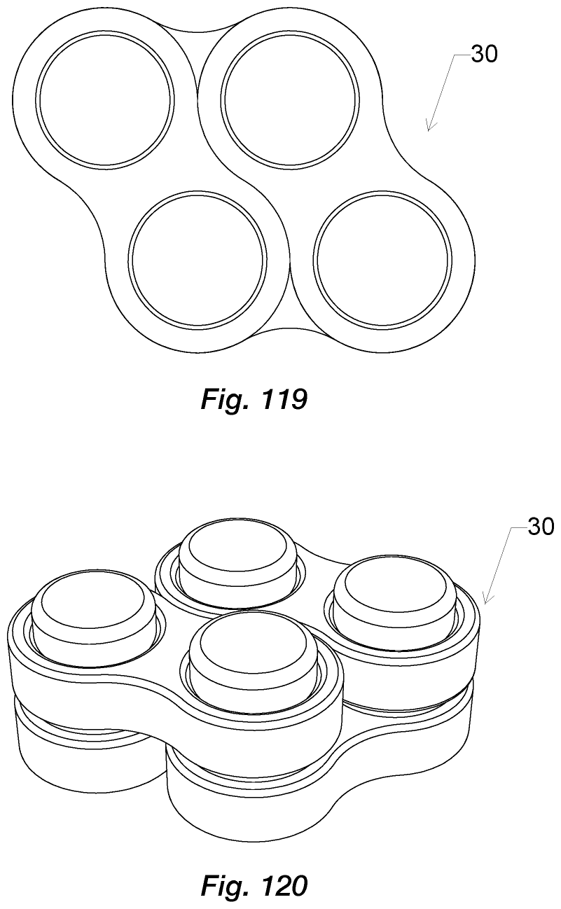

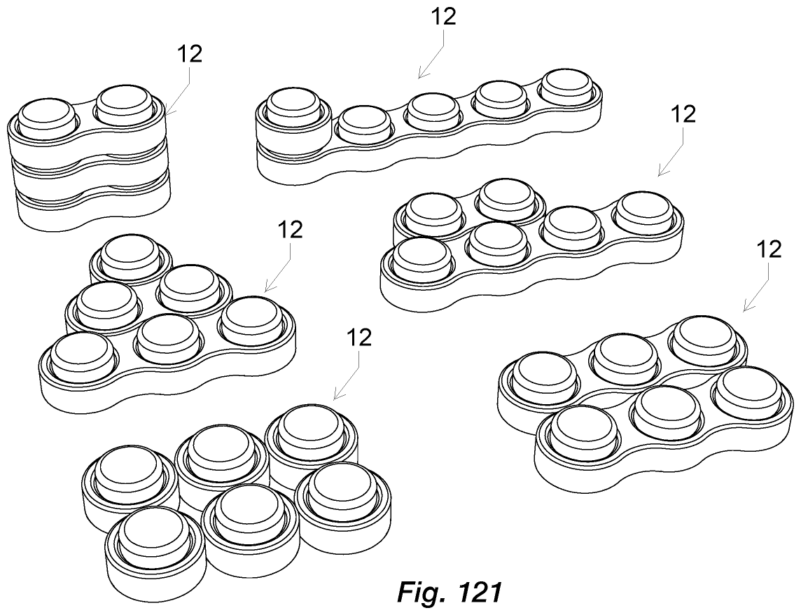

Lateral Interlocking Profile and Multiple Grid Arrangements. In an example, the centerlines of the indents 3 within a tray 2 can be equidistant from each other. In an example, the trays 2 can share a common distance between the centerlines of the indent 3. In an example, two trays 2 may be positioned on a work surface adjacent and abutted to each other and aligned at one end whereby each indent 3 in the first tray 2 may align with an indent 3 in the second tray 2, provided the second tray is of sufficient length as shown in FIGS. 113 and 114. In an example, the distance between the centerlines of the aligned indents 3 between the two abutted trays 2 may be equal to the distance between the centerlines of the indents in a single tray 2. Therefore, as shown in FIGS. 115 and 116, a third tray 2 may be stacked onto the arrangement shown in FIGS. 113 and 114 in a cross-wise fashion whereby the longitudinal axis of the third tray 2 lies perpendicular to the longitudinal axes of the first and second trays 2 in the arrangement 11. As is further evident from FIG. 116, trays can be arranged and stacked in an arrangement 11 that is a square grid pattern.

In an example, a tray 2 may have a radius profile of a first dimension around each indent 3 and a reverse radius profile of the same dimension between each indent 3. In an example, trays 2 can be abutted to each other whereby the indents 3 in a second tray 2 may be aligned between the indents 3 in a first tray 2 and whereby the outer radius profile around the indents 3 in the second tray 2 fit into the inner radius profile between the indents 3 in the first tray 2 as shown in FIGS. 117 and 118 and can be referred to hereafter as tessellated tray assemblies or “lateral interlocking profiles” 30. In an arrangement of this fashion, the distance between centerlines of the indents 3 in the first tray 2 and the second tray 2 can be equal to the distance between the centerlines of the indents 3 in a single tray 2 and furthermore the centerlines of the indents 3 in both trays 2 can form a triangular grid pattern respective to each other. When the arrangement 11 is viewed from the top and in plan view, the centerlines of any three adjacent indents form an equilateral triangle. A third tray 2 may be stacked onto the triangular grid arrangement 11 formed by the first and second trays 2. The utility of the tray and marker assemblies 12 to be arranged and stacked in both square and triangular grids is disclosed in the proceeding sections on games and building set capabilities.

Example Number Games Played with the Building Set. In some elementary math curriculum, there exists an exercise called “Ways to Make” in which a student is challenged to write down combinations of different numbers that when added together, equal the “Ways to Make” target number. For instance, a student may play the game using “Ways to Make 7.” The student may then write down “6+1”, “4+3” and perhaps “5+2”. Each pair of numbers adds up to the target number of “7”. Adding the numbers “6” and “1” to get “7” is considered a convergent problem-solving exercise because there is only one correct answer. In divergent problem-solving exercises, there is no single correct answer. A student is challenged to discover one of many possible solutions. “Ways to Make” is one such exercise for divergent problem-solving and has implications in the development of creative and flexible thinking.

The building system 1 can be implemented to play a version of “Ways to Make” whereby the student may make a number of tray and marker assemblies 12 that each add up to the target number. A few possible solutions to the “Ways to Make 6” challenge which are comprised of tray and marker assemblies 12 are illustrated in FIG.

A modular game board 31 with protrusions 32 that mate with the tray indents 3 may be provided in the building set 1. The protrusions 32 on the game board 31 can be configured in a square grid and may allow the tray and marker assemblies 12 to be arranged adjacent to one another on the game board 31 and in a grid pattern. Game boards 31 themselves can be arranged adjacent to one another and in a grid to expand the area of play. Magnets 10 may be embedded within the protrusions 32 on the game board to allow the trays 2 to fit securely on the board 31.

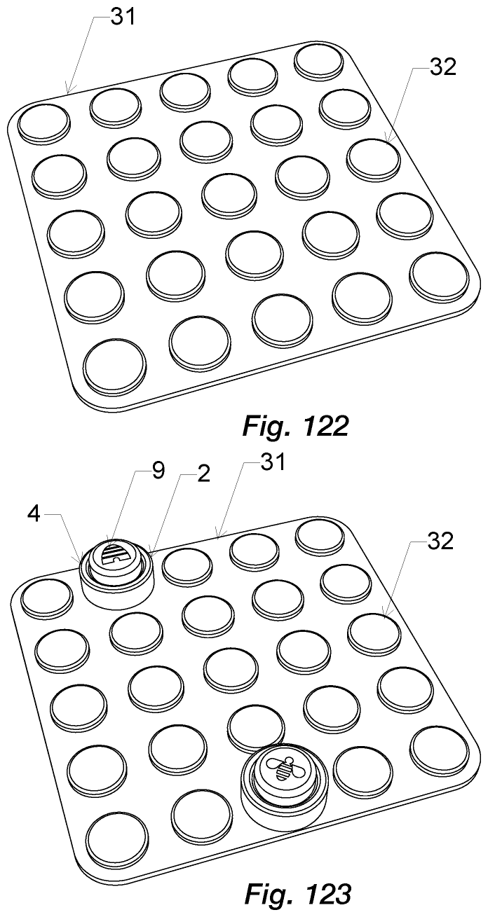

Another math game which can be played with the building set 1 incorporates and is played upon a game board 31 disclosed hereinabove as shown in FIG. 122. The object of the game is to build a path between a starting point and an ending point using tray and marker assemblies 12, while constrained by a given story problem. Story problems can be provided that offer different levels of challenge to players. Markers 4 can be provided that have been printed, painted, debossed, etched or otherwise inscribed with pictures 9 that describe the elements in the story problem. The story problem can also determine the positions of the starting and ending tray and marker assemblies 12. A first one-unit tray 2 containing a marker 4 with a picture 9 printed thereon may be placed on the game board 31 and may represent the character in the story and be implemented as the starting point in the path building challenge. A second one-unit tray 2 containing a marker 4 with a picture 33 printed thereon may be placed on the game board and may represent the goal in the story and be implemented as the ending point in the path building challenge. FIG. 123 illustrates a game board 31 with a starting point represented by a tray and marker assembly 12 with a honey bee picture 9 printed thereon and an ending point represented by a tray and marker assembly with a bee hive picture 9 printed thereon.

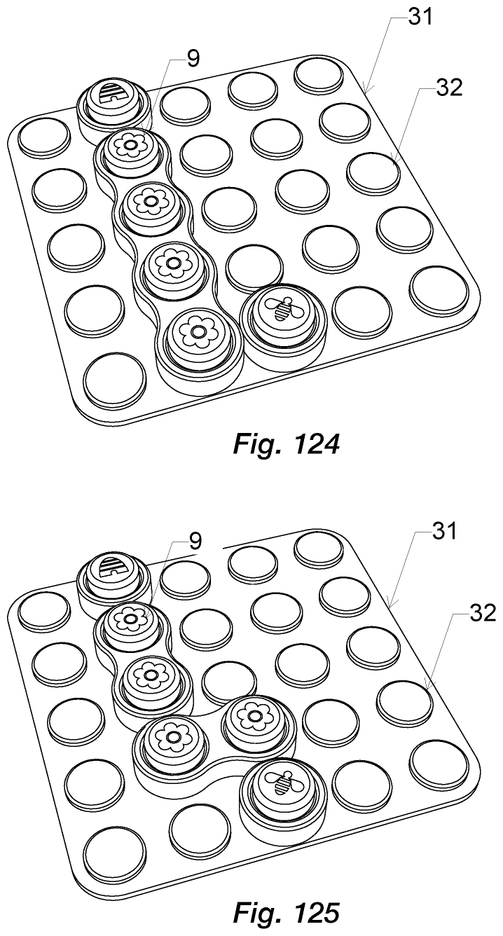

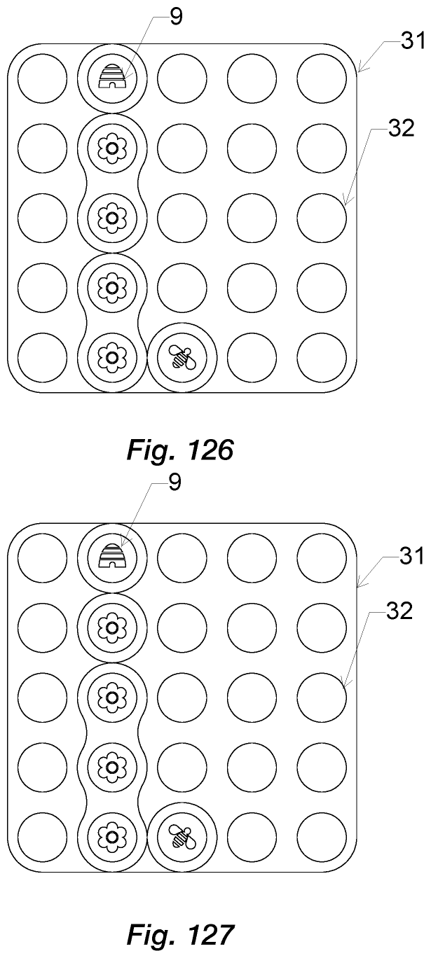

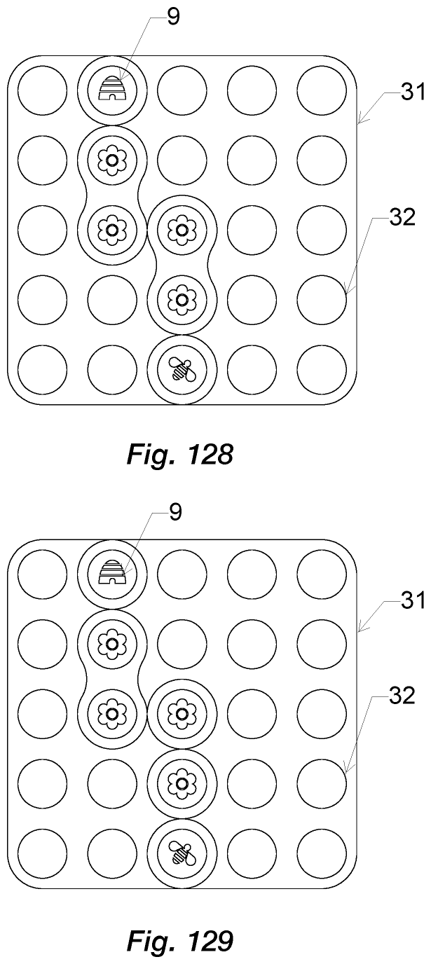

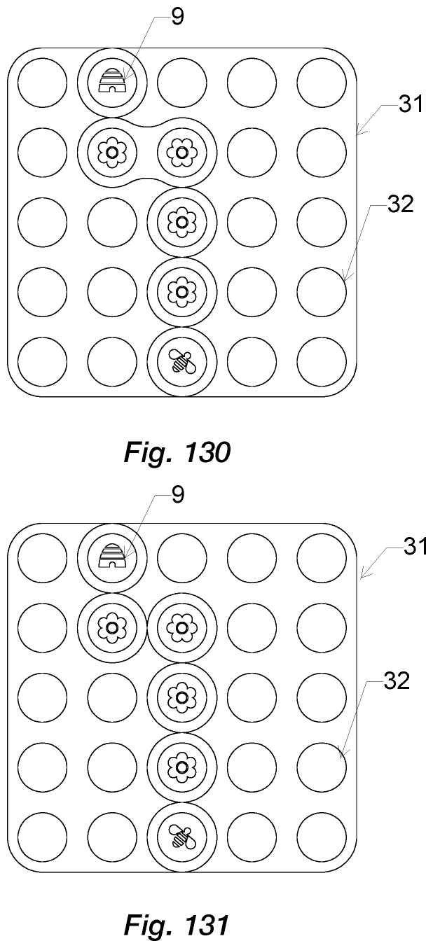

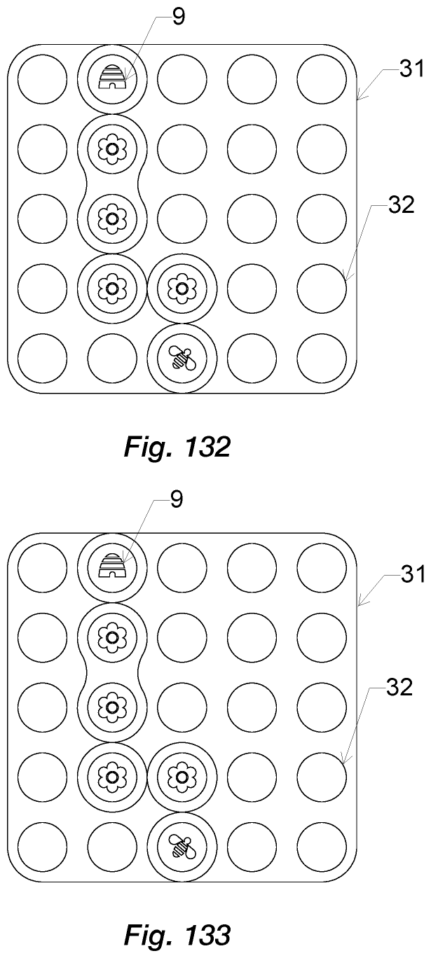

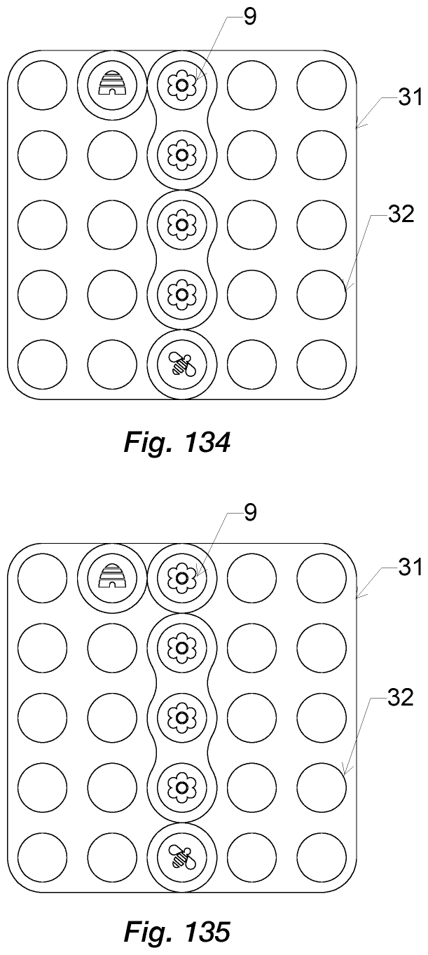

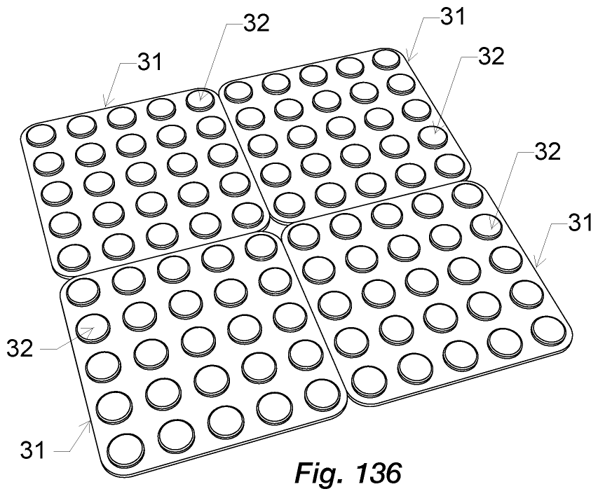

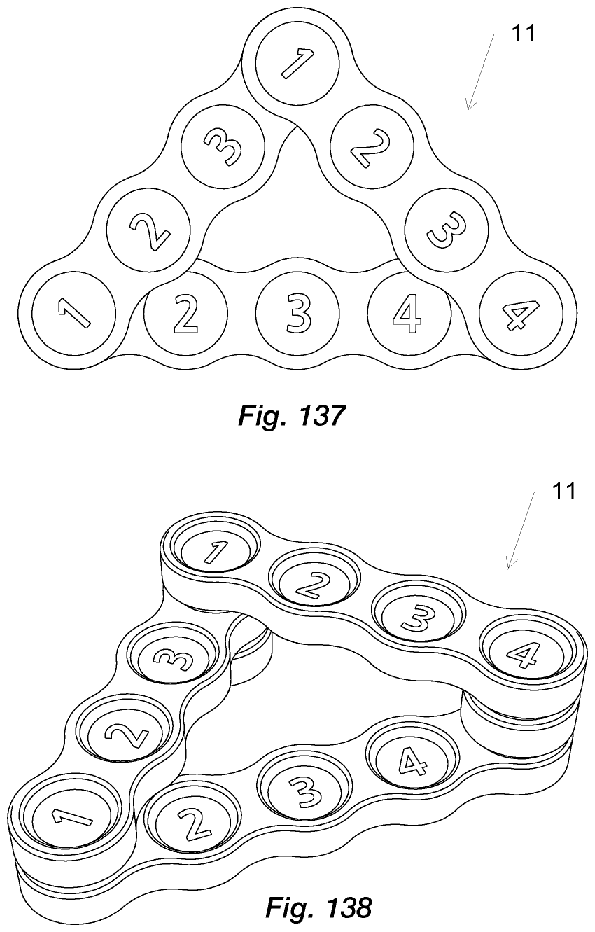

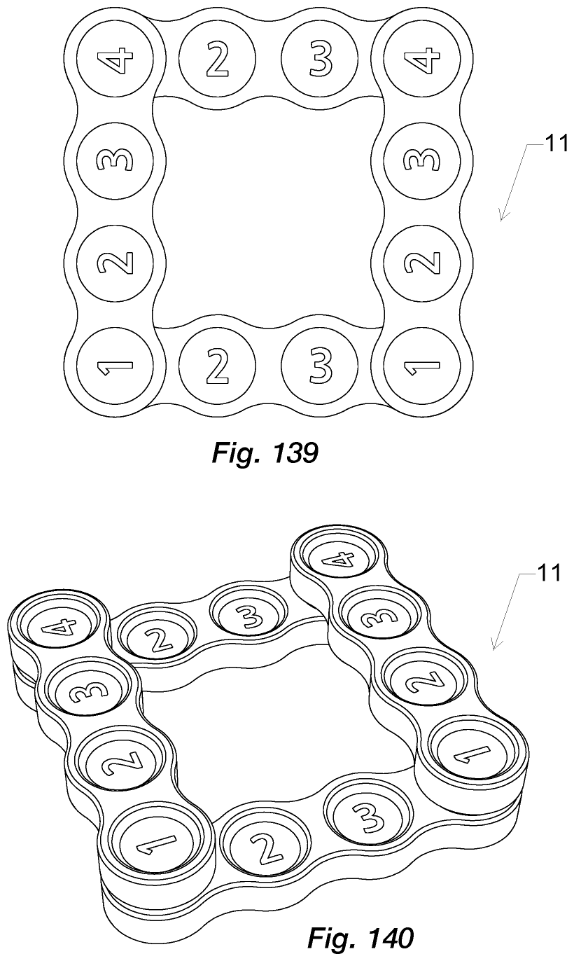

For instance, an exemplary story problem may be called “Bee Goes Home” and provides markers 4 with pictures 9 of a bee and a hive as shown in FIG. 123. The story problem might be written as “Help Bee visit 4 flowers before going home,” which presents a puzzle to the player for divergent problem-solving. There are many solutions to this particular story problem. A player might select a single four-unit tray 2 to form a straight path as shown in FIG. 124 or the player might choose to build a path that turns and is composed of two two-unit trays 2 as shown in FIG. 125. A variety of solutions to this story problem are illustrated in FIGS. 126-135. The path building game offers to a student an engaging method to practice counting, subitizing and composing and decomposing the challenge path length, in this case “4”, into component parts comprised of tray and marker assemblies 12.

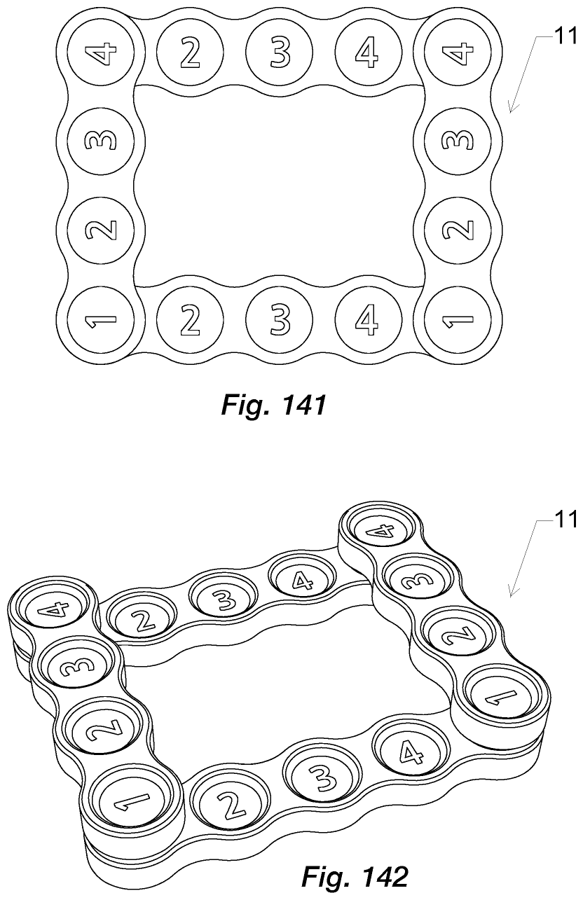

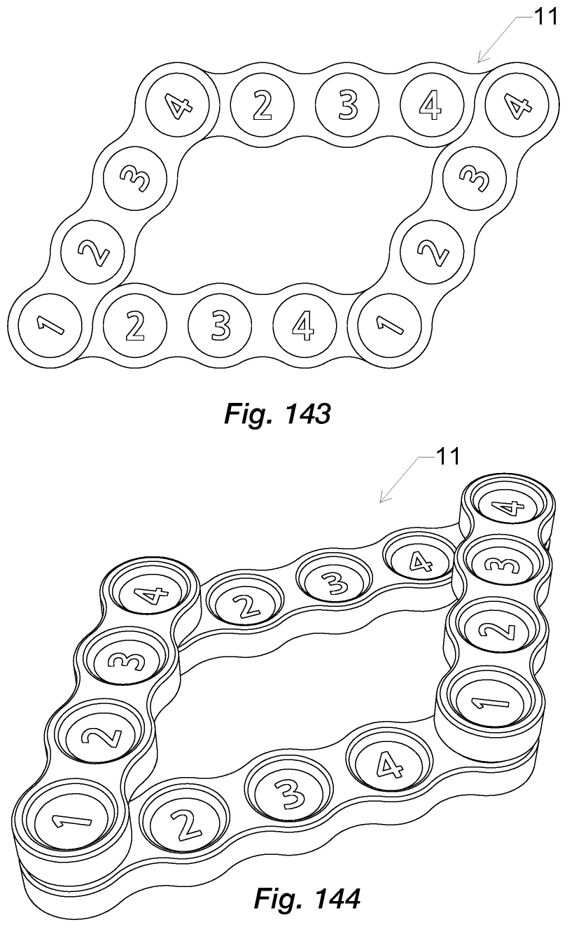

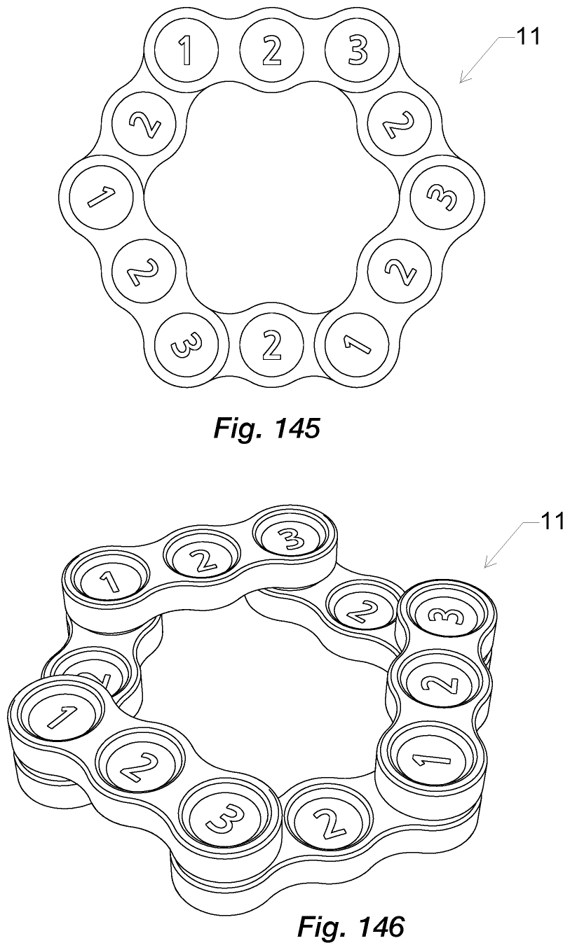

Geometric Shapes. With instruction from a teacher, a student may learn about and build geometric shapes 11 including but not limited to a triangle as illustrated in FIGS. 137 and 138, a square as illustrated in FIGS. 139 and 140, a rectangle as illustrated in FIGS. 141 and 142, a parallelogram as illustrated in FIGS. 143 and 144 and a hexagon as illustrated in FIGS. 145 and 146.

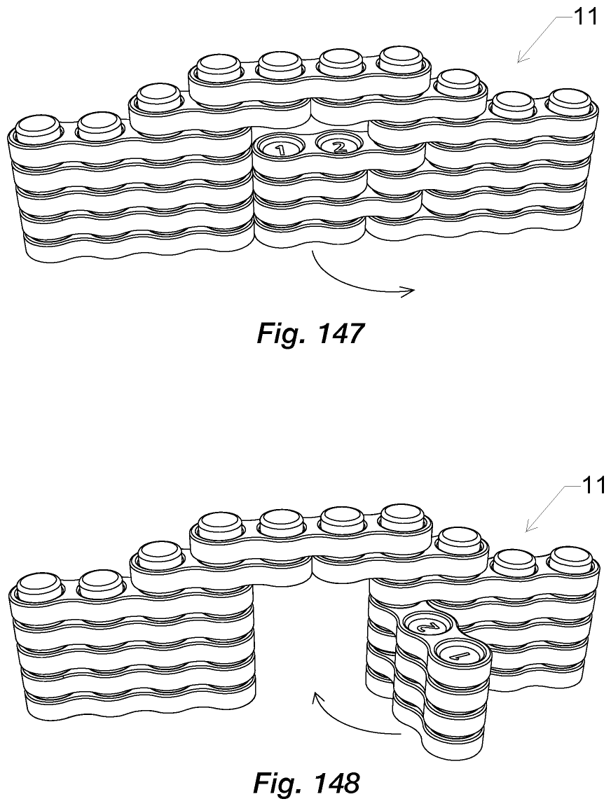

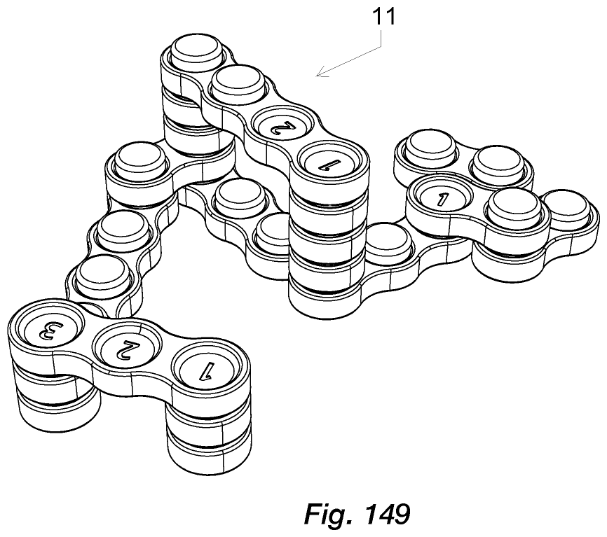

Building Set Capabilities. The following features of the building set can provide a flexible framework with which students may build a variety of shapes, structures, constructions or arrangements 11 during constructive play; indents 3 on opposing sides of the trays 2 which may allow them to be stacked when markers 4 are inserted therein, lateral interlocking profiles 30 and the relationship of indent centerlines within the trays 2 which may allow them to be arranged in square and triangular grid patterns 11 and magnetic connections 10 between the markers 4 and the indents 3 in the trays 2 which may provide freedom of movement around the rotational axis that runs through the centerlines of the markers 4 and indents 3. FIG. 147 shows a structure 11 built from tray and marker assemblies which is a wall that possesses a door with operable hinge. FIG. 148 shows the door in an open position. As evident in FIG. 149, highly complex structures and arrangements 11 may be built with the building set incorporating the features outlined hereinabove, thus permitting the set to be employed in teaching or self-guided learning of basic structural design and assembly techniques.

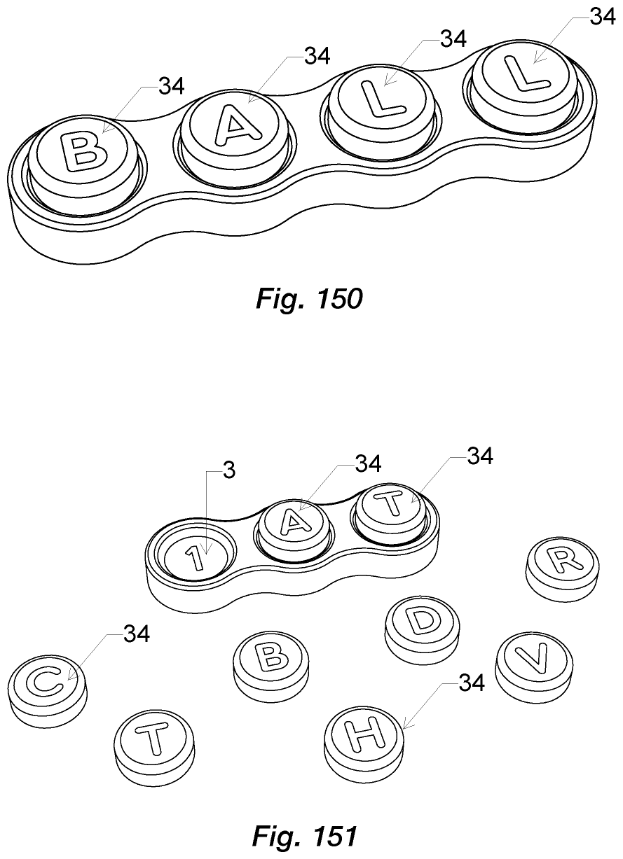

Modeling and Spelling Words. Letters of the Latin alphabet may be inscribed on the unit markers, hereinafter called letter markers 34. Letter markers 34 can be inserted into the slots or indents 3 in a tray 2 and employed to model words. For instance, FIG. 150 shows a sequence of unit markers 4 having a sequence of letters “B”, “A”, “L” and “L” inscribed respectively thereon and inserted into a four-unit tray 2, thus modeling the word “ball.” Depending on the length of a single tray 2 or the length of a sequence of trays 2 employed, words of various character lengths may be modeled.

Example Word Games Played with the Building Set. With instruction from a teacher, a student may learn to model and spell words using assemblies 12 of trays 2 and letter markers 34. To further enhance students' experience of learning to model and spell words, a few example games may be played with trays and letter markers.

With assistance from a teacher, a student may play an example word game called “Word Length Challenge.” To begin a round of the game, the teacher selects a unit-tray 2 of a particular length, in this example a three-unit tray 2. The teacher then speaks a target word having the same character length as the selected unit-tray 2 and instructs the student to spell the target word. By providing tray 2 at the outset of the round, the teacher provides the student with a hint as to the number of characters needed to correctly spell the word. In a more challenging form of the game, the teacher may speak the target word but require that the student select the tray 2 themselves.

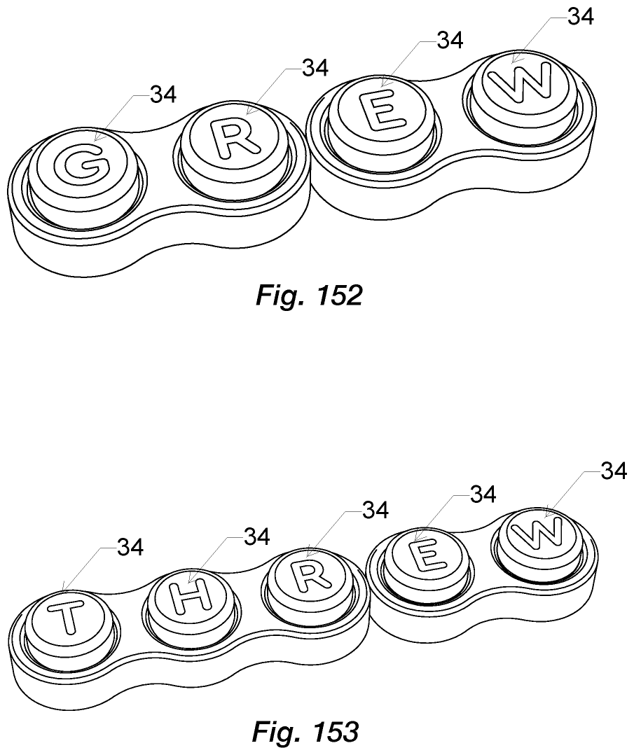

With assistance from a teacher, a student may play an example word game called “Vocabulary Challenge—Same Ending.” In an example game, the teacher may assemble and present to the student a tray 2 containing letter markers 34 placed in each respective slot or indent 3 of the tray 2 with the exception of the first letter in the word, which will be left blank with no letter marker 34 inserted. For instance, the teacher may present a three-unit tray 2 which contains no letter marker 34 in the left-most and first slot 3, a letter “A” marker 34 in the second slot 3 from the left and a letter “T” marker 34 in the third and final slot 3 from the left. This tray 2 may be called hereinafter the “game” tray and the state whereby the first position slot 3 is left blank and the remaining slots 3 are filled by the teacher with letter markers 34 will be called hereinafter the “starting state” of the game tray. The teacher may place the game tray 2 on a work surface. The teacher may also place on the work surface and adjacent to the game tray 2 a quantity of letter markers 34. FIG. 151 illustrates the game tray 2 and letter markers 34 on the work surface at this stage of the game. The teacher may then challenge the student to model as many words as they can that have the same ending but different first letters. The student may first select a letter marker 34 from the work surface and insert it into the empty first-most slot 3 in the game tray 2 in order to model a word. After the student has modeled a word correctly, the teacher may record the word modeled and return the game tray 2 to the starting state by removing the letter marker 34 in the first position slot. The student may then repeat the process whereby they select a new letter marker 34 from the building set 1 on the work surface, insert it into the empty slot 3 in the game tray 2 to model a new word. A more challenging form of the game might employ more than one tray 2 where the letter markers 34 of the “same ending” portion of the word are inserted into their own tray 2. The student may then select a second tray 2, insert letter markers 34 into the second tray 2 and finally place the second tray 2 adjacent to and in a collinear relationship with the first tray 2 to model a word. In this form of the game, many more words might be modeled since the beginning portion of the word that the student selected can be of a character length greater than one as seen in FIG. 152 and FIG. 153.

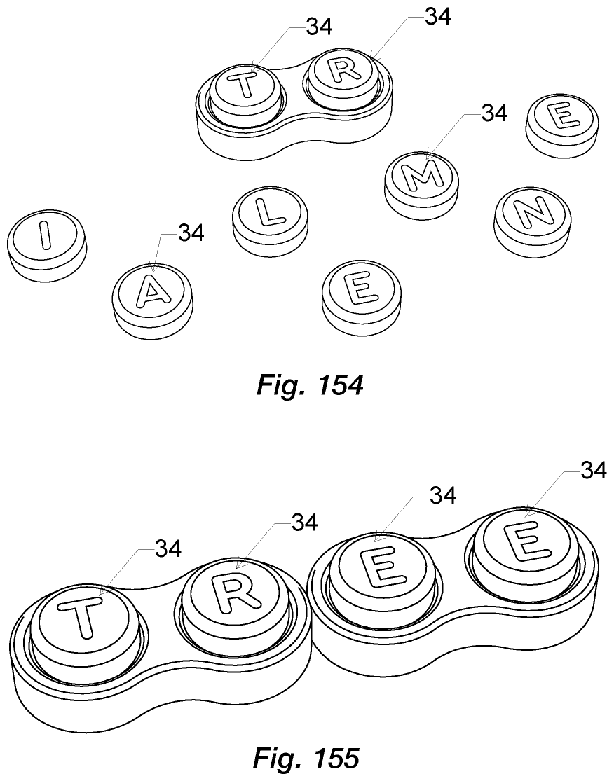

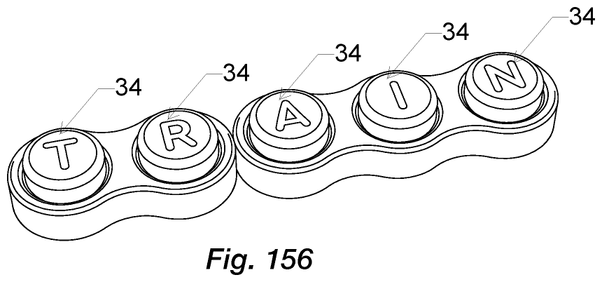

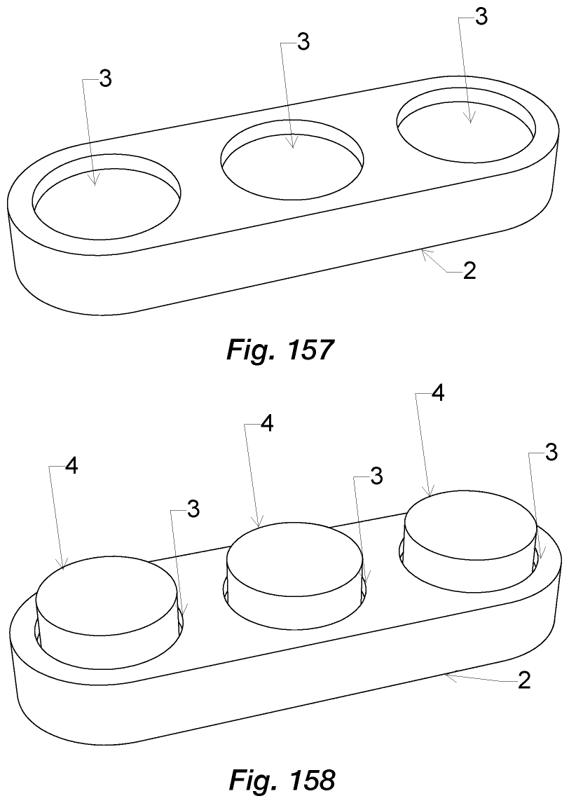

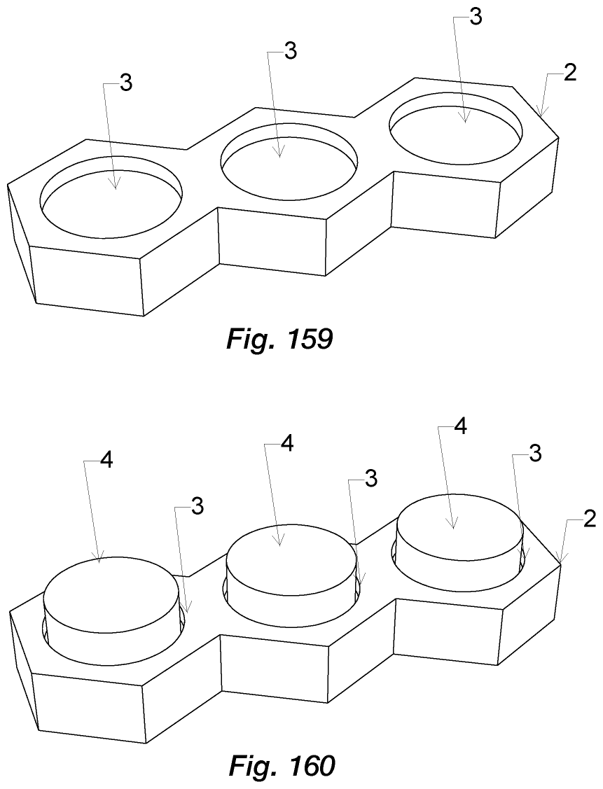

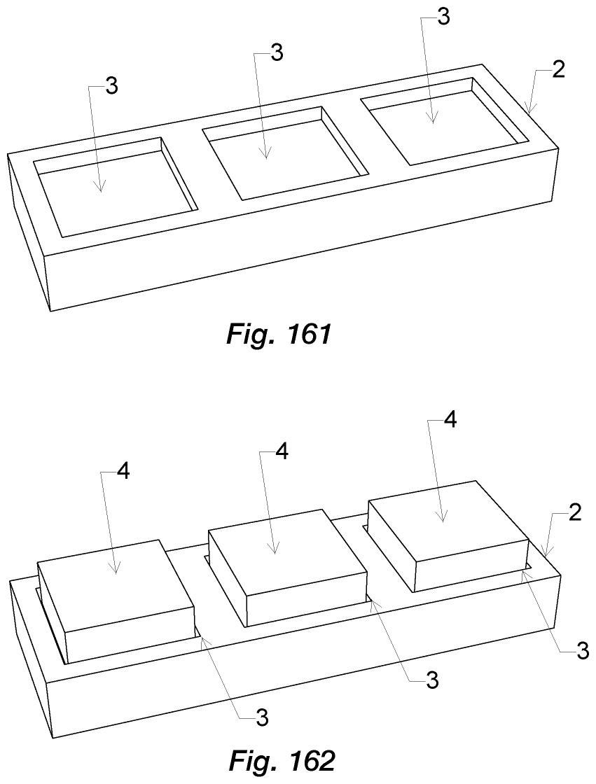

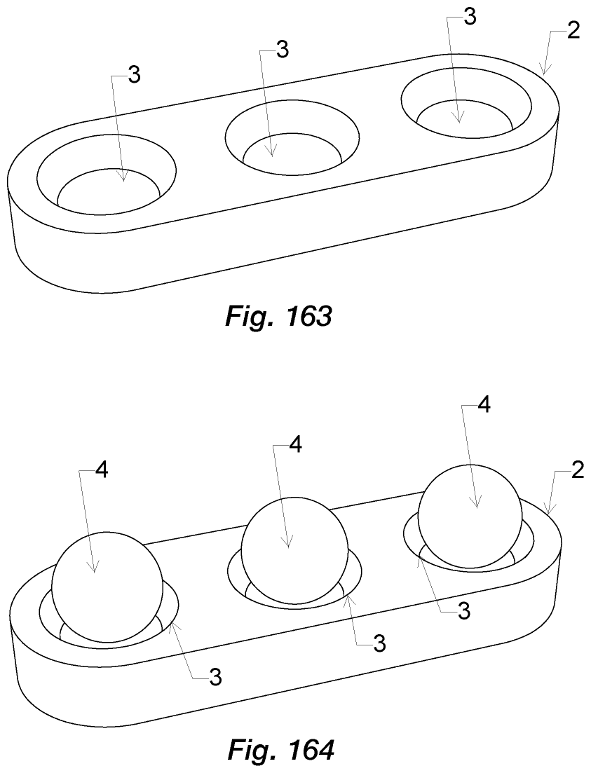

With assistance from a teacher, a student may play an example word game called “Vocabulary Challenge—Same Beginning.” In an example game, a student is challenged to create as many words as possible that all begin with the same consonant group. To begin an example game, the teacher may select a first tray 2, insert letter markers 34 into the slots 3 to form a common word beginning such as “TR” and place the first tray 2 on a work surface. The teacher may also place on the work surface and adjacent to the game tray 2 a quantity of letter markers 34 as shown in FIG. 154. The teacher then challenges the student to model as many words as they can, beginning with the letters “TR.” The student may select a second tray 2 and place it adjacent to and in a collinear relationship with the first tray 2. The student may then select letter markers 34 from the work surface and insert them into the slots 3 in the second tray 2 to model a word. After the student has modeled a word correctly, the teacher may record the word modeled. The student may either employ the previously selected second tray and remove the letter markers 34 therein or remove the second tray 2 and select a third tray 2 of a different unit length than the second tray 2. In either case, the student repeats the process. The student selects letter markers, inserts them into the tray slots and models a new word. FIG. 155 and FIG. 156 each show an example modeled word.

Other examples of the building system are also contemplated, which may include but are not limited to cards with other operators or symbols such as greater than, less than, or logic operators such as AND, OR, XOR, and NOT. Also contemplated are trays with other example profiles, trays with indents only on a single side, other example marker and tray indent shapes such as squares solids and spheres, trays that are not stackable and trays whose profiles lack the lateral interlocking feature as disclosed hereinabove. These and other examples will be readily understood by those having ordinary skill in the art after becoming familiar with the teachings herein.

In still other examples of the building system, the magnets and/or magnets/magnetic material may be substituted with other removable attachments, such as hook-and-loop fasteners. In an example implementing hook-and-loop fasteners, a smaller area of hook material may be provided on the “weak” side of the marker and a larger area of hook materials on the “strong” side of the marker. The tray indents may be provided with a consistent area of loop material. A first tray may pull out markers from a second tray of the “strong” side of the marker with the larger hook material facing up. Any other suitable attachment mechanism now known or later developed may also be employed. Indeed, in other examples, the attachment mechanism may be omitted entirely.

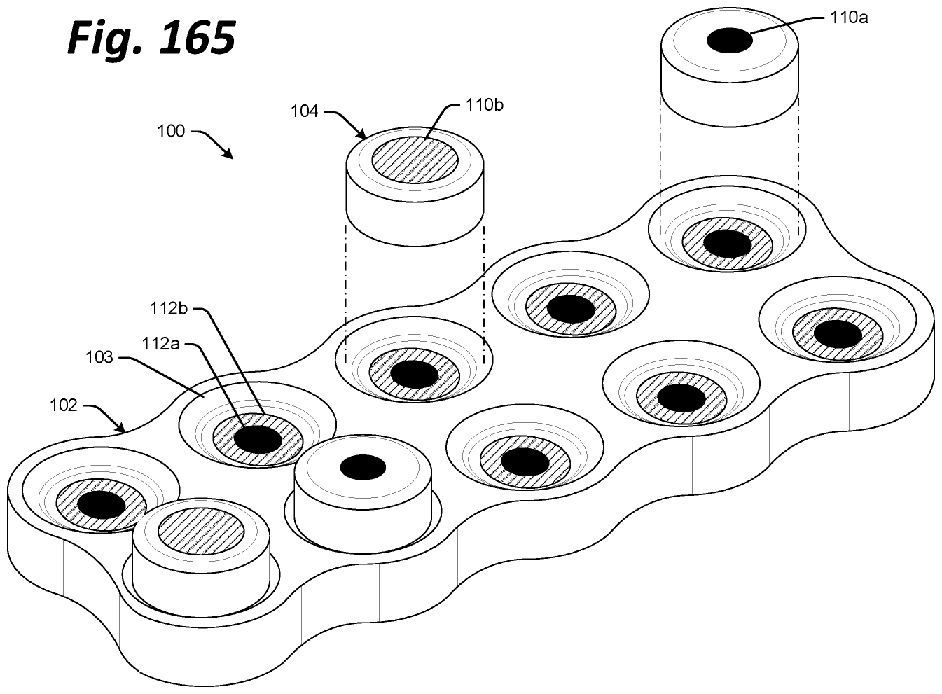

FIG. 165 shows another example tray 102 and markers 104 of an example building set 100 having a hook-and-loop connection mechanism. The example building set 100 includes a tray 102 having a first row and a second row, each having a plurality of marker positions 103. The example building set 100 also includes a plurality of markers 104 configured for interchangeably fitting with the marker positions 103 on the tray 102.

A connection mechanism has a first connection 110a on a first side of the markers 104, a second connection 110b on a second side of the markers 104, and a third connection 112a, 112b at each of the marker positions 103. The third connection 112a, 112b interchangeably mates with the first connection 110a and the second connection 110b of the plurality of markers 104. The connection mechanism is at least one of hook-and-loop and magnetic, and may be biased toward one side of the markers 104 to aid in subtraction. The tray 102 and markers 104 are configurable in various exercises and games to teach at least one of numeracy, arithmetic, and spelling.

In an example, the tray 102 is a ten-frame tray having ten indents on an upper surface and ten indents on a lower surface. As already described above, the marker positions 103 are indents formed on the tray 102. Indicia (not shown in FIG. 165) on the markers 104 may include at least one of numbers, letters, and pictures of objects, and indicia on the marker positions may include at least one of numbers, letters, and pictures of objects.

In an example, the connection mechanism is biased to connecting the first connection 110a with the third connection 112a, 112b. The biased connection mechanism enables a subtraction feature. For example, the first connection 110a may be a first hook-and-loop fastener and the second connection 110b is a second hook-and-loop fastener. The third connection 112a, 112b may be a third hook-and-loop fastener. The third hook-and-loop fastener mates with the first and second hook-and-loop fasteners.

In an example, the third connection 112a, 112b is a third and fourth hook-and-loop fastener. The third hook-and-loop fastener (e.g., 112a) mating only with the first hook-and-loop fastener (e.g., 110a), and the fourth hook-and-loop (e.g., 112b) fastener mates only with the second hook-and-loop fastener (e.g., 110b). For example, the first and third hook-and-loop fasteners may have hooks and the second and fourth hook-and-loop fasteners have loops. Or for example, the first and third hook-and-loop fasteners may have loops and the second and fourth hook-and-loop fasteners have hooks.

In an example, the first and third hook-and-loop fasteners (e.g., 110a, 112a) have about the same diameter and the second and fourth hook-and-loop fasteners (e.g., 110a, 112b) have about the same diameter that is different from the diameter of the first and third hook-and-loop fasteners. This aids in “biasing” the marker 104, e.g., toward the side with the larger diameter hook-and-loop connection.

In an example, the first and third hook-and-loop fasteners have about the same diameter and the second and fourth hook-and-loop fasteners have about the same diameter that is larger from the diameter of the first and third hook-and-loop fasteners to bias connecting the markers with the marker positions 103 to a side of the markers 104 with the larger diameter hook-and-loop fasteners.

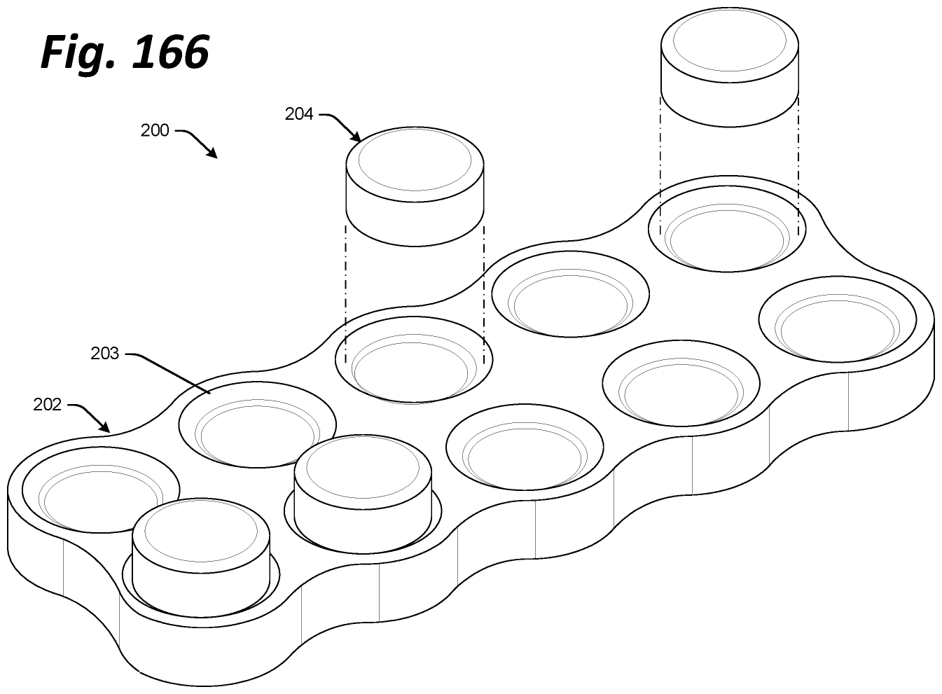

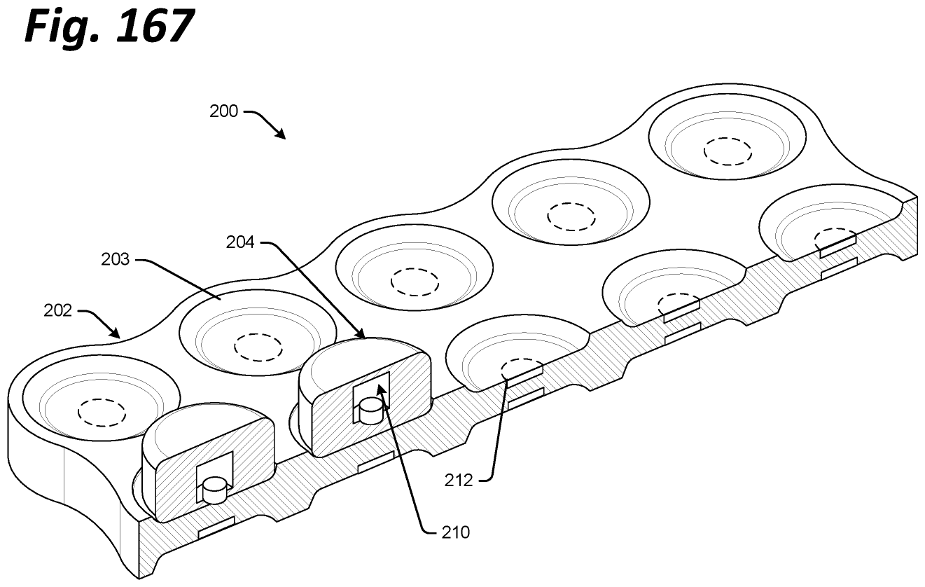

FIG. 166 shows another example tray and unit markers of an example building set having a magnetic connection mechanism. FIG. 167 is a cross sectional view of the example tray and unit markers having a magnetic connection mechanism of FIG. 166.

The example building set 200 includes a tray 202 having a first row and a second row, each having a plurality of marker positions 203. The example building set 200 also includes a plurality of markers 204 configured for interchangeably fitting with the marker positions 203 on the tray 202. A connection mechanism has a first connection on a first side of the markers 204, a second connection on a second side of the markers 204, and a third connection at each of the marker positions 203. The third connection interchangeably mates with the first connection and the second connection of the plurality of markers 204. The connection mechanism is at least one of hook-and-loop and magnetic, and may be biased toward one side of the markers 204 to aid in subtraction. The tray and markers are configurable in various exercises and games to teach at least one of numeracy, arithmetic, and spelling.

In an example, the tray 202 is a ten-frame tray having ten indents 203 on an upper surface and ten indents 203 on a lower surface. As already described above, the marker positions 203 are indents formed on the tray 202. Indicia (not shown in FIGS. 166-167) on the markers 204 may include at least one of numbers, letters, and pictures of objects, and indicia on the marker positions may include at least one of numbers, letters, and pictures of objects.

In an example, the connection mechanism is biased to connecting the first connection with the third connection. The biased connection mechanism may enable a subtraction feature.

In an example, the first connection and the second connection is a magnet 210 in a cavity 212 formed in each of the markers 204. The cavity 212 is biased to a first surface of each of the markers 204. For example, the cavity 212 is shown in FIG. 167 formed closer to the first surface of each of the markers and further away from a second surface opposite the first surface of each of the markers. The magnet 210 free floats in the cavity 212 to attach the corresponding marker 204 to the marker positions 203 in the tray 202 interchangeably in a first orientation and a second orientation.

It is noted that the examples shown and described are provided for purposes of illustration and are not intended to be limiting. Still other examples are also contemplated.

1. A building set, comprising:
a tray having a first row and a second row, each row having a plurality of marker positions;
a plurality of markers each configured for interchangeably fitting with the plurality of marker positions on the tray;
a connection mechanism having:
a first connection on a first side of each of the plurality of markers;
a second connection on a second side of each of the plurality of markers; and
a third connection at each of the plurality of marker positions;
wherein the third connection interchangeably mates with the first connection and the second connection of the plurality of markers;
wherein the tray and plurality of markers are configurable in various exercises and games to teach at least one of numeracy, arithmetic, and spelling.

2. The building set of claim 1, wherein the connection mechanism is biased to connecting the first connection with the third connection.

3. The building set of claim 2, wherein the biased connection mechanism enables a subtraction feature.

4. The building set of claim 1, wherein the first connection and the second connection is a magnet in a cavity formed in each of the markers.

5. The building set of claim 4, wherein the cavity is biased to a first surface of each of the markers.

6. The building set of claim 5, wherein the cavity is formed closer to the first surface of each of the markers and further away from a second surface opposite the first surface of each of the markers.

7. The building set of claim 4, wherein the magnet free floats in the cavity to attach the corresponding marker to the marker positions in the tray interchangeably in a first orientation and a second orientation.

8. The building set of claim 1, wherein the first connection is a first hook-and-loop fastener and the second connection is a second hook-and-loop fastener.

9. The building set of claim 8, wherein the third connection is a third hook-and-loop fastener, the third hook-and-loop fastener mating with the first and second hook-and-loop fasteners.

10. The building set of claim 8, wherein the third connection is a third and fourth hook-and-loop fastener, the third hook-and-loop fastener mating only with the first hook-and-loop fastener, and the fourth hook-and-loop fastener mating only with the second hook-and-loop fastener.

11. The building set of claim 10, wherein the first and third hook-and-loop fasteners have hooks and the second and fourth hook-and-loop fasteners have loops.

12. The building set of claim 10, wherein the first and third hook-and-loop fasteners have loops and the second and fourth hook-and-loop fasteners have hooks.

13. The building set of claim 10, wherein the first and third hook-and-loop fasteners have about the same diameter and the second and fourth hook-and-loop fasteners have about the same diameter that is different from the diameter of the first and third hook-and-loop fasteners.

14. The building set of claim 10, wherein the first and third hook-and-loop fasteners have about the same diameter and the second and fourth hook-and-loop fasteners have about the same diameter that is larger from the diameter of the first and third hook-and-loop fasteners to bias connecting the markers with the marker positions to a side of the markers with the larger diameter hook-and-loop fasteners.

15. The building set of claim 1, wherein marker positions are indents formed on the tray.

16. The building set of claim 1, further comprising indicia on the markers including at least one of numbers, letters, and pictures of objects.

17. The building set of claim 1, further comprising indicia on the marker positions including at least one of numbers, letters, and pictures of objects.

18. The building set of claim 1, wherein the tray is a ten-frame tray having ten indents on an upper surface and ten indents on a lower surface.

19. A method of teaching addition and subtraction using a building set, comprising:
providing a first tray having markers representing a first quantity;
providing a second tray having markers representing a second quantity; and
providing a third tray filled having markers representing a third quantity;
wherein the trays and markers are moved according to a connection mechanism having:
a first connection on a first side of each of the markers;
a second connection on a second side of each of the markers; and
a third connection on each of the trays;
wherein the third connection on each of the trays interchangeably mates with the first connection and the second connection of the markers;
wherein the trays and plurality of markers are configurable in various exercises and games to teach at least one of numeracy, arithmetic, and spelling.

20. The method of claim 19, wherein the connection mechanism is at least one of hook-and-loop and magnetic.
